(19) United States
(12) Patent Application Publication
(10) Pub. No.: US 2002/0080450 A1
(43) Pub. Date: Jun. 27, 2002

(54) Fully photonic, high-speed, reduced-energy-density, burst generator

(76) Inventor: John N. Hait, San Diego, CA (US)

Correspondence Address: GARY L. EASTMAN, ESQ., ALL OPTICAL NETWORK, INC., 9707 WAPLES STREET, SANDIEGO, CA, 92121, US

(21) Appl. No.: 09/753,498

(22) Filed: Dec. 27, 2000

(51) Int. Cl. H04B 10/00; H04B 10/04

(52) U.S. Cl. 359/158; 359/184

(57) ABSTRACT

An encoding and decoding method and apparatus support high speed multiplexing with a resolution of up to a single wavelength, in the speed range appropriate for photonic signal processing. The apparatus can support unbundling of sequential data patterns (such as packets etc.) down to an atomic level and rebundling for an arbitrary distribution pattern, with minimal overhead. A photonic encoder may encode at a rate governed by the cycle time of a photonic wave modulated in a domain selected from phase, frequency, amplitude, polarization, spread spectrum in time or frequency, or any combination thereof. Signals are split into daughter signals, having the exact wave form, absent amplitude equality, of the parent. Daughter signals may be serialized by a delay, spacing one daughter after another. A decoder splits the daughter signals into granddaughter signals and recombines them to provide noninterference, constructive interference, and destructive interference. By detection of photonic interference, a reconstituted output pulse may be formed, completely regenerating all information from the original signal. Overlaps between various daughter pulses may be used to provide amplitude increases in areas of interference having substantially reduced pulse durations, while lesser amplitudes remain elsewhere. Eventually, energy conservation may render lower amplitude regions below a noise level or cutoff level, thus concentrating the signal in a shorter duration, allowing more pulses to be encoded into a carrier, with less total energy density in the carrier for each pulse.

### BACKGROUND

1. The Field of the Invention

This invention relates to computer systems and switches therefor and, more particularly, to novel systems and methods for switching and processing photonic information.

2. Background

Multiplexing is a method for transmitting multiple, distinct signals over a single physical carrier medium. Much of the protocol of computer hardware deals with the encoding and decoding of signals according to some time scheme for maintaining signal integrity and uniqueness from other signals. In conventional time-division types of multiplexing, signals are transmitted within specific time divisions or bit positions. In order to prevent individual bits from being transmitted at the same time, each is encoded into a signal and transmitted over the carrier medium at a specific time.

As transmission rates increase, the individual time divisions available for each small quantity of information in a signal is reduced. However, with the advent of photonic processing, the transmission, encoding, and decoding of photonic signals taken from the electromagnetic spectrum, deserve further consideration. In conventional computer systems, as well as conventional telecommunications networks, the switching, routing, and transmission of signals throughout networks and between processors or processes is a major limiting factor in performance. Typically, transmissions of a signal require encoding of the signal in a carrier medium, according to a protocol or format.

Thereafter, transmission occurs as a physical phenomenon in which light, or other electromagnetic radiation, electrical signals, mechanical transmissions, or the like are transferred between a source and a destination. At the destination, a decoder must then manipulate the physical response to the incoming signals, thus reconstructing original data encoded by the sender. Communications in general may include communications between individual machines. Machines may be network-aware, hardware of any variety, individual computers, individual components within computers, and the like.

Thus, the issue of sending and receiving information or message traffic is of major consequence in virtually all aspects of industrial and commercial equipment and devices in the information age. Whether communications involve sending and receiving information between machines, or telecommunications of data signals, audio signals, voice, or the like over conventional telecommunications networks, the sending and receiving requirements of rapidly encoding and decoding are present.

With the advent of photonic signals and photonic signal processing, new speed limits are being approached by transmission media. Moreover, origination of signals can now be executed literally at light speeds. Accordingly, what is needed is a system for multiplexing photonic signals over photonic carrier media in such a way as to maximize speed, while maintaining the integrity of information.

Total throughput for any communication process will be limited by the slowest element or process occurring. Accordingly, faster computation in photonic computers and switches needs to be supported by appropriate communications within and between elements of such computers, as well as between computers, and between other telecommunications locations throughout the geography of the earth. Thus, multiplexing information over trunk carriers, with respect to collection of information and distribution of information on either end, will eventually become a limiting issue. Accordingly, what is needed is a method for multiplexing at maximum rates, while maintaining information integrity, to maximize throughput of systems.

As advanced technologies are developed, the current infrastructure of the industrialized world will not disappear overnight. Accordingly, legacy equipment needs support. Moreover, in order to advance the deployment of high-speed technologies, it will be important for newer communication systems to interface with legacy equipment. Current telecommunication systems have been developed over decades. Accordingly, lines vary from wireless to copper wire, to fiber optics and the like.

Likewise, the individual sending and receiving (transmitting/receiving) components operate at various speeds. In all communications, speed matching between components will be a major issue. With photonic communications, speeds are so drastically changed, that conventional protocols are inapplicable. Nevertheless, at some point, even a photonic network must communicate with an existing (legacy) piece of equipment. Matching signal formats, wave shapes, and the like, in order to be “understood” is necessary.

What is needed is a method and apparatus for high speed multiplexing within the speed ranges appropriate for photonic signal processing. What is also needed is a convenient method and durable apparatus for interfacing between legacy equipment and photonic communications equipment. Also needed is an apparatus and method for encoding, routing, decoding, processing, manipulating, dividing, and recombining, complex wave forms containing information imbedded therein. Also needed is a method for literally assembling and disassembling complex structures of information in arbitrary manners in order to optimize the use of transmission resources.

This process and apparatus should include unbundling sequential data patterns (such as packets etc.) and rebundling for an arbitrary distribution pattern, similar to the current package delivery system characterized by the Federal Express system. That is, in conventional telecommunications, packeting was more or less sacrosanct. Although packets were read, rewritten, repackaged, and so forth, they continued with their same internal structures. However, as the Federal Express system has proven with packaging, sometimes higher speeds can be achieved by centralizing or rerouting packaging and repackaging systems according to destination. Thus, some central, arbitrary hierarchical criteria whether organizational, geographical, priority, protocol, or other consistent thread of organization between certain information, may be useful as a mechanism for organizing transmission of information. Thus, according to the original receipt of information, information (data, communications, etc.) may need to be reorganized in order to provide faster and more effective or efficient delivery to destinations (receivers).

One need in photonic telecommunications is the need for bundling and unbundling information (typically packets) for distribution. That is, like the Federal Express package delivery system, information must be gathered, sorted, and redistributed. In current systems, even those using fiberoptic cables, all bundling and unbundling is actually executed by devices operated electronically. Accordingly, the speed limits on transfer of information are imposed by the intermediary electronic equipment that must process signals for bundling and unbundling information.

As photonic systems are developed, it would be an advance in the art to develop a fully photonic router that is capable of dynamic configuration for accomplishing both routing and provisioning functions in order to effectively and speedily distribute information. Creation of a fully photonic router, particularly one that could dynamically be reconfigured, would solve a major technological bottleneck that needs to be resolved before a fully photonic network can be implemented.

Another need in photonic technology is the need for interfacing with legacy equipment. Interfacing with legacy equipment may be necessary where a legacy “last mile” of a network must interface with a fiber optic, photonic network. Moreover, as small fiber optic networks or photonic networks are installed, they must nevertheless interface with legacy interconnections existing in current infrastructure across the nation and the world. Thus, photonic systems must interface as interior elements of other networks, and must interface as terminal elements of other networks.

Moreover, current technology in the electronic art provides for multiplexing. Both timedivision multiplexing and wave-division multiplexing may occur in legacy hardware. Bandwidth is increased by multiplexing, putting more signals over a single physical carrier in the same limited time and space. What is needed is additional bandwidth, and such bandwidth that will interface with legacy equipment. It would be an advance in the art if photonic multiplexers could be configured in series with conventional multiplexers, in order to increase bandwidth while interfacing with legacy equipment. Such massive increases in bandwidth can alleviate current limitations on information transfer.

Thus, what is needed is a compound multiplexing system including serial multiplexing of both wave-division multiplexers and time-division multiplexers in series with new photonic multiplexers. Due to the “delay domain” provided by an apparatus and method in accordance with the invention, it is possible to provide a compound multiplexing system in which multiple photonic multiplexers are compounded with legacy multiplexers to send signals over a single physical carrier.

Meanwhile, it would be a substantial advance in the art to compound multiple legacy multiplexers (time-division multiplexers, wave-division multiplexers, etc.) in a network served by photonic delayed-domain multiplexers feeding signals directly into the physical carrier medium.

The high bandwidths available in photonic systems may be relied upon to carry highly secure communications. What is needed is an effective means for defeating interception or decoding of photonic information. It would be an advance in the art to provide a photonic communication network having multiple delay paths in order to provide security through integration of two separate routes. Accordingly, it would be an advance in the art if exact, coherent signals were required from two physically separate carrier medium passing through different geographical routes, in order to reconstitute secured information.

It would be an advance in the art to add an additional level of multiplexing, by adding a delay-domain multiplexing capability to become compounded with NRZ equipment. Specifically, it would be an advance in the art to rely on delay-domain multiplex signals having the same frequency. It would be an advance in the art to be able to receive signals over multiple channels, from disparate sources, having the same, or substantially the same frequencies, and still be able to effectively multiplex those signals without cross talk.

Much of legacy telecommunications equipment operates on a “non-return-to-zero” (NRZ) basis. That is, a signal is set, and remains at the set value until another signal unsets it or changes its value otherwise. Even fiber optic systems (photonic signal systems) may operate on an NRZ basis. It is important in developing a new technology, such as the photonic technology of the present invention, to continue providing support for legacy equipment. Since legacy equipment may include photonic (fiber optic, etc.) carriers and signals, including OC-48, OC-3, and other SONET systems, proper interfaces would be desirable when deploying new equipment in accordance with the invention.

Thus, it would be an advance in the art to be able to create equipment in accordance with the invention that is effectively transparent to NRZ communications. Since conventional legacy equipment differentiates on a frequency basis, multiplexing is limited by the ability to distinguish individual frequencies.

It would be an advance in the art to provide multiple channels associated with any individual time delay. Thus, when multiple sources, whether local or remote with respect to one another, are encoding in reliance on a particular time delay, it would be an advance in the art to provide channeling so that multiple messages or other information, having the same time-delay encoding, could nevertheless be managed simultaneously over the same carrier medium, by virtue of some multiplex method that allows coexistence through multiple channels. Alternatively, it would be an advance in the art to provide additional bandwidth by providing multiple channels at each individual delay-time, in order to increase input through a communication system. Moreover, it would be an advance in the art to be able to provide multiple channels through a single set of decoder hardware.

No physical carrier medium can be fairly expected to carry an infinite amount of energy or to sustain an infinite energy density. Signals may be distorted as energy densities rise. Also, physical damage to carrier media and other components may occur due to excessive energy densities. As signals are multiplexed in greater number, the energy density in a carrier medium must be addressed.

If not ameliorated, the energy density in the carrier medium may saturate the capacity of the medium, information may be lost by both the distortion of the encoded information in the medium, as well as through cross talk, and other sources of increased bit error rates. When electro-optics technology is relied upon at a receiving end of a transmission network, performance of the detection circuits and other devices may be adversely affected by the receipt of more energy than the saturation level will tolerate.

What is needed is a method and apparatus for transmitting more information with less energy. Thus, when multiplexed together, multiple channels of signals or other multiplexed information streams need to have less energy so that more information can be passed over the same carrier medium.

Specifically, it would be an advance in the art to provide a method and apparatus for narrowing the width (time) of a digital pulse in order to reduce the net energy in each pulse, while maintaining a minimum amount of energy to support the signal. What is needed is a reduced-energy transmission of information while maintaining a suitably high signal-to-noise ratio (SNR).

In certain embodiments, encoding and decoding with high signal-to-noise ratios (SNRs) may be achieved with comparatively reduced energy.

Electrical, electronic, and electro-optical devices have unacceptable speeds to handle photonic data transfer. Therefore, it would be a further advance in the art to provide a fully photonic method and apparatus for reducing pulse width, and thus concentrating information, while reducing energy levels, without sacrificing signal-to-noise ratio.

### BRIEF SUMMARY AND OBJECTS OF THE INVENTION

In view of the foregoing, it is a primary object of the present invention to provide a method and apparatus for encoding and decoding signals. Preferably, such an apparatus may include an ability to handle an input signal of arbitrary data rate.

Consistent with the foregoing objects, and in accordance with the invention as embodied and broadly described herein, an apparatus and method are disclosed, in suitable detail to enable one of ordinary skill in the art to make and use the invention. In certain embodiments an apparatus and method in accordance with the present invention may include a photonic encoder connected to receive an input signal, and encode at a rate governed by the cycle time of a photonic wave. For example, in certain embodiments, encoding may occur within a single cycle of an electromagnetic wave, whether optical, microwave, or other spectrum. In alternative embodiments, a photonic decoder may connect to receive from an encoder an output signal over a transmission medium. A signal may be modulated in a domain selected from phase, spread spectrum over a time domain, over a frequency domain, over frequency itself, over amplitude, over polarization, or any combination of the foregoing.

In certain embodiments, a modulated photonic source may encode signals by splitting a parent signal to provide subsequent daughter signals, having an exact wave form, absent amplitude equality, with the parent signal. Each of the daughter signals is coherent with each other, but the daughter signals may be serialized by a delay mechanism, spacing one daughter signal after another. In this way, the daughter signals are substantially identical to within the granularity of a single cycle of the photonic wave, except for amplitude. Input signals may actually be selected from digital pulses, analog signals, multi-level semaphore, multi-level logic signals, two-dimensional images, or the like.

In certain embodiments, daughter signals may have a coherence characteristic rendering them unique as against all other transmitted signals. Amplitude equality is not required, since wave splitters or beam splitters typically provide some variation in the division of amplitude (energy content) of daughter signals.

In selected embodiments, a coherence characteristic shared by daughter pulses may be selected from a coherence time less than a time duration of a wave form, a coherence time longer than the duration of a wave form, or a coherence time substantially equal to the duration of a corresponding wave form. Frequency content may be selected from a narrowband spectrum, broadband spectrum, or a combination thereof.

Thus, first and second daughter signals, split from an original parent signal, may be characterized by a shared fingerprint comprising a combination of a coherence characteristic, and a frequency content. Meanwhile, a second daughter pulse or daughter signal (analog or digital, etc.) may be delayed with respect to a first daughter signal by a time delay characterized by a difference defined by traverse times between two paths. That is, a second daughter pulse may be delayed through a longer optical or photonic path, such as a changed index of refraction, a longer length or the like, in order to provide an offset in time between the two daughter signals.

A combiner may be operably connected in order to recombine daughter signals, one now delayed, thus encoding the two signals for transmission to a destination. Delay mechanisms may include mirrors, prisms, holographic structures, fiber lengths, spatial paths, or the like calculated to provide a particular time delay. Meanwhile, image splitters or beam splitters may split the parent signal into daughter signals based on a domain selected from polarization, amplitude, wavefront, or the like. Moreover, multiple encoders and multiple decoders may be “ganged” in parallel or series.

Similarly, at a receiving end of a communication, a decoder may also be formed using a splitter, for receiving daughter signals, and thus further splitting the daughter signals into granddaughter signals. Accordingly, a decoder combiner may then receive the granddaughter signals, recombining them in order to provide a combination of noninterference, constructive interference, and destructive interference. According to the photonic interference of the daughter signals, a reconstituted output pulse may be formed, completely regenerating all information from an original parent signal, which recombination can only be accomplished by exactly coherent waves such as the daughter signals and granddaughter signals, through photonic interference. Anything other than an identical (again absent amplitude) wave form will not produce the interference pattern required to give the reconstituted signal back.

In certain embodiments, a method in accordance with the invention may include receiving first and second daughter pulses that arrive at a destination as a coherent set. The term “pulse” is for convenience and all that is stated regarding pulses applies to other signals as well. The daughter pulses may be characterized or created by receiving a pulse of energy, splitting a pulse into at least first and second daughter pulses, selecting a characteristic time, introducing a delay equal to the characteristic time, and transmitting the daughter pulses toward the destination as a coherent set. Thereafter, the method may include splitting from each daughter pulse, duplicate granddaughter pulses, delaying each according to the characteristic time and producing interference therebetween.

The wave interference reflects the relative coherence between any set of first and second daughter pulses or granddaughter pulses. In certain embodiments, detection of the interference may rely on photonic detection, holographic detection, electronic detection, electro-optical detection, acoustic detection, or a combination thereof. Detection may also include detection of destructive interference, constructive interference, or differential therebetween.

In certain embodiments, first and second daughter pulses may be received at a first destination as a coherent set and split into granddaughter pulses, one of which is then delayed with respect to a first granddaughter pulse by a time delay corresponding to an original encoding time delay. Recombining the granddaughter pulses produces wave interference, the output of which reflects the modulated information originally encoded. In certain embodiments, a plurality of photonic encoders and photonic decoders may be arranged in a configuration selected from parallel, series, or a combination thereof in order to provide effective multiplexing of signals.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a delay-domain multiplexing system in accordance with the invention;

FIG. 2 is a schematic block diagram of a photonic network embodying an apparatus in accordance with FIG. 1;

FIG. 3 is a schematic block diagram of a delay-domain multiplexer configured to receive a modulated signal containing information;

FIG. 4 is a schematic block diagram of an encoder module, illustrating the details of internal operations thereof, in accordance with the apparatus of FIGS. 1-3;

FIG. 5 is a schematic block diagram of an amplitude splitter for creating multiple daughter signals from an initial parent signal;

FIG. 6 is a schematic block diagram of a polarization splitter configured to create daughter signals from an input parent signal;

FIG. 7 is a schematic block diagram of a splitter illustrating the single-cycle character of the splitting function enabling single-cycle resolution of multiplexing information;

FIG. 7A is a schematic block diagram of a splitter configured to process image signals and maintain spatial information in accordance with the invention;

FIG. 8 is a schematic block diagram of one embodiment of a beam combiner in accordance with the invention;

FIG. 9 is an alternative embodiment of a beam combiner in accordance with the invention;

FIG. 10 is a schematic block diagram of an encoder module illustrating the operation of an assembly of beam splitters, mirrors, and other photonic elements;

FIG. 11 is a schematic block diagram of a composite encoder module assembly configured to operate with multiple time delays, and thus provide multiple daughter signals from a single parent signal;

FIG. 12 is a schematic block diagram of one embodiment of a decoder module, configured to provide coincidence detection in accordance with the invention;

FIG. 13 is a schematic block diagram of one embodiment of a decoder module in accordance with the invention, and illustrating both holographic and beam splitter implementation;

FIG. 14 is a timing diagram corresponding to the operation of the apparatus of FIG. 13;

FIG. 15 is a timing diagram illustrating delay-domain multiplexing of multiple channels;

FIGS. 16-17 are schematic block diagrams of alternative embodiments of a coincidence detection interferometer in accordance with the apparatus of FIG. 12 illustrating the single-cycle resolution of the interference process as used in an apparatus and method in accordance with the invention;

FIG. 18 is a waveform diagram illustrating a delay-domain encoded analog signal;

FIG. 19 is a timing diagram of one embodiment of a multi-level semaphore daughter signal set;

FIG. 20 is a multi-domain signal, illustrating the characteristic fingerprint thereof, as an aggregate of time, frequency, and amplitude domains;

FIG. 21 is a schematic block diagram of a decoder in accordance with the invention configured to process two-dimensional images;

FIG. 22 is a schematic block diagram of a photonic processor for comparing differential outputs;

FIG. 23A is a schematic block diagram of an alternative relying on an electronic processor for processing the complementary outputs of a decoder;

FIG. 23B is a schematic diagram of a differential decoder as an alternative embodiment to the apparatus of FIGS. 22 and 23A, using noise cancellation to improve the signal-to-noise ratio;

FIG. 24 is a schematic block diagram of a drop-rearrange-add apparatus for unbundling and rebundling multiplexed information;

FIG. 25 is a schematic block diagram of compound-domain, broadcast multiplexing using a delay-domain multiplexor in accordance with the invention;

FIG. 26 is schematic block diagram of an alternative embodiment of a compound multiplexing system in which the delay-domain multiplexing apparatus is interior in a network, with respect to conventional analog and other multiplexing apparatus;

FIG. 27 is a schematic block diagram of one embodiment of a multiple-delay path for implementing encoding and decoding in accordance with the invention, and relying on integrated delay and delay correction;

FIG. 28 is a schematic block diagram of one embodiment of an apparatus in accordance with the invention configured to process a non-return-to-zero (NRZ) signal transparently;

FIG. 29 is a timing diagram corresponding to the apparatus of FIG. 28;

FIG. 30 is a schematic block diagram of one embodiment of a phase-sequenced, dual-channel encoder;

FIG. 31 is a schematic block diagram of a phase-sequence, dual-channel decoder;

FIGS. 32-33 are timing diagrams for two channels of an apparatus in accordance with FIGS. 30-31;

FIG. 34 is a schematic block diagram of one embodiment of a quadrature-encoding and decoding apparatus in accordance with the invention, incorporating two of each of the apparatus of FIGS. 30-31;

FIG. 35 is a truth table for the decoder of FIG. 34;

FIG. 36 is timing diagram corresponding to the apparatus of FIG. 34;

FIGS. 37A and 37B are schematic diagrams of a polarization beam splitter, illustrating the relationship between the polarization components, with respect to an apparatus in accordance with the invention;

FIG. 38 is a schematic block diagram of a double encoder relying on polarization sequencing to differentiate multiple channels sharing a single time delay between encoded daughter signals;

FIG. 39 is a schematic block diagram of a double decoder relying on polarization sequencing to differentiate two channels sharing a single time delay, in accordance with the apparatus of FIG. 38;

FIGS. 40-41 are timing diagrams corresponding to two channels of an apparatus in accordance with FIG. 39;

FIG. 42 is a schematic block diagram of a pulse concentrator in accordance with the invention;

FIG. 43 is a timing diagram illustrating the signal processing, and resulting concentration of pulses, of the apparatus of FIG. 42;

FIG. 44 is a schematic block diagram of an apparatus in accordance with the invention provided with a burst generator and subsequent processing of a signal generated thereby;

FIGS. 45-46 are schematic block diagrams of alternative embodiments of a burst generator in accordance with FIG. 44;

FIG. 47 is a timing diagram of a burst generator in accordance with FIGS. 44-46;

FIG. 48 is a schematic block diagram of a compound modulation apparatus in series with a delay-domain multiplexing system;

FIG. 49 is a schematic block diagram of one embodiment of a pre-conditioning modulator corresponding to the apparatus of FIG. 48; and

FIG. 50 is a chart reflecting one embodiment of a frequency shift between a delayed daughter signal associated with a first daughter pair and direct daughter signal associated with a subsequent daughter pair.

### DETAILED DESCRIPTION OF THE PREFERRED EMBODIMENTS

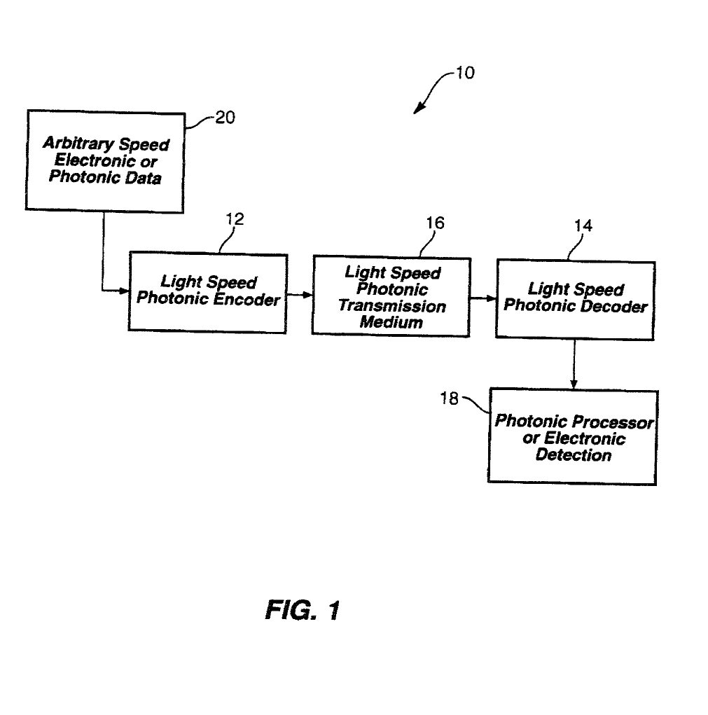

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 23, is not intended to limit the scope of the invention. The scope of the invention is as broad as claimed herein. The illustrations are merely representative of certain, presently preferred embodiments of the invention. Those presently preferred embodiments of the invention will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only by way of example, and simply illustrates certain presently preferred embodiments consistent with the invention as claimed.

Referring to FIG. 1, an apparatus 10 for communications, over an all-photonic or fully-photonic transmission system may include an encoder 12 for encoding signals at photonic speeds. By photonic is meant all electromagnetic radiation in which communications may be embodied, regardless of frequency. Thus, photonic frequencies include microwave, radio waves, optical waves, and the like. The encoder 12 may transmit signals embodying information to a decoder 14 at a receiving end of a transmission system.

The transmission medium 16 connecting the encoder 12 to the decoder 14 may be any medium suitable for carrying a photonic transmission in a wavelength selected. Typical transmission media may include fiberoptic fibers, fiber bundles, (particularly coherent fiber bundles in which positions of fibers in the bundle are maintained with respect to one another in order to transmit “pixel-light” elements of images) two-dimensional arrays of signals, and the like, while maintaining any spatial distribution or modulation imposed on the signals.

Metal structures of various types may be used as wave guides in various electromagnetic frequency ranges. For example, microwave transmissions may include gold, copper, aluminum, brass, silver, or other wave guides shaped as wires, tubes, and the like, in order to transmit photonic signals. In general, the purpose of any communication network, such as the apparatus 10, is delivery to a destination 18 of information (typically embodied in some type of a signal to be decoded) from a source 20 or a data stream 20.

In one presently preferred embodiment, the delivery of data 20 at an origin may be committed to the transmission process at an arbitrary rate or speed. Accordingly, in certain embodiments, an encoder 12 may operate at such speeds as to accommodate any arbitrary speed of the originating data 20. In the limit, the encoder 12 and corresponding decoder 14 may operate at speeds suitable for handling data up to the cycle time of an individual wave of electromagnetic energy. This means that an individual bit, in the limit, may be represented as one wavelength of a photonic carrier modulated to embody the transmitted information.

Information is embodied in signals. Signals have some minimum size or maximum level of resolution. That is, information ultimately must be recognizable in order to be encoded and decoded.

Typically, in digital data, a bit is a single piece of information, a one or a zero value. Nevertheless, in an analog signal, the same principle exists. That is, some minimum level of distinguishable modulation must be interpreted as information. Often in a process of communication or competition, data is referred to as data at an “atomic” level. An atomic level of data is the smallest size that any process can recognize as an individual, processible unit.

In digital data, a bit is the smallest atomic level of data. In certain embodiments, binary data may actually be digital or analog. Thus, referring to ones and zeros as digital or binary, should not be interpreted to restrict in any way an apparatus and method in accordance with the invention. Thus, in a binary sense, data can be modularized in accordance with the invention down to an atomic level corresponding to a single bit of data. Meanwhile, that bit can be modularized or embodied down to a single wavelength of a carrier.

One may think of an apparatus and method in accordance with the invention as representing a time-division, multiplexer. That is, a multiplexer is an apparatus for combining information streams from various sources, and transmitting those streams, in a pseudo-simultaneous manner, by dividing portions of the information of each stream and interleaving them in a time-division multiplexed fashion. Thus, a single carrier may simultaneously carry streams from multiple sources, interleaved at some division level.

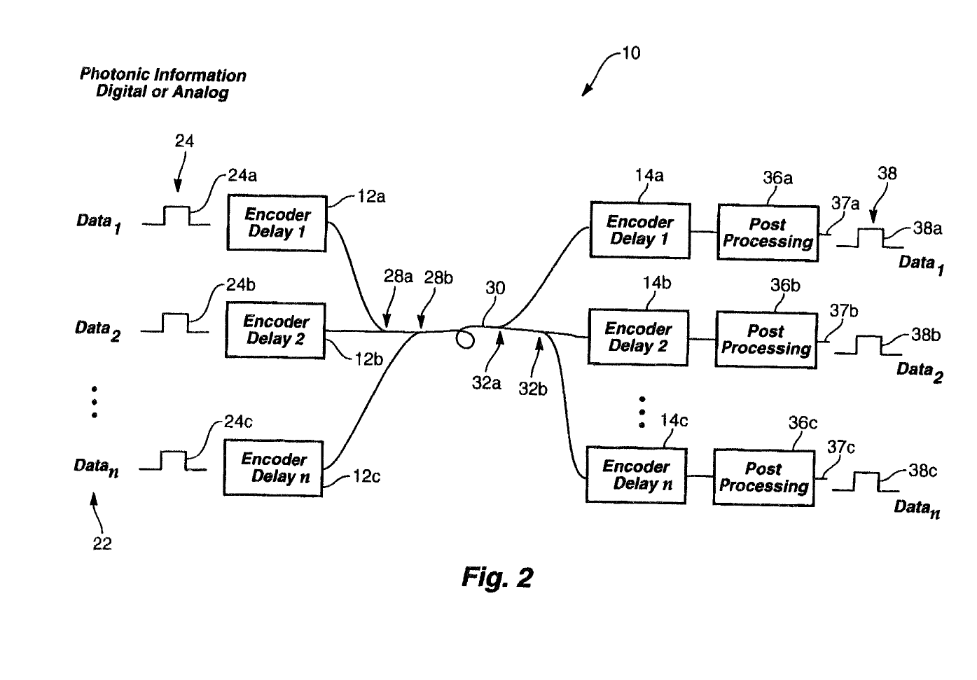

Referring to FIG. 2, data 22 from a variety of sources, may be embodied in signals 24 (for example, signals 24a, 24b, 24c). Each of the signals 24, embodying information 22 or data 22 must then be encoded in some type of encoder 12 in a fashion that may be interpreted later by a decoder 14 at a destination.

Broadcast routing refers to the ability of a system 10 to combine the information 22 from disparate encoders 12 and even combine it through various junctions 28 (for example, the junctions 28a, 28b) at disparate times and places. Thus, by combining streams of information at various junctions 28, a single line 30 may become a trunk carrying multiplexed information from widely distributed times and places, as it is transmitted to widely disparate destinations.

Similarly, junctions 32 may be responsible to subdivide, physically, the energy embodied in a multiplexed signal, in order to deliver to ultimate decoders 14 at disparate destinations the information embodied in the original data 22. At a destination, a decoder 14 corresponding to an encoder 12, may decode signals for additional processing by a post processor 36, ultimately responsible to deliver data 38 reconstituting the original data 22.

In certain embodiments of an apparatus and method in accordance with the invention, the lines 37 may have post processing. The signal 38 that is a virtually identical representation of the original signal 24. Accordingly, the apparatus 10 or network 10 may actually become a virtual fiber, reconstituting signals 38 identical to signals 24, regardless of intervening media, formatting, other multiplexed signals, or the like. Thus, a multiplexed signal, may be regarded as if it had been sent over a dedicated line, due to proper encoding and decoding.

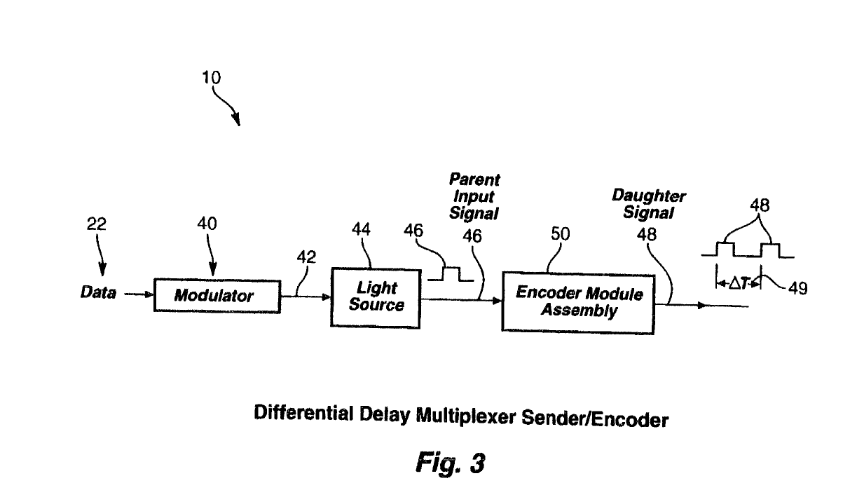

Referring to FIG. 3, a differential-delay multiplexer 10 may include a signal 22 received through a modulator 40 outputting a modulated signal 42. The modulated signal 42 is received by a photonic source 44 and converted into a photonic signal 46. The photonic signal 46 may be regarded as a parent signal 46, such as a signal 24 of FIG. 2, which will eventually result in the daughter signals 48 output as a result of the operation of the encoder 50 (e.g. an encoder 12) in accordance with the invention.

One principal mechanism used by the encoder 50 is imposition of a time delay 49 between daughter signals 48 that each embody all of the wave characteristics of the signal 46, absent amplitude, since amplitude can vary from exact equality in a splitting operation. The responsibility of the encoder module 50 is to prepare a signal 48 suitable for transmission to an ultimate destination. In an apparatus and method in accordance with the invention, the encoder module 50 creates time-delayed signals 48, thus creating a differential delay multiplexing encoder for creating a plurality of signals 48 of exact coherence, and virtually identical wave form absent amplitude.

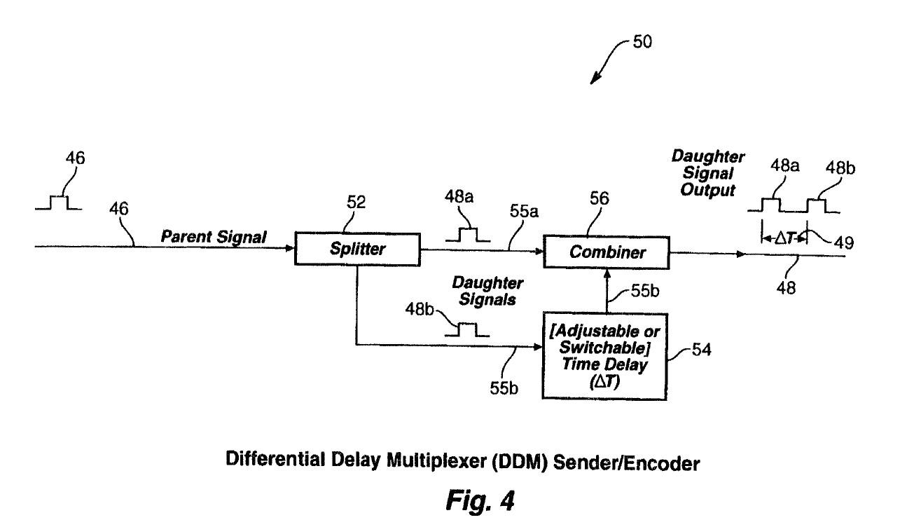

Referring to FIG. 4, an encoder module 50 may include a splitter 52 for producing duplicate signals 48a, 48b from a parent signal 46. In one presently preferred embodiment, a time delay apparatus 54 may provide a differential delay 49 between the signals (e.g. pulses) 48a, 48b. Thus, the path 55a may be regarded as a direct path, while the path 55b may be regarded as a delay path. The delay may be incorporated by any suitable mechanism such as a change in the indices of refraction between two materials or between portions of a single material, and additional distance in space or through a particular device, transmission medium, or the like. In certain embodiments, the time delay mechanism 54 may be adjustable. Nevertheless, in other embodiments, a fixed time delay 49 from the apparatus 54 may be adequate.

In the embodiment of FIG. 4, a combiner 56 effectively multiplexes the signals 48a, 48b into the encoder output 48 illustrated. Thus, each of the pulses or signals 48a, 48b, whether analog or digital, is separated by a time delay 49 between corresponding locations in the wave form.

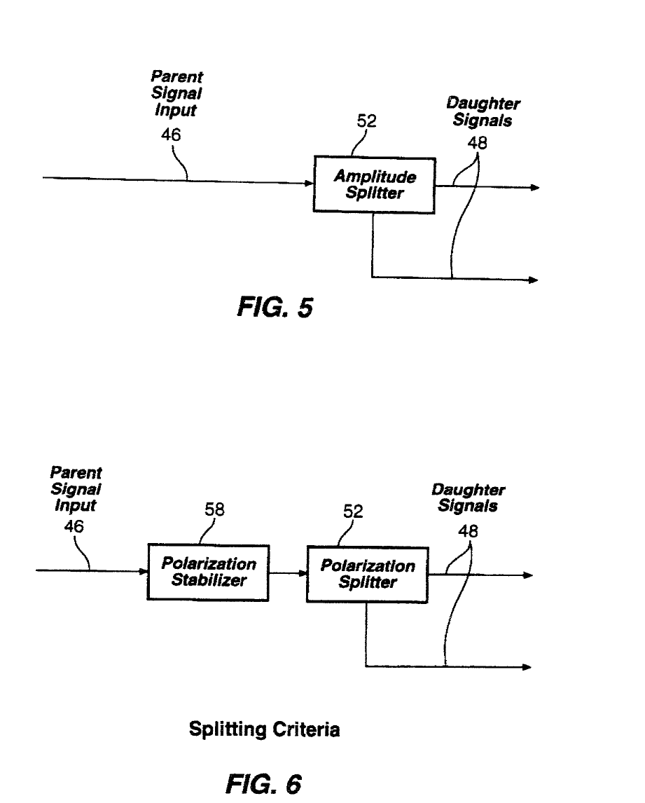

Referring to FIG. 5, a parent signal 46 may provide an input to a splitter 52 of various constructions. In the illustrated embodiment, the splitter 52 divides the parent signal 46 into daughter signals 48 relying on an amplitude splitter. Thus, the intensities or energy levels of the daughter signals 48 may be approximately halved with respect to that of the parent signal 46.

Nevertheless, all other aspects of the wave form of the daughter signals 48 can be expected to be coherent with each other, and identical to each other and the parent signal 46, except for amplitude. That is, since the amplitude has been split, the total energy of each daughter signal 48 must be different from that of the parent 46, and typically will be approximately half thereof. Nevertheless, the signals 48 are “complementary” in that the sum of their energies substantially equals the sum of the energy of the parent signal, but energies need not be equal to each other.

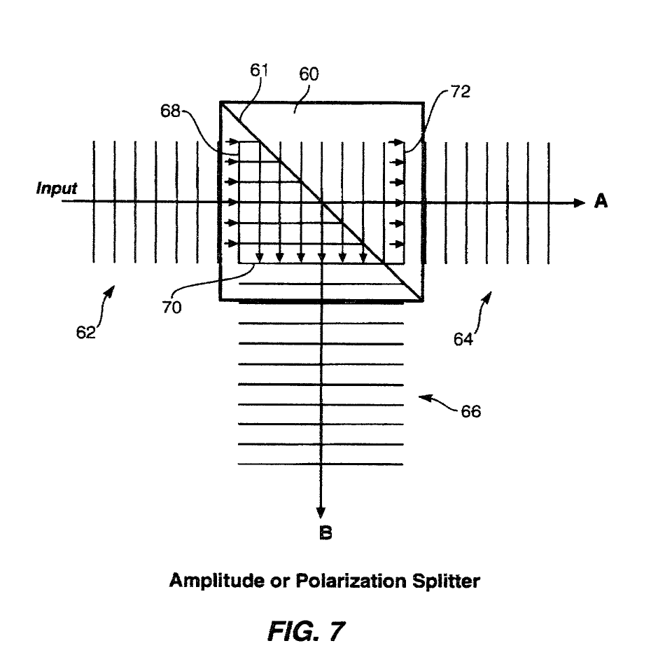

Referring to FIG. 6, an input signal 46, or parent signal 46, may also be split by a polarization splitter 52. In order to rely on a polarization splitter 52, a polarization stabilizer 58 may be required. One reason for the polarization stabilizer 58 is that the daughter pulses 48 have different polarizations. Rather than dividing on amplitude, the daughter signals 48 are divided on polarization. That is, each may typically be a single component, orthogonal to each other, of the original parent signal 46. Accordingly, if the polarization stabilizer 58 is not used, then care must be taken to assure that both orthogonal components and therefore both daughter signals 48, are present.

Otherwise, the polarization splitter 52 may effectively filter an entire component, rendering no daughter signal 48 in one of the channels. Commonly, when speaking of polarization, those in the art refer to a horizontal component and vertical component. These components are merely reflective of the orthogonal relationship between the two components, and do not necessarily refer to any absolute frame of reference.

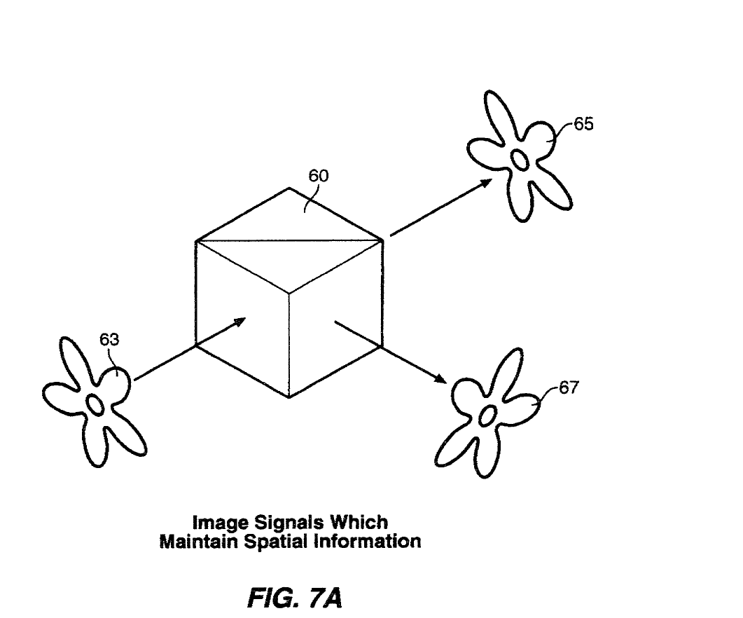

Referring to FIG. 7, one embodiment of a splitter, of which both amplitude and polarization splitters are available configurations, may rely on an input wave 62 having a plane wavefront 68. Typically, a collimating apparatus may provide a plane wavefront 68 in a wave 62 input into a splitter 60. Typically, a splitter 60 may be one of several types, including cubes, Wallaston prisms, Thompson prisms, calcite and other birefringent materials, and the like. In the embodiment of FIG. 7, the splitter 60 is of a cube type in which the splitter 60 includes a solid cube of optically or otherwise photonically transparent material. Along the surface 61 is a material that is partially transparent, even selectively transparent, depending upon the splitter type.

For example, in a polarization splitter 60, the surface 61 is polarization selective so as to transmit a wave 64, representing part of the energy of the wave 62, and to reflect a wave 66 containing the remainder of the energy of the input wave 62. An amplitude beam splitter 60 transmits a portion of the energy of the input wave 62 into a transmitted portion 64, reflecting the remainder in a reflected beam 66.

A significant feature of the beam splitter 60 is that the plane wavefront 68 remains a plane wavefront in the outputs 64, 66 because each individual wave 68 transmits or reflects on a cycle-for-cycle basis at the splitting surface 61, without amalgamation, confusion, or loss of any of the embodied information.

In one presently preferred embodiment, the surface precision of the surface 61 is sufficient to prevent any amalgamation of information between individual cycles (wave 68) with respect to either preceding or subsequent waves in the input stream 62. Although a beam having a spherical wavefront could be substituted for the input bream 62, and a spherical beam splitter surface could be substituted for the planar beam splitter surface 60, the architecture of FIG. 7 is simple, reliable, and capable of effecting the splitting process while maintaining necessary coherent interaction on a wave-by-wave basis.

Geometrically, it is clear that the surface 61 turns each wave 68 sequentially as it “walks down” the surface 61, providing an exactly reconstructed plane wavefront 70 on reflection, or passing the wave 72, each in turn walking down the surface 61, and providing the output 64. Accordingly, coherence and all other features of the waves 64,66 may be effectively preserved, with the exception of the feature that has been split off (amplitude, polarization state, etc.).

Referring to FIG. 7A, one embodiment of a splitter 60 may receive input signals 63 configured to embody information contained in the spatial distribution of the signal 63. Thus, energy may be distributed over an area, rather than just serially or sequentially in a single dimension as in the wave 62 of FIG. 7. Both temporally modulated and spatially modulated inputs or images 63 are available. Accordingly, when the splitter 60 passes a portion 65 or a daughter signal 65, and reflects, a daughter signal 67, each of the daughter signals 65, 67 contains a portion of the energy of the original signal 63, but all of the spatially modulated and temporally-modulated information originally included in the input signal 63. Of course, the daughter signals 65, 67 correspond exactly to daughter signals 48 of FIGS. 3-4. Accordingly, each of the images 65, 67 may be encoded precisely as illustrated in the apparatus and method of FIGS. 3-4. Therefore, as in all of the apparatus and methods of FIGS. 1-7, the transmission medium 16 into which each of the signals 65, 67 is transmitted may operate at photonic transmission speeds and may be selected from any suitable medium, from free space interconnections, and any other coherence-maintaining image conductor, such as coherent fiber bundles, optical solids, or other fully-photonic, coherent image transmission systems.

It should be remembered that each of the signals 63, 65, 67 may be modulated in time as an analog, digital, or sequential image, whether recognizable by human interaction or by other machine recognizable means. An additional benefit of the apparatus of FIG. 7A is that beam quality may be maintained. Specifically, beams typically embody a power distribution across their cross section. The variation may be referred to as a profile. Since the profile may vary in amplitude across an image, maintenance of beam quality assures full retrieval of the entire image profile upon decoding. Accordingly, the apparatus of FIG. 7A supports free space interconnection of multiple modules in any conceivable network configuration. Each individual component will be “transparent” to the transmitted images 63, 65, 67.

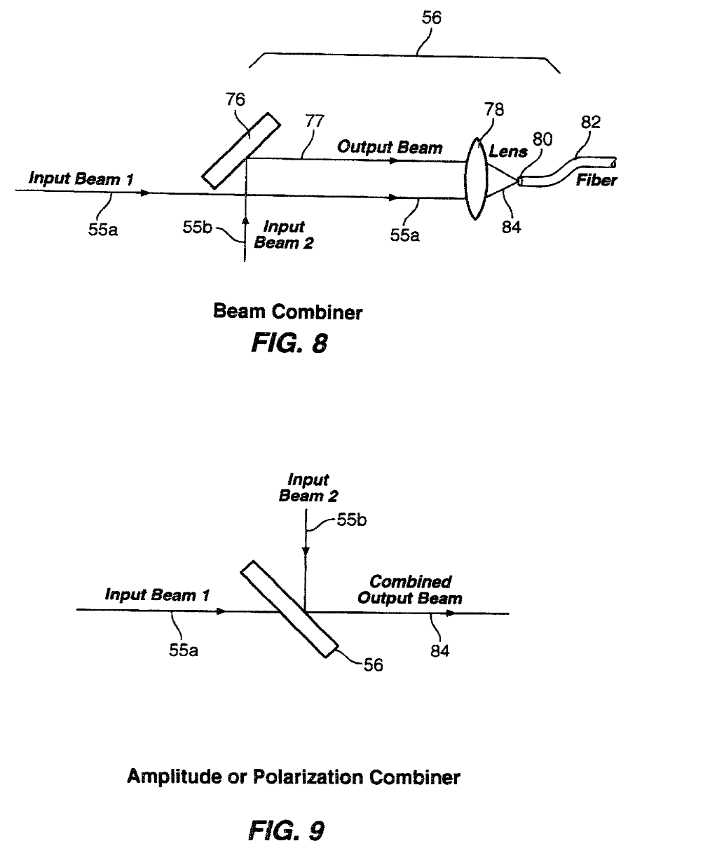

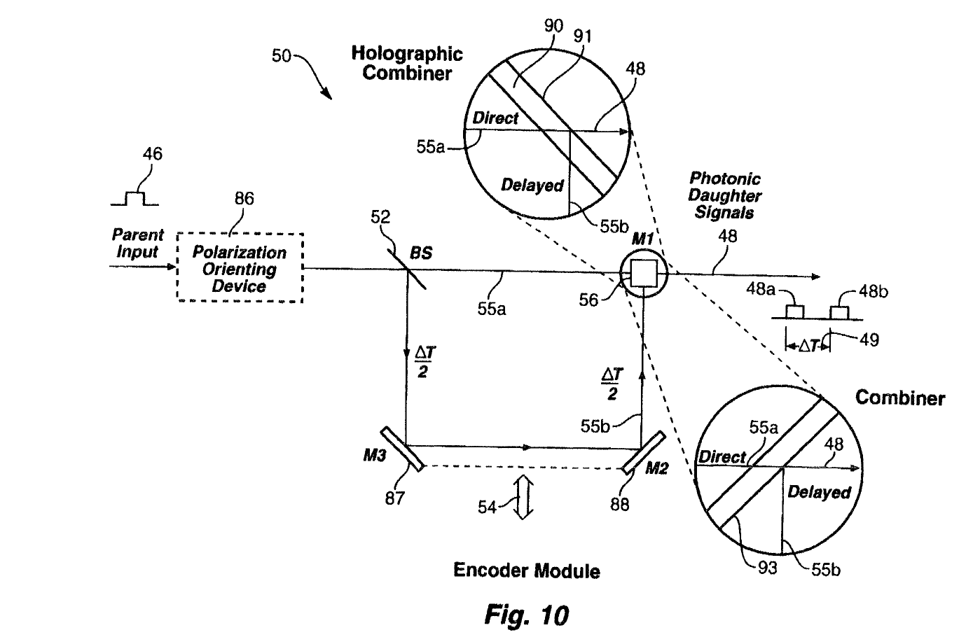

Referring to FIGS. 8-9, a combiner 56 (see FIG. 4) may be embodied in one of several architectures. For example, in the illustration of FIG. 8, a mirror 76 or reflector 76 may reflect an input beam 55b to a path 77 or signal 77 reflected through a lens 78. Meanwhile, a beam 55a (For example, the undelayed signal 55a) passes by the reflector 76, and also passes through the lens 78. Accordingly, the lens 78 combines the beams 55a, 55b (reflected 77) toward an aperture 80 for receiving the combined beam 84 to be conducted by a fiber 82 or other conducting mechanism. Thus, the lens 78 focuses the beams 55a, 55b such that the aperture 80 effectively multiplexes both signals 55a, 55b for transmission through the fiber 82.

Referring to FIG. 9, the input beam 55a may pass through a beam splitter type of combiner 56, which may be of an amplitude or polarization type. Similarly, the input beam 55b (typically the delayed daughter pulse 55b) reflects from splitter 56. Thus, the combined beam 84 represents the contribution of the reflected beam 55b, and the transferred beam 55a passing through the combiner 56.

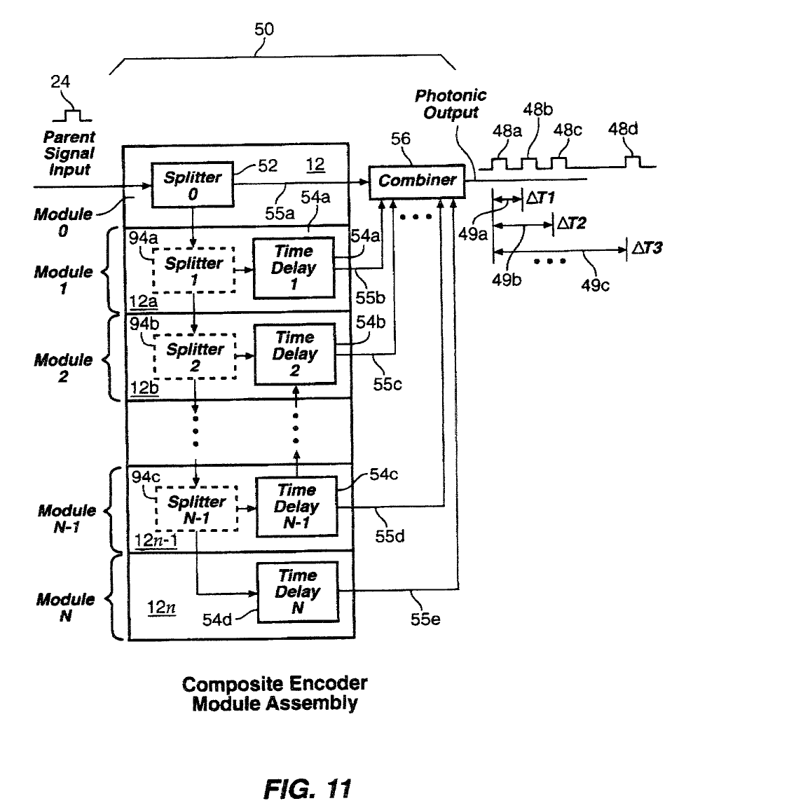

Referring to FIG. 10, an encoder module 50 may optionally receive a signal 46 through a polarization-orienting device 86. The polarization-orienting device 86 is optional, and depends on the type of input signal 46, relative to the operational characteristic of the encoder 50. For example, polarization beam splitting requires that the signal 46, or the signal 46, after processing by an orienting device 86, be properly prepared to operate in conjunction with the beam splitter 52 and the combiner 56.

In the embodiment of FIG. 10, a signal 46 is transmitted to a beam splitter 52 that passes a direct signal 55a to a combiner 56, and a delayed signal 55b off mirrors 87, 88, embodying a delay path. Accordingly, the distance involved in passing over the mirrors 87, 88, being indirect, results in a time delay 49 between each of the daughter pulses 48a, 48b resulting as outputs.

Meanwhile, the combiner 56 may be of one of several different available types. In one embodiment, the combiner 56 may be a hologram 90. The hologram 90 receives the direct 55a and delayed 55b signals at a surface 91 configured for the purpose of combining the signals 55 into an output 48.

Similarly, a mirror-type or beam-splitter-type combiner 56 may involve a partially-transmitting/partially-reflecting mirror 92 having a combining surface 93 for combining the direct 55a and delayed signal 55b into an output signal 48. Alternative embodiments of a combiner 56 may involve other phenomenon. For example, a combiner 56 may be selected from a fiber combiner, a collection of optical elements, various types of holograms, a non-focusing energy concentrator, partially reflecting mirrors, non-linear optical elements, a polarization combiner, or the like.

Moreover, the delayed signal 55b may be delayed by one of several phenomena. Traversing distance as illustrated in FIG. 10, is one simple embodiment that operates well in free space. Alternatively, time delays may be introduced into the signal 55b, or to delay the signal 55b from the signal 55a, by the addition of a wave guide, films, free space and distance, optical fibers, optical elements of differing indices of refraction, or the like. Moreover, differing types of delays may be introduced in different portions of encoders and decoders for accomplishing the same purpose.

For example, an encoder may use one mechanism for time delay, while a decoder may use a different mechanism to impose the same time delay in order to match the required time differential 49 between corresponding portions of daughter pulses 48a, 48b Moreover, in certain embodiments, an adjustable delay mechanism 54 may be used for the time delay 49. An adjustable mechanism 54 may actually be programmed to track or hunt for a particular time delay, or to move in accordance with a pre-programmed algorithm for determining time delay.

Thus, a certain amount of additional encoding, cryptography, or adjustment may be provided by an adjustable mechanism 54. Moreover, a time delay 49 may be produced in an encoder 12 or decoder 14, by a fixed delay mechanism 54, while the time delay in the other may be provided by an adjustable time delay mechanism 54. Thus, the transmission and receiving processes may be tuned to one another, much as a radio may be tuned up and down the available band to select a particular channel or a particular frequency. Meanwhile, adjustability may actually be done in a “digital fashion” or modular fashion, by which specific, fixed, time delays 49 may be introduced by selection and insertion, followed by removal in favor of another time delay 49. Thus, as snap-in modules, time delay mechanism 54 may be replaced in a rapid, interchangeable fashion.

An individual person is typically not capable of adjusting high-speed devices at appropriate rates. Accordingly, a computerized control mechanism may be used to adjust a time delay 49. Similarly, changing channels, or tuning, as well as insertion and replacement, followed by further replacements of time delay mechanism 54 may be accomplished by a computerized control mechanism, servos, or the like.

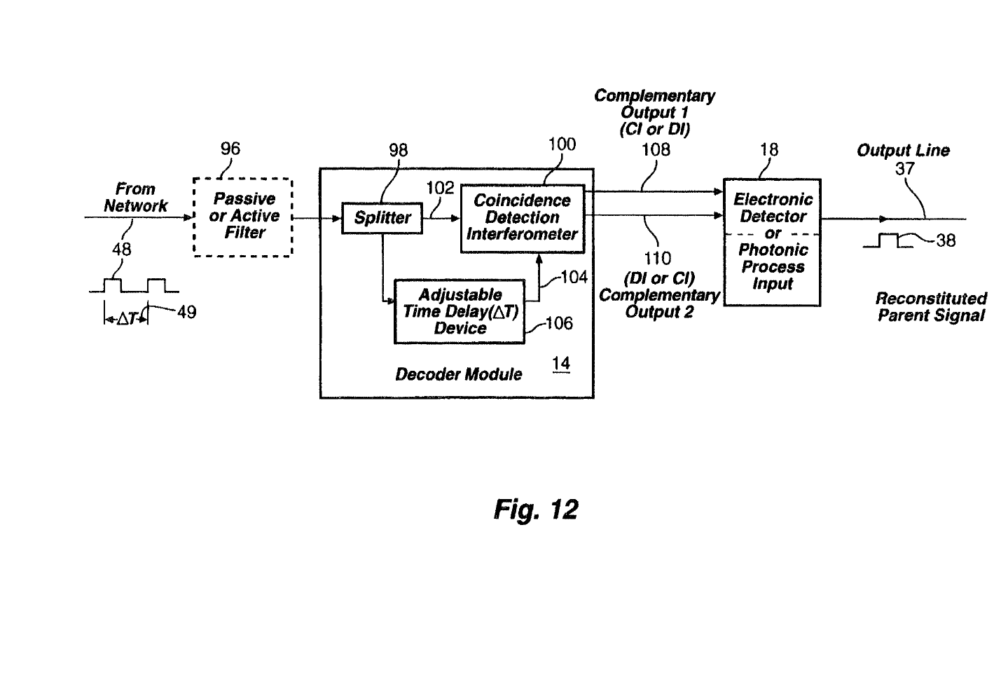

Referring to FIG. 11, an encoder 50 in accordance with the invention may rely on splitting a parent signal 24 in one or more splitters 52, in order to provide a series of daughter pulses 48. Each of the daughter pulses 48a, 48b, 48c, 48d, and so forth, may have a separate, corresponding time delay 49a, 49b, 49c, 49d, etc. In certain embodiments, alternative splitters 94a may continue to subdivide or split the energy of the original input signal 24, as received by the splitter 52. Splitters 94 may be arranged in a series, parallel, and in a variety of configurations in order to provide additional daughter pulses 48.

In one embodiment, individual time delays 49 may be created by time delay mechanisms 54 associated with each individual signal 55 (e.g. 55a, 55b, 55c, 55d, 55Ee etc.) in order to provide improved signal processing. For example, some of the purposes for providing more than two daughter signals 48 include an improved signal-to-noise ratio in certain networks, and inclusion of additional addressing information in certain types of networks. Thus, each of the signals 48 may contribute to an improved signal-to-noise ratio, or may include additional addressing information.

For example, not only can additional addresses or locations be identified for additional daughter signals 48, but coding may actually be embodied in the actual signal profile. This profile may be used, for example, to encode additional addressing information that may be interpreted by a receiving network at some point. Particularly in complex combinations of the features of the present invention, in sophisticated networks, addressing information may be so encoded in order to provide additional addressability, without requiring additional bandwidth. An improved signal-to5 noise ratio may not be evident in the daughter pulses 48 themselves, immediately. However, in keeping with the reconstitution of output signals 38 as a result of the decoder 14, individual signals 48 are nonlinearly combined, thus, providing greater contrast against a baseline of noncoherent line noise or other signals.

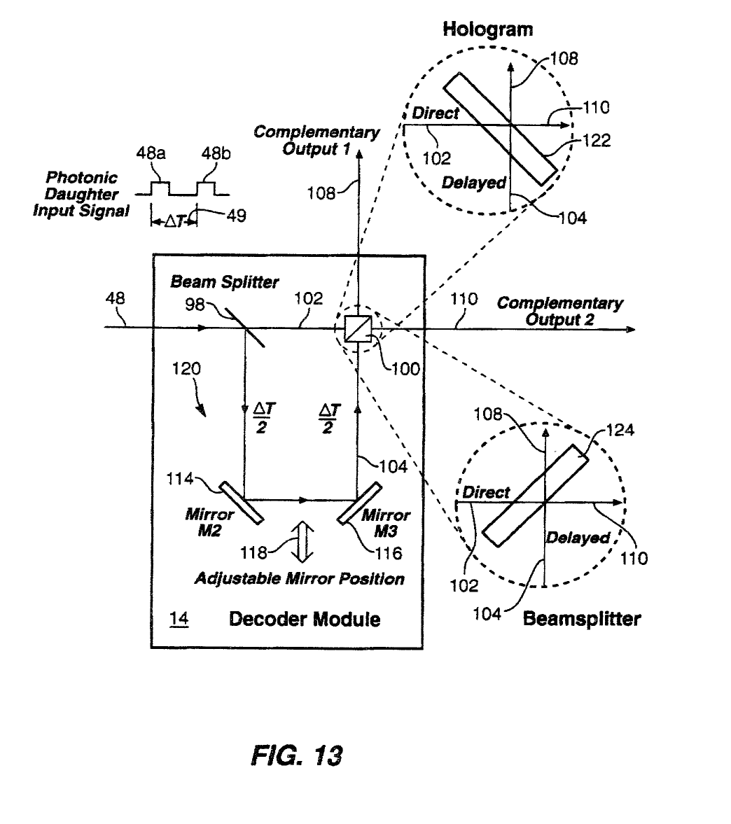

Referring to FIG. 12, a decoder 14 may receive a signal 48 through an optional filter 96. Although the filter 96 is not required, filter technology is available to filter out unwanted noise, or to allow the use of an apparatus in accordance with the invention in a wave-division-multiplexed system. Thus, a filter 96 may permit filtering of inappropriate signal content, particularly in an interface with legacy networks.

In one embodiment of the decoder 14, a splitter 98 may split the incoming daughter signals 48 received from the encoder 50. The splitter 98 may be selected from any of the types discussed above with respect to the encoder module 12. Accordingly, the splitter 98 should typically correspond in operation to the functional operation of the beam splitter 52 of the encoder module 50. Similarly, a splitter 98 produces or transmits a direct signal 102 and a delayed signal 104. The delayed signal 104 may be delayed for an appropriate time delay 49 corresponding to the original delay 49 by the encoder 50. Nevertheless, if a decoder 14 is to be operated at a resolution less than the cycle-for-cycle precision possible, then the time delay 49 between the signals 102 and 104 must be substantially the same as the encoder time delay 49, but need not be exact. Thus, the time delay device 106 may be constructed and operated in accordance with the principles discussed for the time delay device 54.

Each of the signals 102, 104 may be thought of as a granddaughter signal, being a daughter signal 102, 104 of the original daughter signals 48. A coincidence detection interferometer 100 has responsibility for comparing the granddaughter signals 102, 104 with one another. Accordingly, the interferometer 100 provides complementary outputs 108, 110. One of the complementary outputs 108, 110 will result from constructive interference between the granddaughter signals 102, 104. The other of the complementary outputs 110, 108 respectively, will result from destructive interference between the granddaughter signals 102, 104. In one presently preferred embodiment, a device 18 or post processing device 18 may rely on photonic or electronic mechanisms in order to process the complementary outputs 108, 110. In a photonic device 18, the signals 108, 110 may simply be passed through or directed for further processing. Similarly, an electronic detector 18 may reduce the photonic signals 108, 110 to electronic signals, for incorporation into controls for other electronic devices. Also, if the signal 38 is photonic, after post processing in the device 18, then it may be used directly as a signal, or as a control for other photonically controlled devices. All of the components necessary to construct a photonic post processor 18, may be derived from basic photonic transistor technology and other associated logical photonic components.

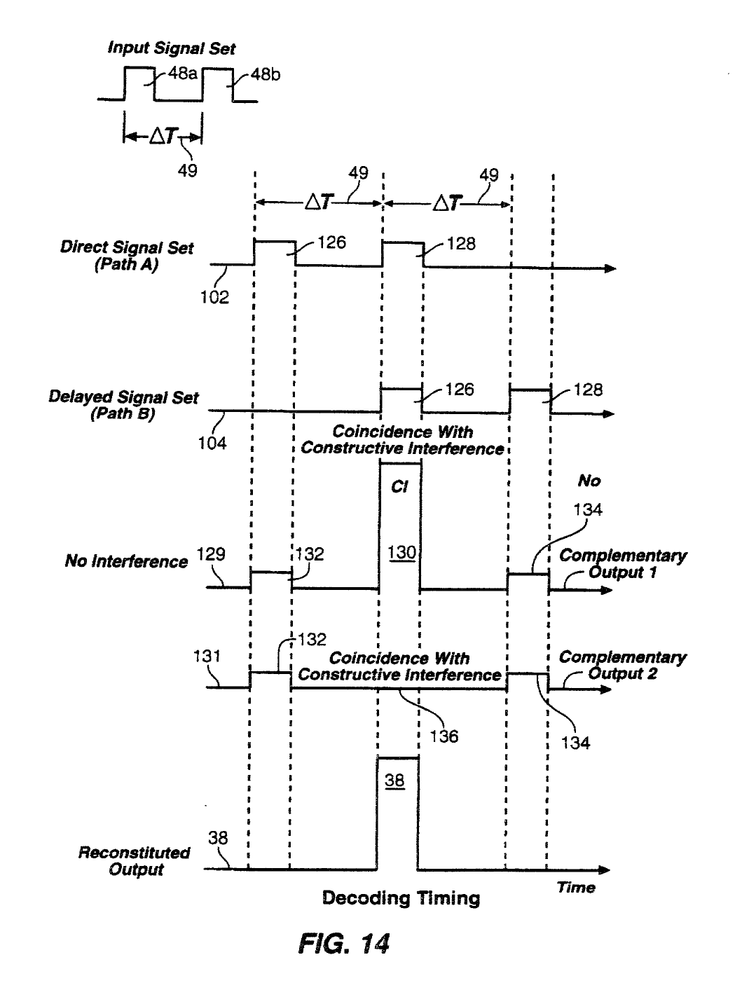

Referring to FIG. 13, a decoder module 14 may receive a signal 48, constituting the relatively delayed daughter signals 48 from the encoder 12, and specifically, from the encoder module 50. The embodiment of FIG. 13, illustrates one method, relying on free-space delay techniques, although all delay techniques are available. Similarly, the coincidence detection interferometer 100 is illustrated in two alternative embodiments, although all of the polarization beam splitter, non-linear optical elements, partially reflecting mirrors, holograms, a collection of optical elements, and a fiber combiner are all possible elements to be relied upon by the interferometer 100.

The signal 48 may be split by a beam splitter 98 into granddaughter pulses 102, 104. Accordingly, the mirrors 114, 116 may be fixed or adjustable mechanisms for adjusting the time delay 49, and thus tuning the decoder module 14. Meanwhile, the interferometer 100 receives the direct signal 102, and the delayed signal 104 (granddaughter signals 102, 104). The delay device 120 may include adjustment in a direction 118, of both mirrors 114, 116. Alternatively, the delay adjustment mechanisms discussed heretofore may also be relied upon as delay devices 120.

The interferometer 100 of FIG. 13, includes a hologram 122 operating as an interferometer receiving a direct signal 102, and delayed signal 104. The hologram 122 is configured to output complementary signals 108, 110, as described above. Similarly, in an alternative embodiment, a partially-reflecting mirror, or polarization beam splitter, may serve as the beam splitter 124. The direct signal 102 and delayed signal 104 may input into the beam splitter 124 in order to provide the complementary outputs 108, 110.

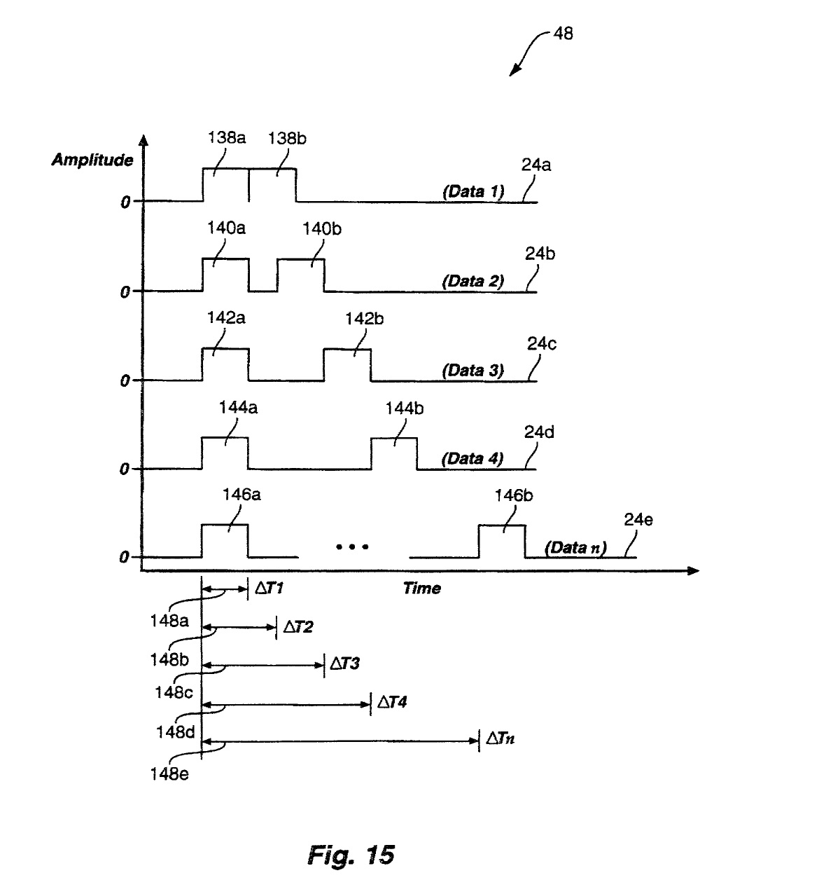

Referring to FIG. 14, daughter signals 48a, 48b are displaced from one another by a time delay 49. Each of the daughter pulses 48a, 48b is transmitted from the encoder 12, to arrive, eventually, at the decoder 14. In the decoder 14, the daughter pulses 48a, 48b are further split into granddaughter pulses 126, 128. A direct signal 102 includes one set of signals 126, 128. Meanwhile, a delayed signal 104 includes a later set of signals 126, 128. Inasmuch as the granddaughter pulses 126, 128 are coherent, superposition will result in constructive or destructive interference.

In general, the signal 108 may result in an output condition that is either constructive or destructive. Similarly, depending upon the phase relationship between the granddaughter signals 126, 128, the signal 110 may result in a destructive or constructive interference signal. The superposition signal 129 results from superimposing the signal 102 and the signal 104. The result is a central constructive interference region 130. The constructive interference region 130 provides an amplitude identifying the constructive interference resulting from the superposition of the granddaughter signal 126, from the signal 104, and the granddaughter signal 128, from the signal 102.

Meanwhile, the superposition signal 131 results from destructive interference between the granddaughter signal 126, from the signal 104, and the granddaughter signal 128, from the signal 102. A non interference region 132 exists due to the presence of a granddaughter signal 126, which provides no interference with another signal, but has an amplitude that is nonzero.

Similarly, following the constructive interference signal 130, the superposition signal 129 includes another non interference region 134. In this case, the granddaughter signal 128 from the signal 104 has no corresponding, coherent signal with which to create interference, but has a nonzero amplitude. The superimposed signal 129 or superposition signal 129 is one embodiment of a complementary output 108, 110, as appropriate.

Meanwhile, between the noninterference regions 132, 134 of the superposition signal 131 (an alternative candidate for either one of the complementary outputs 108, 110), a destructive interference region 136 provides a zero-amplitude signal. The zero value in amplitude results from destructive interference between the granddaughter signal 126 out of the delayed signal 104, and the granddaughter signal 128 out of the direct signal 102.

The result of the superposition signal 129 is a reconstituted output 38 in the case of constructive interference. In the case of destructive interference, a reconstituted output 38 may be a zero signal. Nevertheless, in one embodiment of the apparatus of FIGS. 12-13, the decoder 14 produces constructive interference from one of the complementary outputs 108, 110, and destructive interference in the other complementary output 110, 108, respectively.

Whether or not a complementary output 108, 110 is constructive or destructive depends on the phase relationship between the direct signal 102 and the delayed signal 104. An adjustable time 1 e delay device 106 may be responsible for the adjustment 118 of the mirrors 114, 116 in the apparatus of FIGS. 12-13. Thus, phase can be maintained in order to assure constructive or destructive interference in a complementary output 108, 110.

In one embodiment, phase may be maintained in order that one of the complementary outputs 108, 110 always represents (e.g. becomes) a constructive interference channel, while the other 110, 108 represents (e.g. becomes) a destructive interference channel. In other embodiments, phase may be manipulated in order to provide multiple channels of outputs, in which each of the complementary outputs 108, 110 may selectively provide destructive interference or constructive interference outputs.

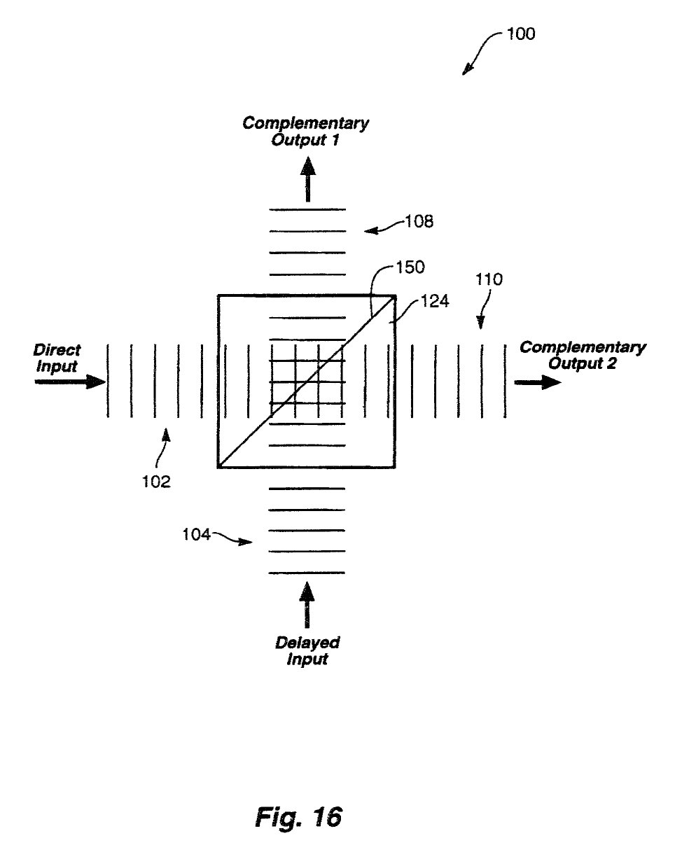

Referring to FIG. 15, different channels 24 may contain data derived from different parent signals. As illustrated in FIG. 2, parent signals 24 may come from various locations, and may be networked together in any geometric configuration over virtually any supportable geography. Broadcast routing may be supported by a multiplexing process in which individual daughter pulses 138a, 138b, for example, on an individual channel 24a, are separated by a time differential 148a. (Any signal and waveform can be substituted for the work pulse herein) Other daughter pulses 140a, 140b on a different channel 24b may be separated by another arbitrary time differential 148b. The system requirements to prevent unintended interference, to maintain channel isolation, and to prevent cross-talk in a broadcast routing environment are determined by the time differentials 148a, 148b, 148c, 148d, 148e, the operating frequencies, and the coherence times of the respective photonic sources generating the parent signals 24a, 24b, 24c. In other words, time differences and relative signal coherence properties govern system operations. By selecting unique time differentials 148, and photonic sources having coherence times shorter than the shorter of the two: the shortest time differential and the shortest time difference between time differentials, unintended interference is precluded and channel isolation is guaranteed.

Nevertheless, if the “unrelated” daughter pulses 138, 140, 142, 144, 146 are in danger of being coherent with each other, then the time differentials 148 may be adjusted accordingly, in order to multiplex overtime. Alternatively, photonic sources having shorter coherence times or different frequencies of operation may be employed.

Coherence length is not an absolute measurement for any system. Accordingly, each set of daughter signals 138-146 should have different time differentials 148, frequencies, or the like, in order to distinguish them. Nevertheless, the time differential 148 between any pair of daughter signals 138-146 is typically selected to be unique. Accordingly, in order to produce the constructive or destructive interference of FIG. 14, a set of daughter signals, 140a, 140b, for example, has a time differential 148b known by the encoder 12 and the decoder 14. Thus, unless a granddaughter signal 126, 128 arrives at the coincidence detection interferometer 100 both coherent and delayed by the proper time, proper constructive or destructive interference will not occur.

In order to eliminate any potential interference between channels 24, short coherent lengths are suitable. This will maximize the bandwidth, or number of channels 24, that may be carried over an individual carrier. Typically, the coherence time (length) of a particular signal should be less than the shortest time differential 148 associated therewith. In certain embodiments, the coherence time (length) may be less than the longest time differential 148, or less than the shortest time differential 148. In certain preferred embodiments, the coherence time (length) may be less than the shortest time differential 148, and shorter than the shortest signal pulse, or equivalent 138, 146.

It should be remembered that signals 138-146 need not be digital pulses. Nevertheless, in certain embodiments, the signals 138-146 may be pulses. In any event, a coherence length less than a signal length of interest may advantageously provide additional assurance against crosstalk between channels 24.

One advantage of an apparatus and method in accordance with the invention is that comparatively short coherence lengths may be used to advantage, whereas in conventional signal processing, a long coherence length is desired. Moreover, it is appropriate to speak of pulse width and pulse length, although signals 138-146 need not be pulses.

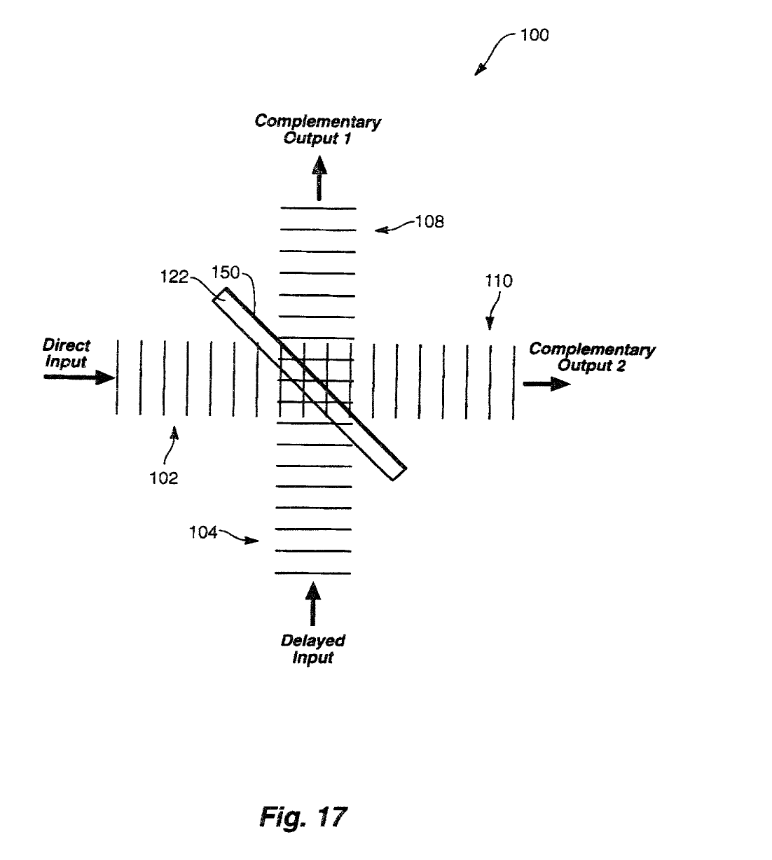

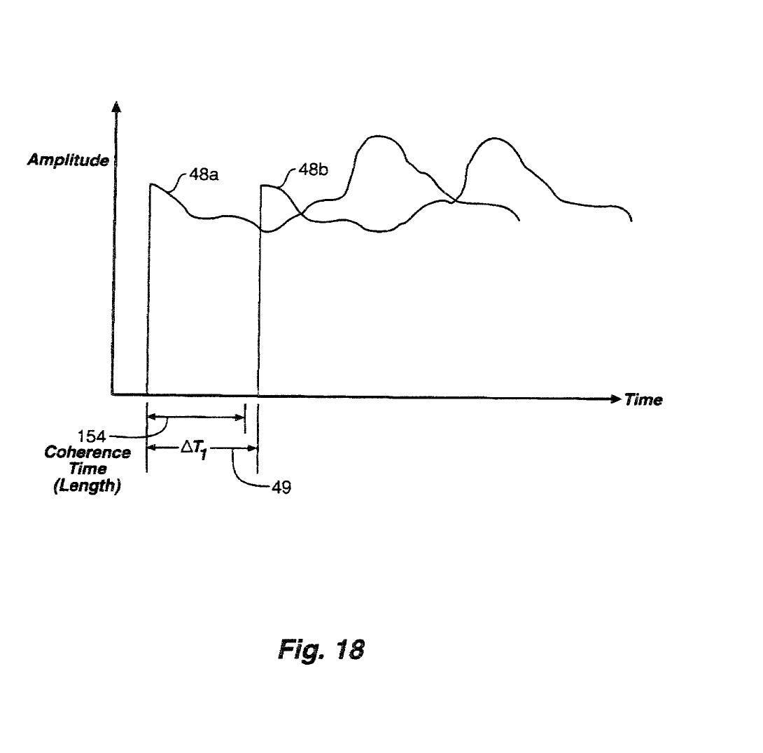

Referring to FIGS. 16-17, a beam splitter 122, 124 may be configured in one of several suitable configurations in accordance with the present invention. In the embodiment of FIG. 16, a beam splitter 124 may have an interferometric surface 150. In accordance with the invention, an incoming signal 102, a photonic signal input as a plane wave, enters the beam splitter 124, eventually encountering the surface 150. The incoming beam 102 walks up the surface 150, encountering and creating interference with the delayed input beam 104.

As illustrated, the beams 102 (direct input) and 104 (delayed input) interact on a cycle-for-cycle basis. The complementary outputs 108, 110 result. In the event of constructive interference, and in accordance with an appropriate phase of each signal 102, 104, relative to each other, a constructive interference wave may proceed out as either the complementary output 108, or the complementary output 110.

Similarly, opposite to the output path 108, 110 of a constructive interference wave, a destructive interference wave may propagate out the opposite complementary output 110, 108. Thus, by selective management of the relative phase of the input waves 102, 104, two channels 108, 110 for constructive interference may be provided. A destructive interference condition may propagated in an opposite condition.

Other shapes for the surface 150 are tractable. However, a plane surface 150 is a suitable and simple construction for ease of manufacture by several methods. It is advantageous to have plane-wave beams 102, 104 correspond to the planar surface 150. Other wavefront surface geometries with corresponding splitter surface geometries 150 are possible. For example, spherical beams 102, 104, with a spherical splitter surface 150 could be used.

Referring to FIG. 17, the surface 150 may be a developed emulsion formed as part of a hologram 122. As a practical matter, the surface 150 may be manufactured on a substrate that participates, or does not participate, in wave mechanics of the apparatus 100. In one presently preferred embodiment, a direct input 102 as a plane wave 102 and a delayed input 104 as a plane wave 104 may walk up the surface 150, interfering on a cycle-by-cycle basis. Depending upon the relative phase of the input beams 102, 104, a constructive interference output beam may be produced as one of the complementary outputs 108, 110. A destructive interference wave may be produced as the alternative output 110, 108. That is, a set of inputs 102, 104 may produce constructive interference as one of the outputs 108, 110. Accordingly, the other output 110, 108 would be a destructive interference wave. However, by manipulating the phase relationship between the beams 102, 104, the constructive interference wave may be produced in the opposite complementary output 110, 108, with a destructive interference wave in its opposite complement 108, 110.

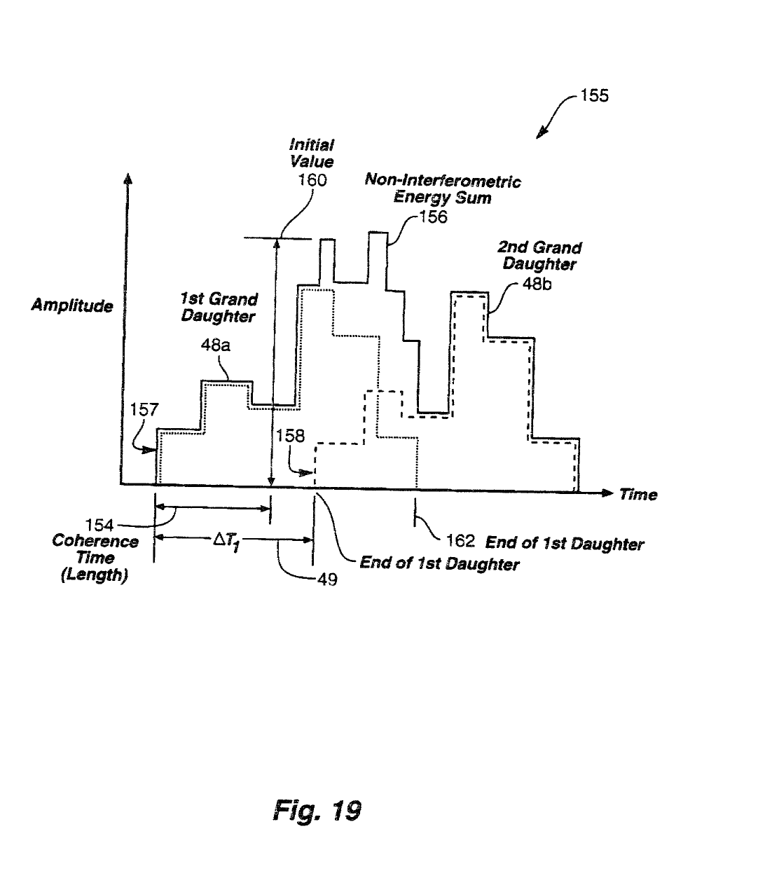

Referring to FIG. 18, daughter signals 48a, 48b are illustrated as they may appear in analog format. Each of the daughter pulses 48a, 48b is separated from the other by a time differential 49. The coherence time 154 of a photonic source is related to the coherence length by a constant value in any given uniform transmission medium. The coherence time of the source producing a parent of the daughter signals 48 should be less than the smallest time differential 49 used to separate corresponding, coherent, daughter pulses 48a, 48b.

As a practical matter, the coherence time 154 is actually a coherence time 154 associated with the originating photonic source that originally spawned a parent signal 24 from which the daughter signals 48 were derived. If the coherence time 154 becomes longer than the minimum time differential 49 used, then a danger of coherence between non-corresponding portions of the daughter signals 48a, 48b is a serious concern that may cause unwanted interference and frustrate proper encoding and decoding of the daughter signals 48.

Thus, analog daughter signals 48 are suitable, and can achieve the same result accomplished by digital or pulsed signals. An apparatus and method in accordance with the invention can process analog signals, digital signals, pulsed signals, multi-level semaphore signals, images, and so forth.

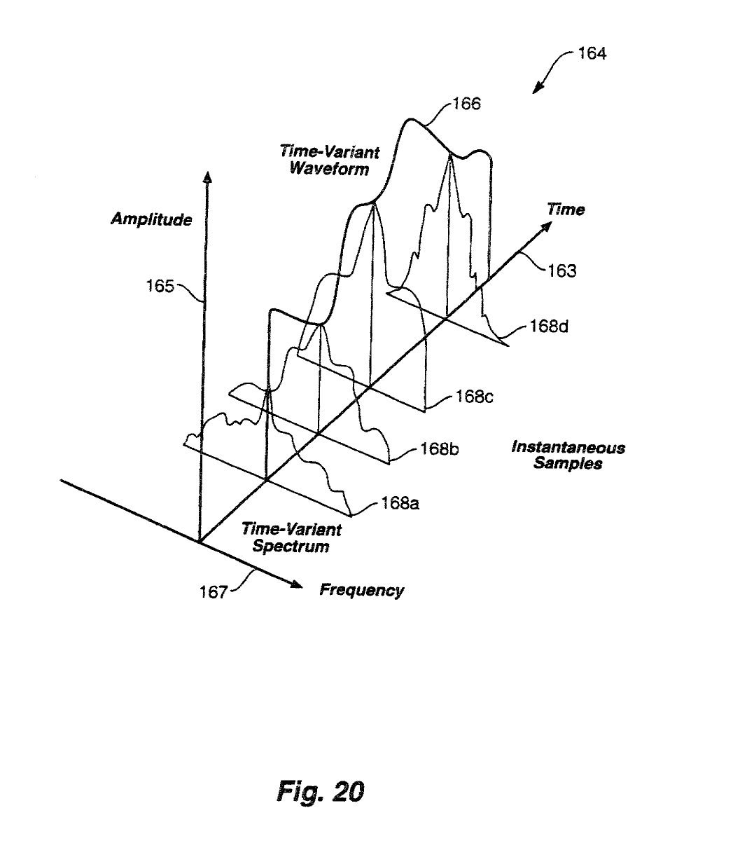

Referring to FIG. 19, a multi-level semaphore 155 may be characterized by an energy sum 156. The energy sum 156 may be envisioned as a graph integrating the energy from two multi-level semaphore signals. In the embodiment of FIG. 19, a daughter signal 48a begins at a starting point 157. At a time differential 49 later, a start point 158 begins a daughter signal 48b. Again, the coherence time 154 is less than the time differential 49.

Meanwhile, the total energy sum 156 follows the first daughter signal 48a, follows the superposition thereof with the second daughter signal 48b, and terminates with the amplitude of the second daughter signal alone after the end point 162 of the first daughter signal 48a. In a circumstance existing between the starting point 158 that initiates the second daughter pulse 48b during a portion of the first daughter pulse 48a, and up until an ending point 162, the noninterferometric energy sum 156 represents total photonic signal intensity. Yet, because the contributions from each of the daughter pulses are incoherent during the overlapping time 158 to 162, interference is not manifest. However, when the delay 49 is corrected in the receiver, interference occurs between matching wave components such as the components 157-158 representing the waveform in the output. One virtue of an approach as illustrated in FIG. 19, involving multi-level semaphore daughter signals is the potential for encoding additional information in the shape of the signal.

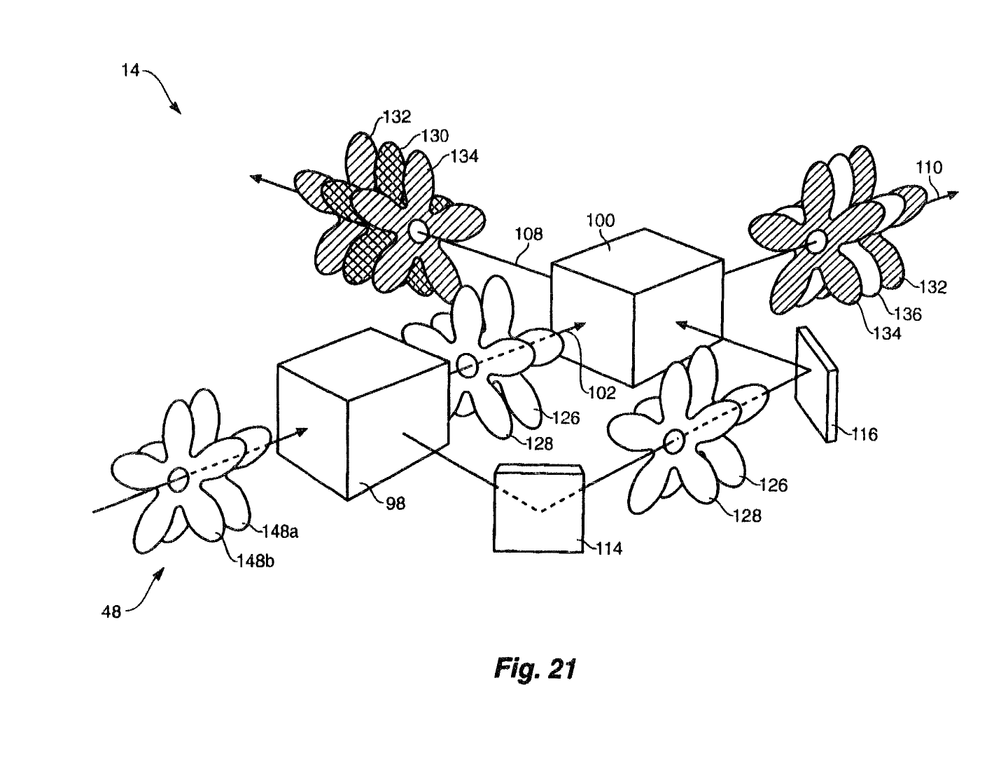

Referring to FIG. 20, an alternative embodiment of a time-variant wave form 166 illustrates an amplitude that varies over time, and varies also with each of a variety of frequencies within its domain. Variations in the amplitude 165 over time 163, throughout a number of different frequencies 167, the wave form 164 may embody information in the variations available in a host of variable parameters. Thus, a method and apparatus in accordance with the invention, when used to operate with waveforms similar to those illustrated in the wave form 164 of FIG. 20, transmit and receive (encode and decode) multi-spectral, time-varying, amplitude-modulated, phase-modulated, spatially-distributed (image) information. (Not all of the available parameters need to be used in encoding information.) Nevertheless, as illustrated in FIG. 20, the instantaneous samples 168a, 168b, 168c, 168d illustrate that modulation in any available domain may be relied upon, encoded, decoded, and multiplexed. Each waveform 164 has a unique organization in the time domain, frequency domain and amplitude domain. It is, therefore, much like a unique fingerprint of the waveform. An apparatus and method in accordance with the invention duplicates, transmits, and then receives such a complex waveform, extracting it from the conglomerate of noise and other multiplexing signals. This is accomplished by reconstituting (reconstructing) the same wave form, by matching the fingerprint-like daughter pulses and outputting that which matches.

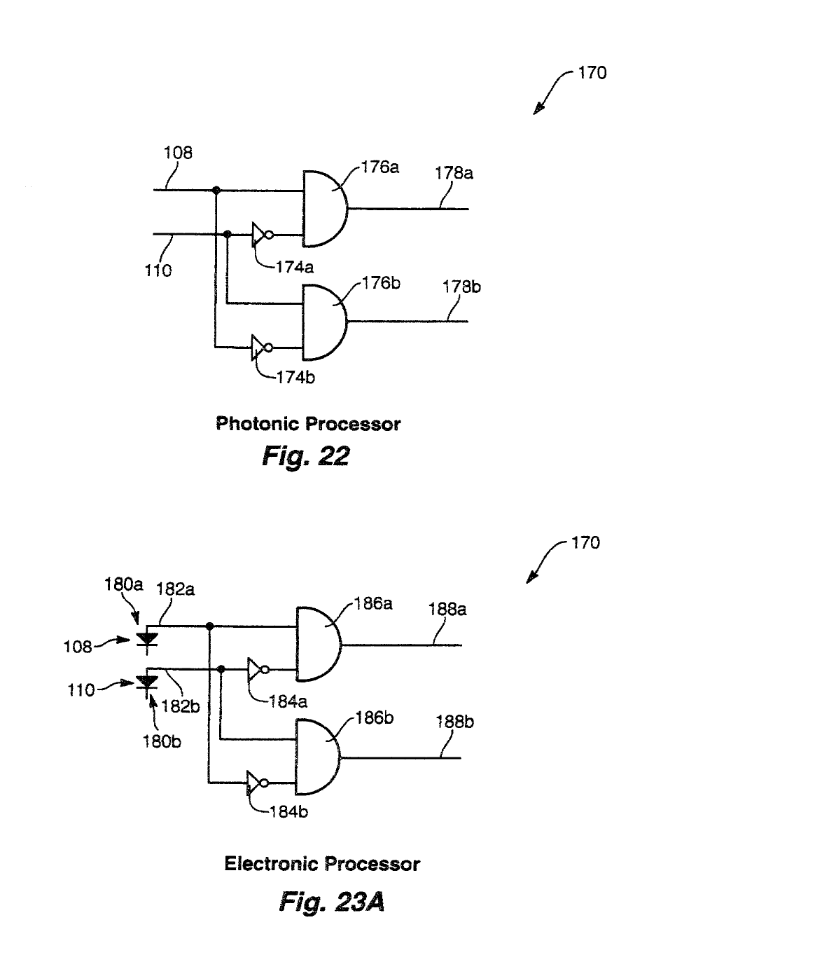

Referring to FIG. 21, a decoder 14 is illustrated, managing daughter signals 48, such as might be generated in an apparatus illustrated in FIG. 7a. In the embodiment of FIG. 21, daughter signals 48a, 48b enter a beam splitter 98. Granddaughter signals 126, 128 exactly matching the coherence and other wave characteristics of the daughter signals 48a, 48b (absent amplitude) pass through a direct path 102 and a delayed path 104, including the spatial and color relationships indicative of an image.

As described for other, simpler signals and pulses, the image signals 126, 128 are reconstituted in a coincidence detection interferometer 100. Accordingly, in one embodiment, a complementary output 108 provides a constructive interference region 130, flanked by non-interfering portions 132, 134. Similarly, through another complementary output 110, appears (or perhaps more properly disappears) a destructive interference portion 136, flanked by unaffected noninterference portions 132, 134. In certain embodiments, a differential amplitude may be detected between the constructive interference portion 130 of the complementary output 108, and the destructive interference 136 of the other complementary output 110. Thus, as illustrated in FIG. 21, the photonic apparatus 10, particularly the encoders 12 and decoders 14, can handle photonic signals regardless of their spatial distribution, time variance, or spectral extent. The destructive interference portion 136 is illustrated by an outline in FIG. 21. However, when the decoder 14, in accordance with the invention, is optimally tuned, the destructive interference region 136 is actually an absence of a signal. Nevertheless, that absence may be detectable with respect to the constructive interference portion 130, and even, in certain embodiments, with respect to the noninterference portions 132, 134, which actually have a signal value. Nevertheless, the major value is that differentiation between a constructive interference portion 130, and a destructive portion 136 can be detected and consequently, utilized.

It is no exaggeration to state that image-domain multiplexing provides massive bandwidth available only through such parallel processing. Such processing can be synchronized with other simultaneously multiplexed information in other domains. Multiplexing may be compounded by delay-domain multiplexing. Compounded multiplexing may involve domains such as delay-domain, frequency, time, polarization, image-domain, and the like.

An apparatus and method in accordance with the invention provide a practical way to implement bandwidths that other technologies have never contemplated. By coordinating information being multiplexed within various domains, synchronization of highly disparate types of information is tractable. For example, routing, data processing, various control instructions, hypertext, sound, background information, hierarchically databasing, and images may all be synchronized within the massive bandwidth available in accordance with the invention.

Thus, rather than simply providing a sound and image track as is done with video systems and movies, multiple streams of data may be synchronized for any purpose. For example, image data and reference information may be transmitted with sound, image overlays, and database interaction control data on a single stream of multiplexed information.

Potential applications include simply increasing bandwidth to comparatively massive proportions in a fully photonic, image switching system for supporting a holographic television system would overpower conventional technologies, but be highly tractable in accordance with the invention. Similarly, parallel processing of information management systems becomes almost trivial within the massive bandwidth available for a photonic computing system.

Likewise, a “holodeck” image control and projection system can be supported by an apparatus in accordance with the invention. Mass data storage with light-speed retrieval systems is contemplated. Parallel image, pattern recognition within databases may increase by many orders of magnitude both the size of the database, and the speed at which data can be made available.

Moreover, processing methods such as searching may be executed by image recognition at very high bandwidths of reviewed data, rather than the slower conventional systems currently used. Simultaneous examination of multiple petabyte databases may finally be tractable. Thus, an apparatus and method in accordance with the invention appears entirely capable of fully saturating virtually any current photonic transmission media, with precise, coordinated, multi-domain, information routing and control.

Not only can bandwidth be increased, but data can be encoded to pass a maximum amount of information over the available bandwidth. Thus, an apparatus and method in accordance with the invention provide an enabling technology for deployment of photonic encoding, transmission, and decoding systems for telecommunications in general.

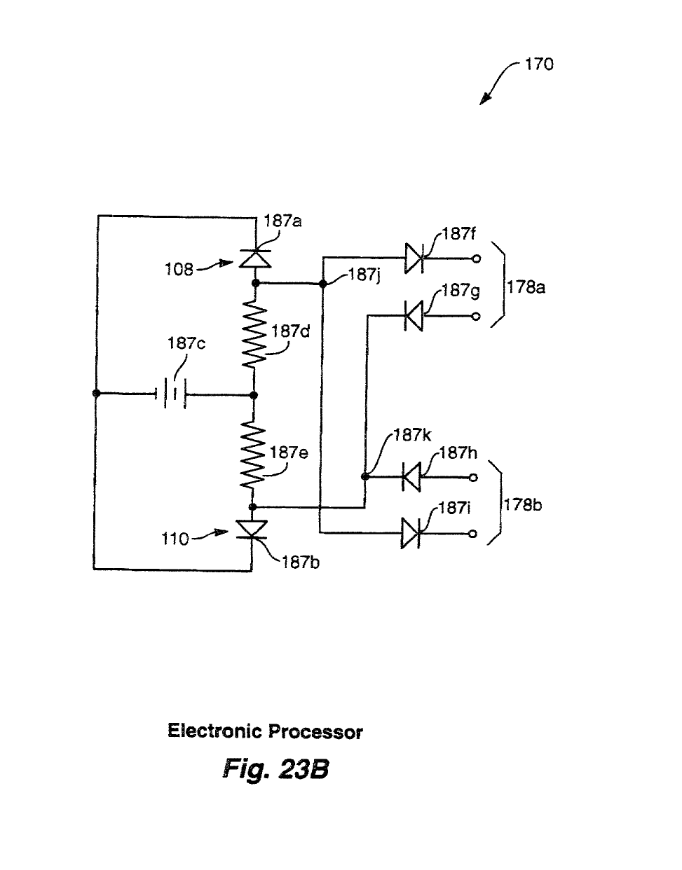

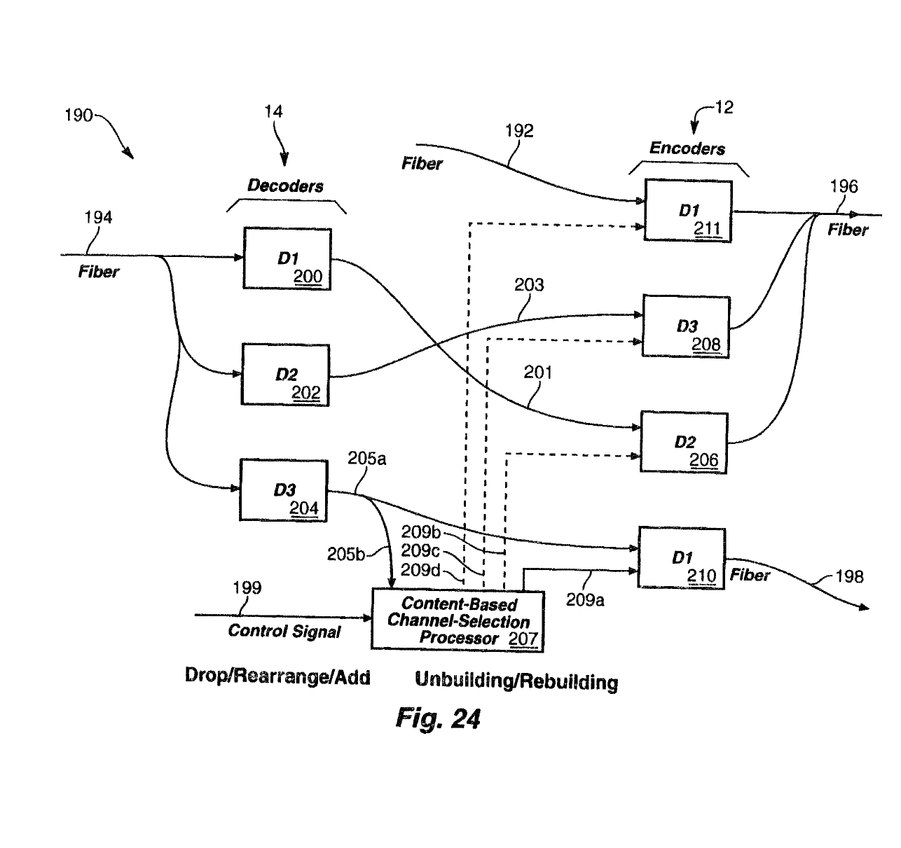

Referring to FIGS. 22, 23A, and 23B, processors 170 may receive and “post-process” the complementary outputs 108, 110. In the embodiment of FIG. 22, the signals 108, 110 are illustrated schematically, borrowing the nomenclature (schematic illustration elements) from conventional digital logic. Accordingly, for example, the complementary output 108 is passed to a first AND gate 176, and simultaneously to an inverter 174b.

Meanwhile, the photonic, complementary output 110 is provided to the AND gate 176b and the inverter 174b. All the elements of FIG. 22 are photonic, and thus physical systems for providing these digital functions may be referenced in previous work of applicant. Accordingly, the outputs 178a, 178b provide differential detection of the signals 108, 110.

For example, if the complementary output 108 provides a constructive interference signal, and the complementary output 110 provides destructive interference, then the output 178a provides an output, indicating differential detection between the signals 108, 110. Similarly, if the complementary output 110 receives a constructive interference signal, then the complementary output 108 receives a destructive interference output.

Accordingly, the output 178b of the AND gate 176b provides an output, indicating a differential between the signals 108, 110. Absent a full constructive interference or destructive interference in one of the complementary outputs 108, 110 and the opposite condition in the other complementary output 110, 108, no output arrives at either output line 178a, 178b. Meanwhile, an optional 2-input, OR gate connected to the outputs 178a, 178b provides a complete differential detection mechanism.

Nevertheless, the photonic signals may be taken directly from the outputs 178. As illustrated in FIG. 22, the channels 178a, 178b provides information regarding which phase relationship exits between the daughter signals 48a, 48b. Accordingly, phase detection is available through the apparatus 170. Thus, the processor 170 provides two-channel output when the input is appropriately modulated in phase.

Referring to FIG. 23, a processor 170 for electronic processing receives the complementary outputs 108, 110 into detectors 180a, 180b, which may typically be embodied as photodiodes 180a, 180b. Accordingly, the outputs 108, 110 are converted to electronic outputs 182a, 182b reflecting the content of the outputs 108, 110. In classical terminology, the signals 108, 110 have been detected electronically.

The signals 182a, 182b are provided to AND gates 186a 186b as illustrated. Accordingly, the AND gate 186a receives the signal 182a, and the signal 182b through an inverter 184a. Similarly, the AND gate 186b receives the signal 182b, and the signal 182a through an inverter 184b. Accordingly, the outputs 180a, 180b perform precisely the same functionality as the outputs 178a 178b, respectively in the illustration of FIG. 22. Nevertheless, the apparatus of FIG. 22 is a fully photonic apparatus, whereas the apparatus of FIG. 23 is electronic, after receiving the original photonic signals 108, 110.

Thus, the processor 170 of FIG. 22 receives photonic inputs 108, 110, conducts photonic processing, and provides photonic outputs 178a, 178b. By contrast, the processor 170 of FIG. 23 receives photonic inputs 108, 110, provides electronic processing through the electronic AND gates 186a, 186b and inverters 184a, 184b and provides electronic outputs 188a, 188b. Thus, the apparatus of FIG. 22 is a fully photonic processor 170. Meanwhile, the processor 170 of FIG. 23 receives photonic inputs, but is a fundamentally electronic processor otherwise.

Numerous applications exist for an apparatus 10 in accordance with the invention. Moreover, numerous specific benefits accrue as a result of implementing photonic encoding and decoding in accordance with the invention.

An apparatus and method in accordance with the invention provide cycle-for-cycle levels of granularity in modulation or distinction of signals. A maximum rate of data transfer in a carrier (photonic carrier) may be possible since resolutions down to an individual wavelength may be used to transfer a single bit of information. Similarly, because of this high rate of resolution, a greater number of multiplexed channels may be available. That is, if resolution down to a single wavelength is possible for data, then switching data between channels, or multiplexing bits among channels, may be completed on an individual cycle-by-cycle basis.

Hardware transparency is always a valuable feature, and more so as fiber optics require higher bandwidths. Removing electronic components, and removing electronic signal processing with its delays is a substantial advantage. In certain apparatus in accordance with the invention, analog, digital, multi-level semaphore signals, and the like may all be transmitted, along with images, or serial data. Data may be modulated by amplitude modulation, frequency modulation, phase modulation, pulsing, spatial distribution or modulation, and polarization modulation as well. Various protocols and bit rates may be used, since the apparatus is completely transparent thereto. Synchronous or asynchronous communication may be possible, including streaming data asynchronously, and simply interpreting it with a decoder 14. Correlation may be accommodated so long as coherency is appropriate for the time delay involved in the two streamed daughter signals 48. Narrow band and broadband communications may be promoted, including stretching and narrowing of pulses, according to the size of a pulse, and the relative overlap between two daughter pulses 48a, 48b.

Sources may include any spectrum from sunlight to microwave, including lasers, light emitting diodes, and other photonic signal sources. Moreover, pulses may be configured to be long, may be stretched to appear long, and thus interface with legacy equipment, or may be modified to become very short, by relying on only a short region of interference between two coherent daughter signals.

Whereas coherence length has been preferred to be as long as feasible, in prior art systems, an apparatus in accordance with the invention can actually benefit from a very short coherence length. As discussed, coherence time and coherence length are related by a constant, the speed of light, in any particular medium. Thus, an apparatus and method in accordance with the invention will permit the use of continuous analog signals.

Moreover, less expensive signal sources may be utilized, since coherence and timing prevent confusion and crosstalk. Virtually any variety of spectral fingerprints, and timing delays, which may be produced on some type of a regular or pseudo-random basis, may be used to provide unique fingerprints for communications. The limited ability of conventional signal time-frame techniques in digital communications to reduce ambiguities, and to verify sending and receiving, may be avoided by the apparatus of the invention.

Moreover, in the instant devices, in accordance with the invention, frame ambiguities within the time frame of any particular signal of interest or pulse may be reduced by the nature of the short coherence length, the signal delay times, and the signal profile. Due to various factors, including the ability to match pulse lengths, and the like, an apparatus in accordance with the invention can connect to legacy equipment such as the OC-48, and the OC-192 protocols. The short coherence length, and the ease with which signals can be distinguished from one another provides for higher numbers of multiplexed channels over the same number of lines. Again, due to the short coherence length and coherence time, coherent noise may be reduced substantially.

Modularization of information may be provided in such a way that individual messages may be provided in substantially any length, and may be routed to substantially any destination by broadcast routing. However, in terms of modularization of hardware, broadcast routing is available, without requiring dedicated trunk channels. Broadcast routing may be virtual at both a sending end and a receiving end, with a single trunk carrying the multiplexed information.

Thus, an apparatus in accordance with the invention produces virtual fibers. The fibers are not actually unique, but rather carry such a high bandwidth of communication, and such a minutely differentiable amount of information, that routing to a particular destination may be done at a higher bandwidth, and may be done absolutely by virtue of time delays, coherencies, and the like inherent in hardware design for particular channels. Thus, a high degree of isolation between channels, and, in some circumstances, an absolute novelty between channels may be available.

Additional modules may be added at a single station, in order to provide additional bandwidth, without necessarily affecting the remaining bandwidth of a connecting trunk. Thus, in sending or receiving mode, and not necessarily in both at once, modules in accordance with the invention may be configured in series and in parallel to create complex networks to direct and encode or decode messages, or to simply add additional bandwidth. Thus, as long as bandwidth is available in a trunk, various encoders and decoders may be cascaded or connected in series or parallel in order to optimize the use of available bandwidth.

Particularly, because of the high degree of isolation of channels, additional channels can be added and subtracted at will from different geographical locations. In accordance with the invention, apparatus embodying decoders and encoders as described herein may be configured to unbundle individual bits. Bits can be rebundled into packets and encoded with headers to be routed over photonic networks. In certain embodiments, an apparatus in accordance with the invention may be configured as a fully optical, time-division, multiplexing system. Alternatively, an apparatus in accordance with the invention may neatly interface with legacy multiplexing equipment. The device can be configured to perform as a drop or add device for adding and dropping channels.

Due to the adjustable delay feature, the apparatus may be tuned such that both transmitters and receivers are selectively interactive with other receivers and transmitters, respectively. Thus, devices may be configured to be tuned to channels temporarily as one would tune a radio.

By contrast, delays may be embodied in fixed hardware. Accordingly, snap-in or snap-out methods may be used to input delays, much as crystal-controlled channels may be set in radios. Accordingly, such hardware may be less subject to vibration and thermal variation. Meanwhile, channels may be pre-selected to be dedicated to certain locations or hardware.

Other applications for an apparatus 10 in accordance with the invention may include broadcast routing. Broadcast routing may eliminate the need for packet routing in many networks by providing virtual direct fibers. The fibers are not actually direct, but unused bandwidth may be used by adding and subtracting modules as needed. Accordingly, bandwidth may be provided as needed anywhere. Also such a system may consolidate information from diverse locations into a few locations.

For example, various sensor information from remote parts of an apparatus, operational plant, industry, building, aircraft, watercraft, automobile, or the like, may be multiplexed over a single lightweight fiber displayed in a single control location. In another example, an aircraft may be configured to have multiple signals multiplexed over a single lightweight fiber displayed through a compact cockpit display. Similarly, controls for a physical plant may be consolidated by a small number of fibers into a central control room. In other embodiments, information may be dispersed. Control information from a device or control center may be dispersed through various hardware that needs remote control.

In other embodiments, information may be consolidated from electrical meters to a central office. Alternatively, fiber cables, individual television channels or bundles of television channels may be sold in a single package that can be multiplexed over a single actual transmission channel. A subscribers decoder may have an appropriate delay installed in order to receive that subscribers chosen signals.

In certain embodiments, signal swapping (sequencing) may double the bandwidth available in an apparatus in accordance with the invention. Fewer decoder components, with multiple channels on a single photonic transistor may be available.

Images may actually be multiplexed. For example, the beam profile integrity, including the actual intensities or amplitudes of signals distributed throughout the spatial distribution of a beam, may be maintained for free-space interconnections, and wireless applications using longer wave energy. Multiple parallel simultaneous signals may be provided for each individual delay time. Thus, full image routing may be available, interfaces with coherent image transmission may be available through coherent fiber bundles, and so forth. In certain embodiments, a single composite fiber may actually transmit an image, collimated and then focused on an aperture for a single fiber.

Phase sensitive or phase insensitive components may be utilized. Moreover, multiple daughter pulses or daughter signals may increase signal-to noise ratios. Additional address coding for interaction with complex networks may be available by suitable modulation outside of the actual content that would normally be associated with a header or address portion of a transmitted signal. That is, high-frequency modulation or other modulation may be used for signal addressing, independent of the content. Encoding methods may include phase encoding, polarization encoding, sequence encoding, as well as the time and frequency encoding mentioned.

The degradation of signals that is a bane to current fiber optic technology may actually present little or no problem in an apparatus in accordance with the invention. The degradation of daughter signals from a common parent should be substantially identical, thus allowing for recovery of data at longer distances, or through dispersion, or other distortion, that would be otherwise unusable in other environments. One of the major efforts of fiber optic technology is correcting for dispersion. An apparatus in accordance with the invention, dispersion can be used to spread signals, or signals may be recovered and reconstituted from daughter signals at longer distances than are currently accessible, even with the same light sources and fiber technology.

In certain embodiments, additional security may be available by sending daughter signals through separate routes. Phase matching may be accomplished by the tuning processes discussed above. Moreover, a fingerprint between two daughter signals is an encryption concept similar to a one-time key or shared secret. Thus, hopping through various time delays may effectively encrypt information, thus making it a highly-time-sensitive cryptographic feature. Just as spread-spectrum techniques are used in a frequency domain, an apparatus and method in accordance with the invention may be implemented as a spread-spectrum system in time. That is, the signal is spread in a time domain, rather than being distributed over a frequency domain.

As signal processing needs are always driven by a need for real-time speeds, a decoder with an optical output can be used as a filter to remove specific delay information among multiplexed signals. Moreover, wireless transmissions may be effected on a single frequency, for telephones, data transceivers, or the like.

Multiple communications units may actually operate on the same frequency. Unlike conventional radios, and cellular phones, due to the high bandwidth of such a photonic system, the time delays and high bandwidth of an apparatus and method in accordance with the invention can support multiple communications and be multiplexed at extremely high speeds, which will not affect the apparent content of the transmissions, due to the high photonic bandwidth of such a system. Since no electronic switching is required, the speeds of “administration” of the signals are substantially eliminated. For this and other reasons, legacy equipment such as the legacy optical equipment, legacy electronic equipment, signals such as SONET, ATM, and the like, may all be interfaced with an apparatus in accordance with the invention. Moreover, as photonics become ubiquitous, totally-photonic networks may be created.

New devices may be enabled by the apparatus 10. For example, some light encoders may be used in solar-powered, remote telephone systems, relying on fiber, and even using sunlight as a photonic source. Thus, non-powered systems may be laid, which are only powered during actual operation. In other developments, using different delay channels, rather than a phone number, may encode messages directly. Encoding occurs at a hand set, making a central office switching concept obsolete. In certain devices, a source may be located at some location other than at an encoder, or even at a decoder, by sending light through a fiber, through the encoder, and then reflecting the light back into the encoder in the forward direction of a modulating mechanism. Such a mechanism could be used for light-weight inexpensive communication with undersea divers, distance habitats, or into places requiring remote sensing, yet in which electronic equipment is difficult or dangerous to place.

In some very pedestrian applications such as sensing the fuel level in an aircraft fuel tank or in multiple tanks, simple fibers may receive light signals from an encoder, reflecting the same back to a decoder, depending on whether or not the index of refraction of the surrounding medium is comparatively high or low (detecting the density of a surrounding medium), thus detecting liquid or air. Rather than using bundles of cable or fibers, a single fiber may conduct sufficient information.

In other embodiments, a photonic burst generator may use a beat frequency between two sources, mismatched in order to provide the differential frequency that is so common in acoustics. Such a device may enhance performance of differential delay (delay-domain) multiplexing systems. Moreover, since the sources of photonic signals may be inexpensive lasers, cost may be substantially reduced.

Rather than matching lasers closely, lasers that are badly mismatched may actually become the norm, providing higher bandwidth in the beat frequency. Such a device actually reduces the energy level in a transmission medium by removing the constant presence of a carrier signal, and replacing it with a very short burst that occurs in a pseudo-random manner, thus providing much shorter bursts of energy in the signals in the apparatus 10. Moreover, such a mechanism may allow for more channels by providing, again, much shorter pulses. Since the apparatus 10 in accordance with the invention can deal with pulse lengths of an order of magnitude of a single wavelength, no other practical limits seem to constrain the shortness of a particular bit signal.

In certain embodiments, a non-return-to-zero type of pulsing system may enhance performance of differential delay multiplexing systems. For example, in such a system, inexpensive lasers or direct optical inputs may be relied upon. Again, since a non-return-to-zero mechanism may be used, the overall energy level for transmission may be minimized. Moreover, the transmission bandwidth requirement is minimized. Again, such an apparatus allows for more channels, reduces the problems with chromatic dispersion, and actually benefits therefrom. For example, such an apparatus may use chromatic dispersion to assist in interfacing with the slower electronic components, thus having a naturally built-in method for pulse stretching. Moreover, such an apparatus may connect directly to legacy equipment such as the devices operating under the protocols of OC-192 and OC-48, or higher.

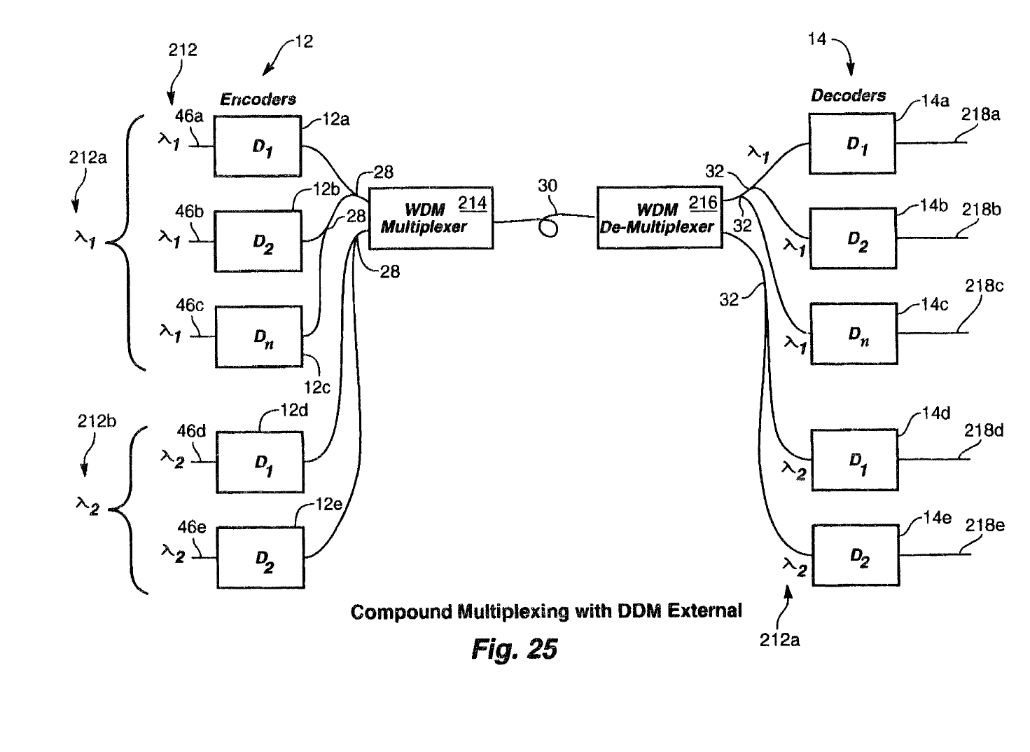

Referring to FIG. 24, a drop-rearrange-add apparatus is illustrated for the bundling, unbundling, and rebundling of information, as packets, channels, or the like. The apparatus 190 of FIG. 24 may serve to dynamically configure a router, or to provision a network with channels. By providing adjustability of time delays, by any of the mechanisms discussed herebefore, various lines 192, 194, 196, 198 may be interconnected to receive selected sets of signals.

That is, channels may be created by virtue of the uniqueness of a time delay associated with a pair of “double-pulsed” signals. By providing an additional variable to work with, a time delay, creating a time-delay domain in which to operate an apparatus 190, new operational characteristics may be defined by that new variable. Thus, a time-delay or a delay-domain multiplexing scheme may rely on the uniqueness of time-delays in order to define channels. Since a time-delay is not exclusive of a frequency (wavelength) or an ordinary time-division multiplexing scheme, then a delay-domain multiplexer can operate in tandem with other wave-division multiplexers and time-division multiplexers of the prior art. Moreover, a delay-domain multiplexer may operate with analog equipment as well.

In one embodiment, various decoders 14 may be provided with unique delays 200,202,204. Associated with each decoder 200, 202, 204 is a resulting signal 201, 203, 205, respectively. Thus original information provided in the line 194 is decoded by the decoders 14 to create individual delays 200, 202, 204 which may also be thought of as individual channels 200, 202, 204, respectively. Accordingly, separated signals 201, 203, 205, respectively, pass from the decoders 14 for re-encoding by the encoders 12. Thus, content can be routed from one channel 200, 202, 204, to another channel 206, 208, 210.

Meanwhile, the delays 206, 208, 210 (channels) may each be directed or redirected then to another line 196, 198 as desired. Of course, switches may be added to the lines 196, 198 in order to reroute signals thereon. Although an encoded signal must be decoded by a decoder having the same effective time delay 49, at re-encoding a new delay 49 may be used in order to create a signal and a new channel.

Referring to FIG. 24, the delay 204 in the apparatus 190 must correspond to a previously encounter delay 49 by which the signal was encoded. However, the signal 205 may be encoded by any arbitrary time delay 210 before being launched into the carrier medium 198 or fiber 198, for example. Thus, the D3 channel 204 has been routed away from the other channels 200, 202. Effectively, in the apparatus 190, the channel 204 is dropped, by being re-encoded as a channel 210. The channel 210 is rerouted into a new carrier medium or fiber 198.

Meanwhile, the channel 200 is re-encoded as the new channel 206. The delay 200 is not the same as the delay 206, and thus, the delay 200 is available again for output onto the line 196 by a different encoder 12, using the delay 211 identical to the delay 200. The new line 198 can encode with the delay 210, identical to the delay 200, and the delay 211 since the lines 196 and 198 are distinct.

Thus, the information is unbundled, some is dropped, some is rearranged, and some is added, and all is rebundled for output. That is, for example, the channel 204, is dropped, the channels 200, 202 are rearranged, and the channel 211 is added to the net flow of information passing from the line 194 through to the line 196.

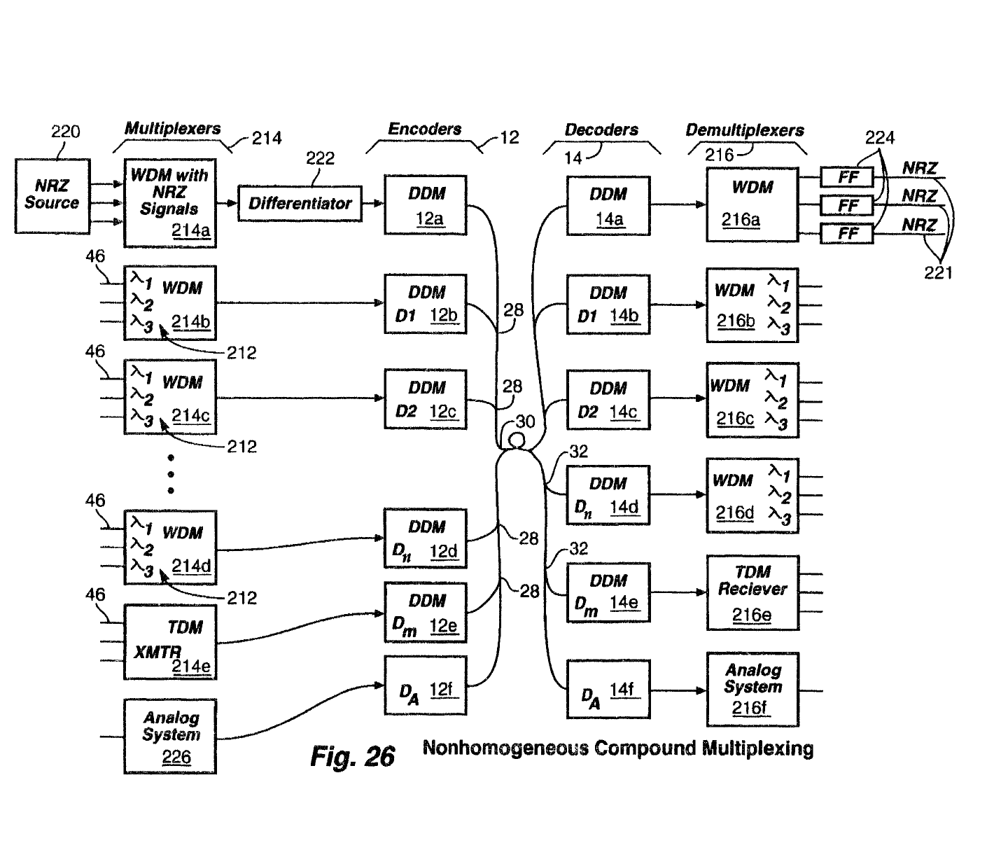

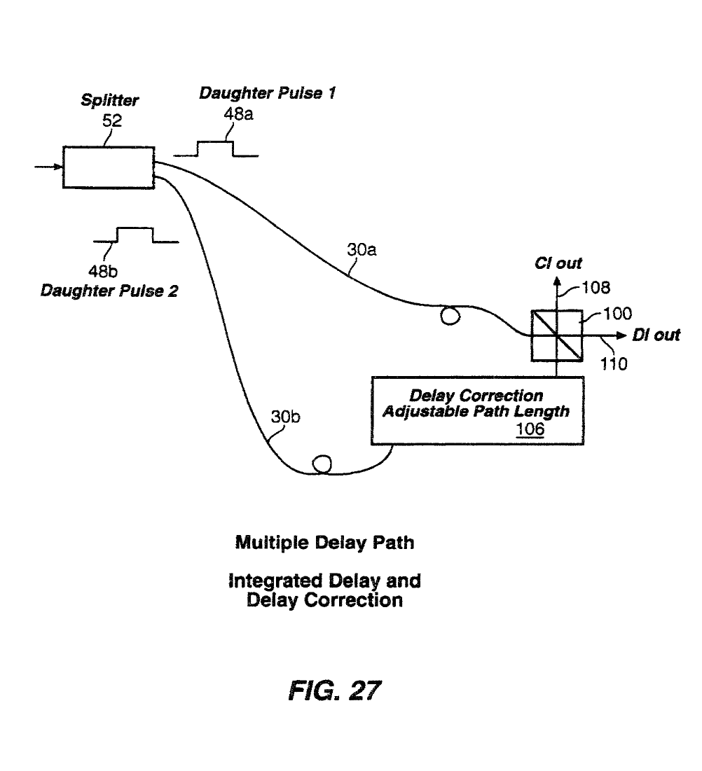

Referring to FIGS. 25-26, compounded multiplexing systems include delay-domain multiplexers compounded (in series, parallel, or both) with multiplexers from other domains such as frequency, time-division, and so forth. A variety of encoders 12, may each be provided with an appropriate wavelength 212. In one embodiment, a series of encoders 12a, 12b, 12c may have a shared wavelength 212a. Another series of encoders 12d, 12e may receive signals having a wavelength 212b. Although sharing a particular wavelength 212a, the individual lines 46a, 46b, 46c carry their own distinct information. Similarly, the lines 46d, 46e carry their own individual information, but each uses the same wavelength 212b.

The encoders 12a, 12b, 12c may be thought of as channel 12a, 12b, 12c each having its own individual delay 49. Accordingly, each of the encoders 12a, 12b, 12c is connected through the various junctions 28 to provide an input having a single wavelength 212a fed to the wave-division multiplexer 214. Similarly, each of the encoders 12d, 12e may be thought of as a single channel 12d, 12e. Accordingly, each of those channels 12d, 12e is combined through a junction 28 in order to provide a signal having a single wavelength 212b fed to the wave-division multiplexer 214.

Thus, two inputs, each operating at a distinct wavelength 212a, 212b, respectively may be received by a wave-division multiplexer 214. The wave-division multiplexer 214 then provides an output that effectively is a compound signal, having different information as the various wavelengths 212a, 212b, and so forth, all carried by the main trunk 30 or carrier medium 30. All the information carried in the line 30 is encoded in both a frequency domain by the wave-division multiplexer, and in the delay domain of the present invention.

At a destination, a wave-division demultiplexer 216 divides the incoming signals according to their wavelengths 212a, 212b. Accordingly, each of the decoders 14a, 14b, 14c receives a signal through a junction 32 at a wavelength 212a. Likewise, each of the decoders 14d, 14e receives a signal through a junction 32 at a wavelength 212b.

Information is recovered from the delay domain by the decoders 14a, 14b, 14c to provide outputs 218a, 218b, 218c, respectively. Similarly, the information is recovered from the delay domain by the decoders 14d, 14e to provide the outputs 218d, 218e, respectively. Thus, in one embodiment of an apparatus and method in accordance with the invention, information is combined in the delay domain by the encoder 12, and then further combined in the frequency domain by the wave-division multiplexer 214, then re-divided in the frequency domain by the demultiplexer 216 and re-divided in the delay domain by the decoders 14.

Referring to FIG. 26, while continuing to refer generally to FIG. 25, and FIGS. 1-24, the central carrier 30 of FIG. 26 may be thought of as a photonic network carrier medium 30. By contrast, the carrier medium 30 of FIG. 25 may be a legacy carrier medium 30. Accordingly, in the apparatus of FIG. 25, the encoders 12 and decoders 14 are compounding on legacy equipment operating in the frequency domain, whereas in the apparatus of FIG. 26, the legacy equipment operating in the frequency domain is compounded on a delay-domain, photonic network.

Because the encoders 12a-12f and decoders 14a-14f, in accordance with the invention, are independent of protocol, format, and other legacy encoding processes, the apparatus of FIG. 26 can compound, over a single network (e.g. trunk carrier medium 30), signals 46 from a variety of legacy equipment. Legacy equipment may include wave-division multiplexers 214a, 214b, 214c, 214d, time-division multiplexers 214e, as well as other apparatus.

For example, a non-return-to-zero (NRZ) such as an OC-48, or other SONET network equipment, and the like, may be accommodated. The NRZ sources 220 may be multiplexed by the multiplexer 214 to result in NRZ outputs 221 after decoding. A differentiator 222, in accordance with the invention, may be connected to a delay-domain multiplexer 12a operates in combination with the flip flops 224 to recover the NRZ outputs.

Meanwhile, an analog system 226 may connect to one of the delay-domain encoders 12f. Signals from the analog system 226, as a unique channel, may be recovered by a destination analog system 228 after a decoder 14f, in accordance with the invention.

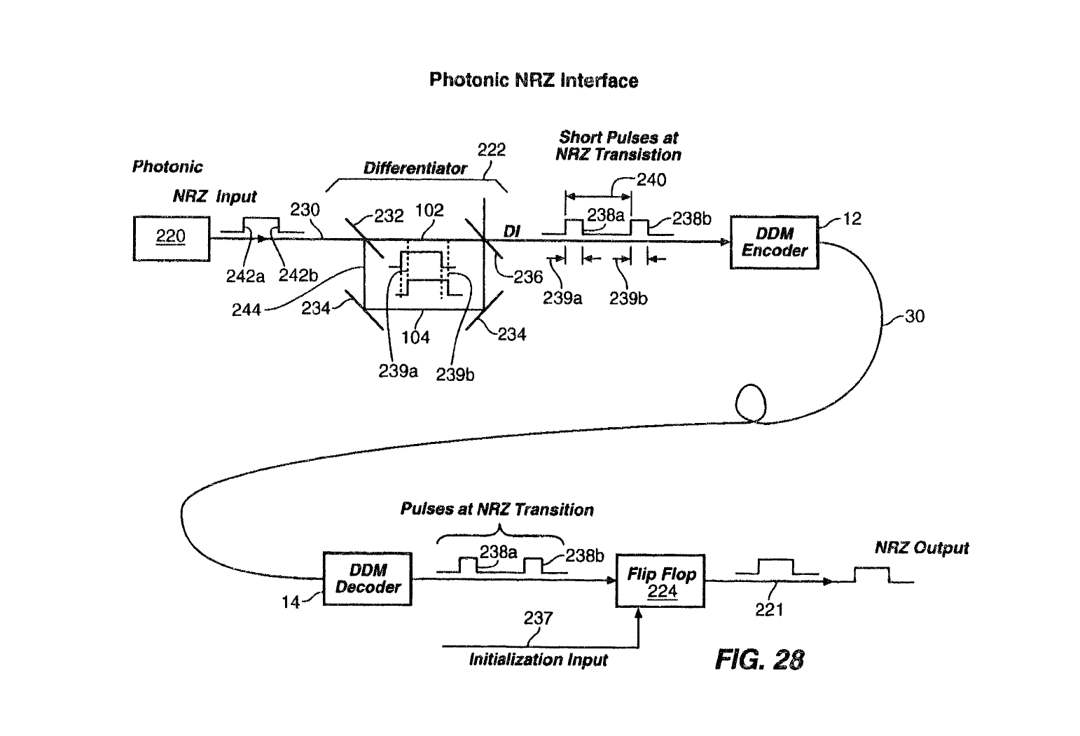

Referring to FIG. 27, one embodiment of an apparatus and method in accordance with the invention may combine features of the encoder module 50 of FIG. 4 and a decoder 14, in accordance with FIG. 12. In the embodiment of FIG. 27, a splitter 52 provides daughter pulses 48a, 48b. The daughter pulses 48a, 48b travel down different carrier media 30a, 30b. The carriers 30a, 30b may actually be identical or different media, but are distinct hardware. In one presently preferred embodiment, both are identical. For example, one carrier 30 may be free space and another carrier may be glass fiber, but both, in one presently preferred embodiment, are photonic carrier media.

The signal 48a or daughter pulse 48a arrives at a coincidence detection interferometer 100. Meanwhile, the daughter pulse 48b arrives first at an adjustable time delay 106. The adjustable time delay 106 provides a correction of the delay between the daughter pulses 48a, 48b, in order to properly produce coincidence at the points of its coincidence detection interferometer 100. Accordingly, complementary outputs 108, 110 may result from constructive interference and destructive interference in accordance with the invention.

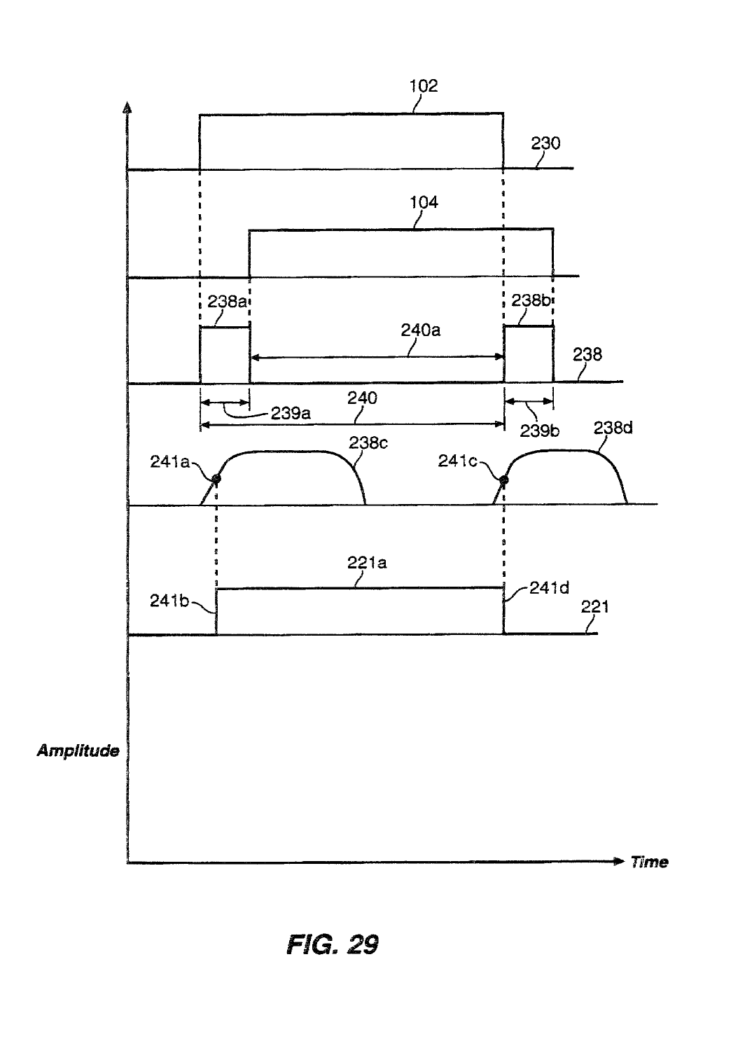

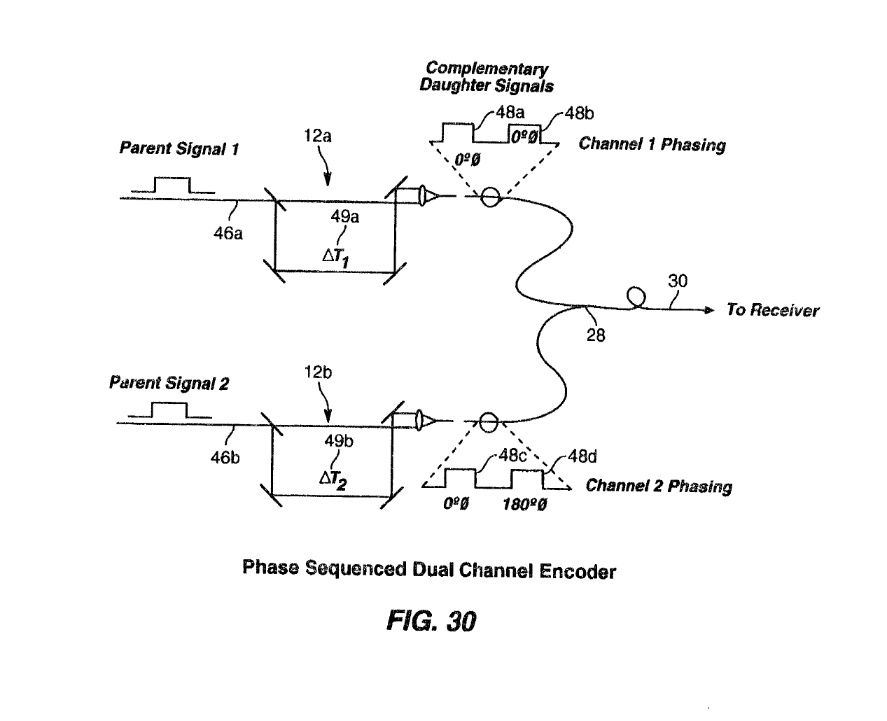

Referring to FIGS. 28-29, a photonic NRZ input source 220 may provide a signal 230 as in input to a photonic differentiator 222. In the differentiator 222, the NRZ input signal 230 strikes a splitter 232 which divides the pulse into daughter pulses traveling over a direct path 102 and a delay path 104. The delay path adds time to a daughter signal by a suitable mechanism, as discussed above, such as mirrors 234. Eventually, the signal from the direct path 102 and the delay path 104 arrive at a photonic transistor 236. Photonic transistor provides, or may provide, both a constructive interference output and a destructive interference output.

In the apparatus of FIG. 28, the output that provides destructive interference is selected as the output signal 238a. Since destructive interference is selected, then the absence of a signal provides a zero. Meanwhile, the presence of destructive interference provides a zero condition. However, in those transition regions 239a, 239b in which destructive interference is absence, the time delay between the daughter pulses provides an offset resulting in a single short pulse 238a, 238b for each transition that occurs in the original NRZ input 230.

A major advantage of differentiation in accordance with the invention is that the net energy transferred or launched through the carrier 30, is greatly reduced. Reducing the overall energy level per channel, and thus the overall energy within a carrier medium 30, allows carrying more channels of information.

In certain embodiments, the differentiator 222 may be adjustable. Also, in certain embodiments, the differentiator 222 may be configured to provide extremely precise time delays 49, in order to precisely control the width of the pulses 238a, 238b. Pulses may be controlled for purposes of information interfaces, requiring pulse-width control, or for purposes of reducing overall energy by reducing the width of a pulse, while leaving all information intact.

Moreover, this manipulation of pulse width effectively controls the energy duty cycle of the apparatus. This is of special advantage in a system that can switch at a resolution of a single wavelength, in accordance with the invention (see e.g. FIGS. 7, 16, 17). It is important to note that the short pulses 238a, 238b are not daughter signals 48 from an encoder 12. Although daughter pulses may be generated in the differentiator 222, they have been recombined by the photonic transistor 236, and exist with an appropriate delay therebetween dictated by the transitions 239a, 239b corresponding to the NRZ input 230.

The time delay 240 between the short pulses 238a, 238b, does not correspond to the time delay 49 created in the differentiator 222, in association with the daughter signals. Rather, the offset 240 or time delay 240 corresponds to the beginning time 242a, and ending time 242b, of the NRZ input signal 230. Thus, the delay 240 between the short pulses 238a, 238b is dictated not be the differentiator, but by the input data of the signal 230, not by the hardware of the differentiator 222. Thus, the delay 240 is a data phenomenon, not a hardware phenomenon.

The encoder 12 operates as discussed herein, to encode each short pulse 238a, 238b, independently as separate, distinct parent signals 46 (pulses 46), effectively unrelated to one another for purposes of encoding. Accordingly, the decoder 14 provides fully reconstituted short pulses 238a, 238b as inputs to a flip flop 224. In a fully photonic system, the flip flop 224 is a photonic flip flop. In an electro optical apparatus, the flip flop 224 is an electronic flip flop. The output 221 of the flip flop 224 is a reconstituted NRZ signal 230. Of course, the flip flop 224 may be initialized in accordance with standard practice, as known in the art.

When an invention in accordance with FIG. 28 is used in a compound domain environment, (e.g. FIG. 26) a legacy multiplexer 214 may be inserted between multiple NRZ sources 220, and a differentiator 222. Correspondingly, a legacy demultiplexer 216 may be inserted between a decoder 14, and multiple flip-flops 224.

It is an important feature in at least one embodiment of an apparatus and method in accordance with the present invention that the duty cycle of each datum be reduced leaving an off time 240a. This not only reduces the amount of energy needed to transmit the data, but makes available an empty time interval immediately following each transmitted pulse. An apparatus may take advantage of this “dead” space in at least two ways.

For example, when a pulse 238a travels through a dispersive medium, various types of dispersion, including may occur. Dispersion types may include chromatic, polarization, and the like, effectively stretch the corresponding received pulse 238c into a time period 240a. Ordinarily, dispersion would cause cross talk with adjacent (in time) bits. The present invention may synchronize a dispersed pulse with an intentional subsequent blank time interval to remedy cross talk between adjacent bit time intervals.

Also, such newly useful dispersed pulses 238a can be directed into a flip flop 224. Meeting a threshold value at a time 241 changes the state of the flip flop 224, reproducing the original NRZ signal. Moreover, the internal capacitance of photo diodes need no longer be bothersome in electrooptical embodiments. Capacitance may actually be desirable, providing integration of a pulse 238. Such integration may aid photodetection. As a result, an apparatus in accordance with the invention can rely on comparatively inexpensive photodiodes having slower speeds than those typically specified to detect short pulses 238. Meanwhile, problems associated with dispersion are ameliorated.

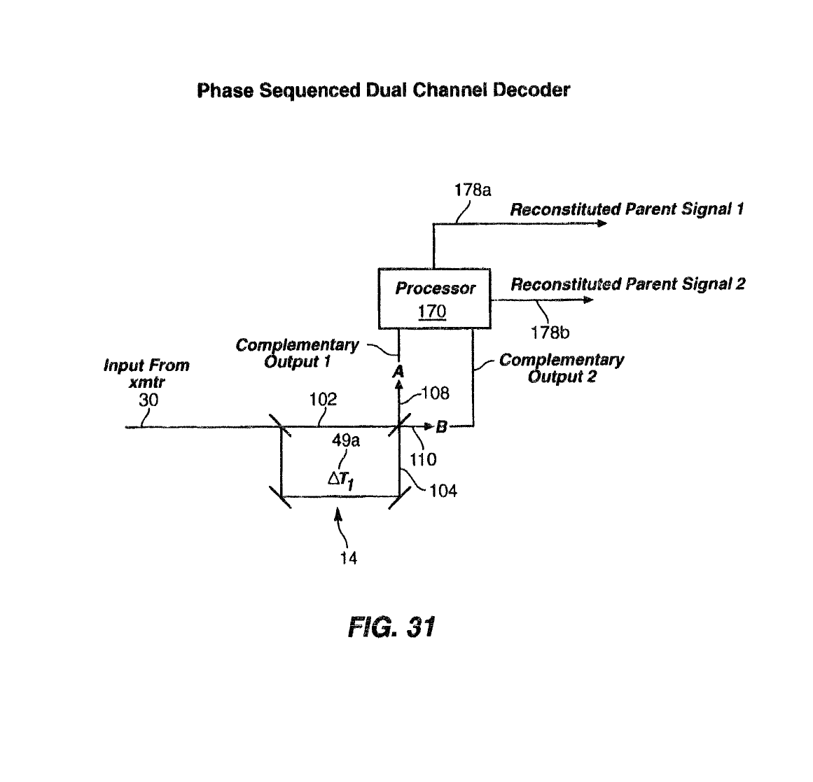

Referring to FIGS. 30-36, while continuing to refer generally to FIGS. 1-29, a parent signal 46a may enter an encoder 12a providing a pair of daughter signals 48a, 48b. Meanwhile, another parent signal 46b enters an encoder 12b to produce daughter signals 48c, 48d. The time delays 49a, 49b are substantially equal but different by sufficient time to produce a phase difference of 180 degrees. Thus, the daughter signals 48a, 48b are in phase with respect to one another, while the daughter pulses 48c, 48d are out of phase with one another. The sets of daughter signals 48a, 48b and 48c, 48d can be combined at a junction 28 or other combining mechanism, and launched into a carrier medium 30 toward a destination. Thus, two, distinct, phase-sequenced channels have been created, using the same effective time-delay 49, to carry two distinct and disparate signals 46a, 46b.

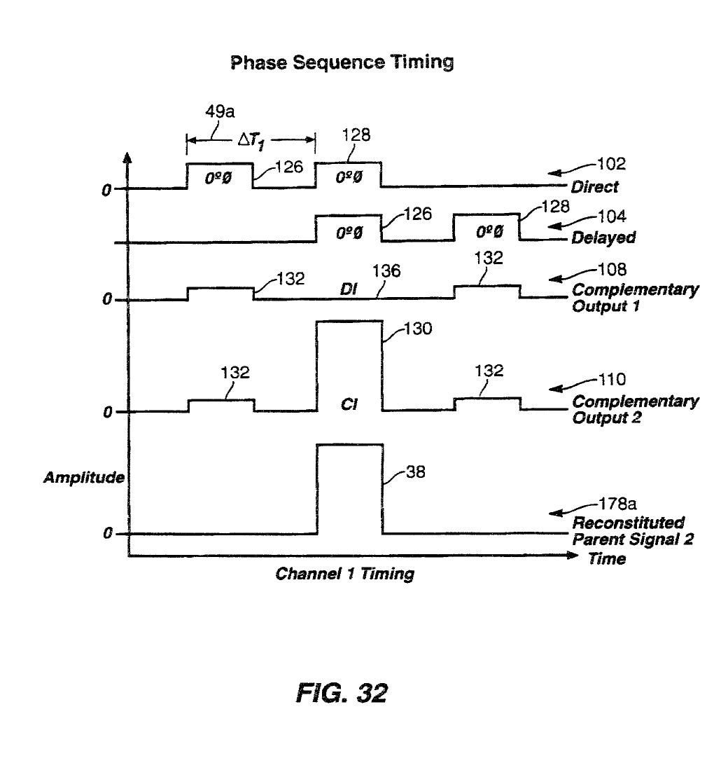

Referring to FIG. 31, a high level, schematic, block diagram of a decoder relies on phase sequencing to manage dual channels. A carrier medium 30 may provide an input to a decoder 14. As discussed hereinabove, complementary outputs 108, 110 result from the decoder 14. The outputs 108, 110 are then processed in a processor 170 (see e.g. FIGS. 22-23) in order to provide reconstituted signals 178a, 178b corresponding to the parent signals 46a, 46b.

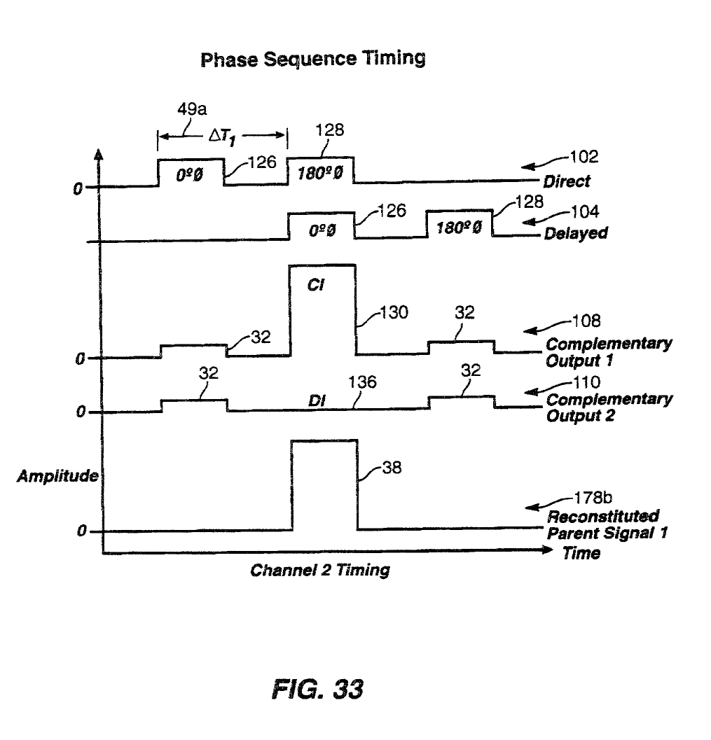

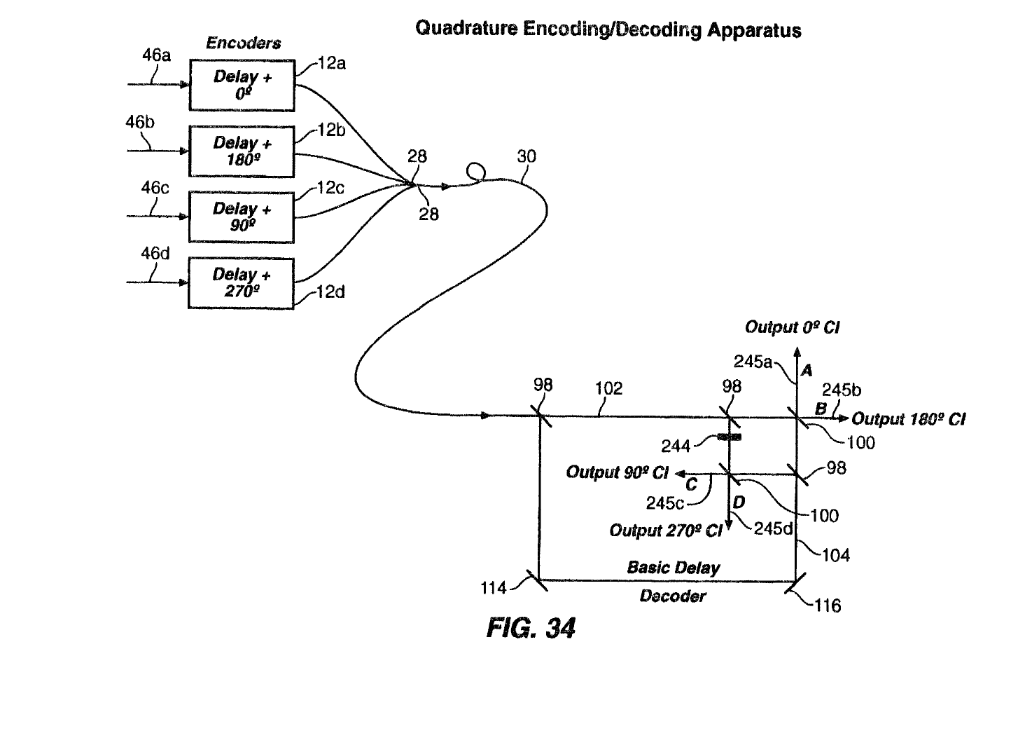

Referring to FIGS. 32-33, timing diagrams illustrate the decoding in channel separation processes of the apparatus of FIG. 31. The decoder 14 has only a single time-delay 49a, since the time-delay 49b is merely the delay 49a shifted in phase by 180 degrees. Referring to FIGS. 32-33, a time-delay 49a exists between corresponding locations in granddaughter signals 126, 128 from the decoder 14 in the outputs 108, 110, respectively.

FIG. 32 illustrates the pair of granddaughter signals 126, 128 in phase, while FIG. 33 illustrates the pair of granddaughter signals 126, 128 that are out of phase. The direct signal 102 reflects only the delay-time 49a between the signals 126, 128 (e.g. pulses 126, 128). Meanwhile, the delayed signal 104 reflects the additional delay of 49a applied by the decoder 14.

Thus, the leading pulse 126 from the direct path 102 or direct signal 102, in each case provides no interference, and thus no contribution to the reconstituted signal 178. Similarly, in each case, the trailing signal 128 from the delayed path 104 or delayed signal 104 produces no interference and thus no contribution to the reconstituted output 178.

By contrast, interference between the trailing signal 128 of the direct path 102, and the leading signal 126 of the delayed path 104 produce destructive interference as the complementary output 108 in a first channel. Similarly, the same two pulses 128, 126 provide constructive interference 30 in the complementary output 110. Accordingly, the reconstituted signal 178a of FIG. 32 provides an output pulse 38.

Since the granddaughter pulse 128 of the direct path 102 of the second channel illustrated in FIG. 33 is 180 degrees out of phase with the leading granddaughter pulse 126 of the delayed path 104, the complementary output 108 sees the constructive interference 130. Thus, the complementary output 110 sees destructive interference 136. Accordingly, a reconstituted signal 178b provides a pulse 38.

The differential between the complementary output 110 and the complementary 108 exists in each case (channel), but is reversed in sense to differentiate the two channels. In the illustrated embodiment, the different channels receive the parent signals 46a, 46b at different times. The value in channeling is to distinguish one result across one path from another result across another path.

Clearly, in the embodiment of FIGS. 32-33, simultaneous occurrence of both the reconstituted pulses 178a, 178b would not occur, or rather the pulses 38 would not occur in the reconstituted outputs 178a, 178b. The presence of a constructive interference output and destructive interference output on each of the complementary outputs 108, 110, simultaneously would eliminate any differential therebetween, nullifying the effect.

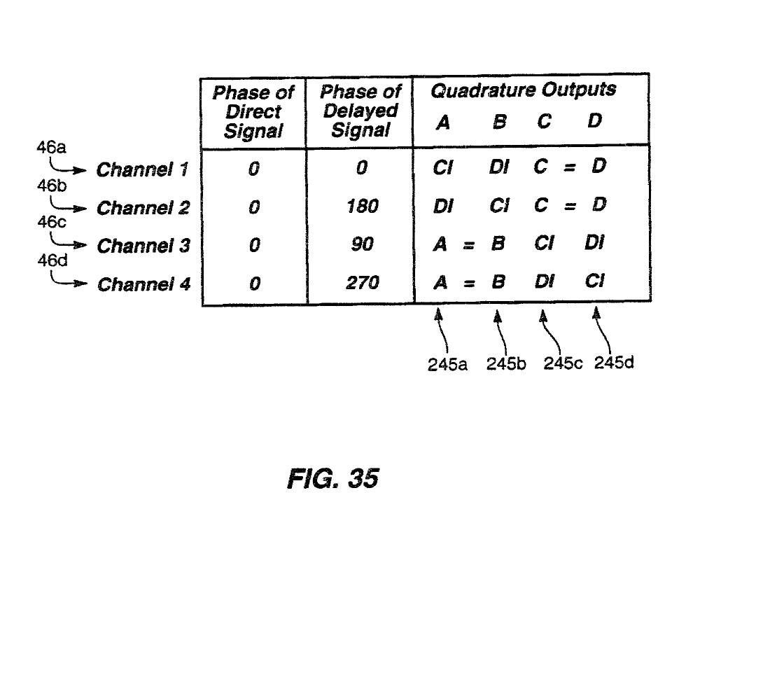

Referring to FIG. 34, the encoders 12 reflect two instantiations of the entire apparatus illustrated in FIG. 30, each instantiation being 90 degrees out of phase with the other. Meanwhile, as a decoding mechanism, the apparatus of FIG. 34 contains two complete instantiations of the entire apparatus of FIG. 31, each shifted 90 degrees out of phase with respect to the another. The result is four channels of throughput.

The inputs 46a, 46b into the corresponding encoders 12a, 12b may be thought of as equivalent to those illustrated in FIG. 30. Accordingly, two channels of output are provided, as discussed. However, by providing an encoder 12c shifted 90 degrees from the encoder 12a, and an encoder 12d shifted 90 degrees from the encoder 12b, two additional channels of output are available. By “shifted” is meant not that the first daughter pulse 126 is shifted, but that the phase shift of the second daughter pulse 128 with respect to the first daughter pulse 126 takes on one of four corresponding values, zero, 180 degrees, 90 degrees, or 270 degrees. Accordingly, two pairs of encoders 12 are each producing a trailing daughter pulse 128 that is 180 degrees out of phase with a leading pulse 126.

In the apparatus of FIG. 34, two coincidence detection interferometers 100 operate 90 degrees out of phase with respect to one another, due to a phase shifter 244. Accordingly, four outputs 245a, 245b, 245c, 245d result. These may be referred to as quadrature outputs 245.

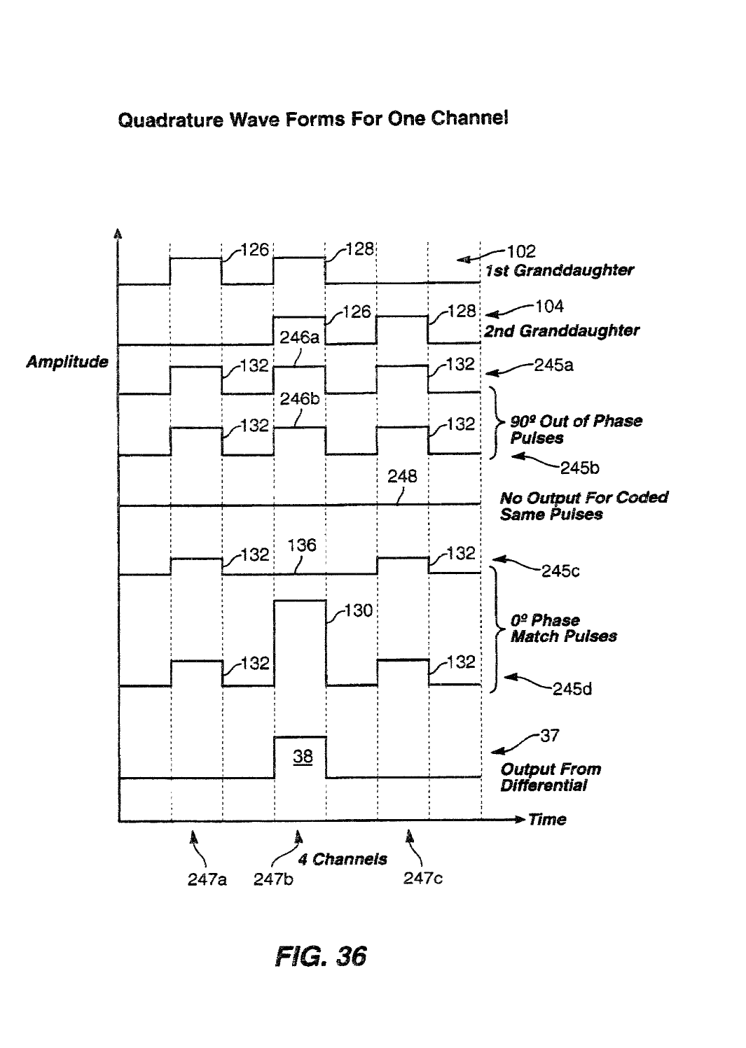

Referring to FIG. 35, a truth table juxtaposes several channels 46a, 46b, 46c,46d of inputs as they will be encoded and decoded into different quadrature outputs 245a, 245b, 245c, 245d. Thus, the quadrature outputs 245 reflect the state of each of the outputs 245, depending upon which channel 46 is active (contains a data signal).

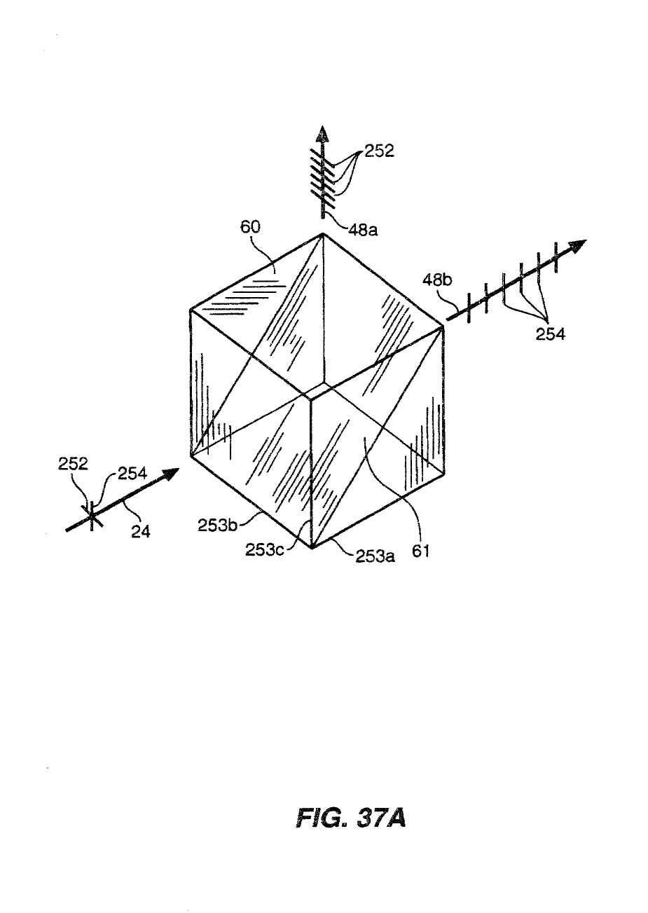

Referring to FIG. 36, a timing diagram illustrates the value of each output 245 for a single input, channel four (the input 46d) in this example. Timing diagrams like those of FIG. 36 may be illustrated to reflect each of the channels 46 in the truth table of FIG. 35.

Continuing to refer to FIG. 36 while referring generally to FIGS. 1-35, a time interval 247a corresponds to a granddaughter pulse 126 in a direct path 102, producing no interference, and no differentials between any of the channels 245, and thus no output 37. Similarly, during the time interval 247c, a trailing granddaughter pulse 128 over the delay path 104 produces no interference, and thus no differential between the outputs of the various channels 245. Therefore, a null value of the output signal 34 results during the time interval 247c.

By contrast, during the time interval 247b, the trailing granddaughter pulse 128 of the direct path 102 is coincident with the leading granddaughter pulse 126 over the delay path 104, resulting in constructive interference 130 in the output 245d and destructive interference 136 in the output 245c. This produces a differential between the values of the constructive interference 130 and the destructive interference 136, resulting in an output pulse 38 in the output signal 37.

The trailing granddaughter pulse 128 of the direct path 102 and the leading granddaughter pulse 126 of the delay path 104 result in coincidence 246a, 246b in the outputs 245a, 245b, respectively. However, due to the 90-degree shift in phase, the relative amplitudes are equal in each case, thus producing no differential. Accordingly, the output 248 resulting at the corresponding output 178 (see FIG. 31) will be null.

That is, depending on which of the channels 46 was providing an input, the corresponding reconstituted parent signal 178 will have a value of the reconstituted pulse 38 in the output 37 that corresponds to the correct reconstituted parent signal 178. The zero value of the output 248 will correspond to the paired reconstituted parent signal 178 from the same processor 170. Thus, for example, if a first channel 46a has an input, then a paired second channel 46b will not. Similarly, if, as illustrated in FIG. 36, a fourth channel 46d has an input, then the output 37 has a pulse 38, while all other channels 46a, 46b, 46c reflect the null value of the output 248.

In another way of thinking, if a fourth channel 46d is receiving data, then a matched third channel 46c has a null output 248 as a result of the process illustrated and explained with respect to FIGS. 32-33. Meanwhile, at the same time, the first and second channels 46a, 46b, respectively have a null value for the output 248, due to the 90 degree phase shift that produces no differential. Thus, in any pair of channels 46, when one of the pair is receiving data, its matched companion has destructive interference, resulting in no output from the companion.

Only one channel 46 of any channel pair (companions) 46a, 46b or 46c, 46d in the example, may be used at one time. Any number of sets (46a, 46b is a set, 46c, 46d is a set) may be used simultaneously.

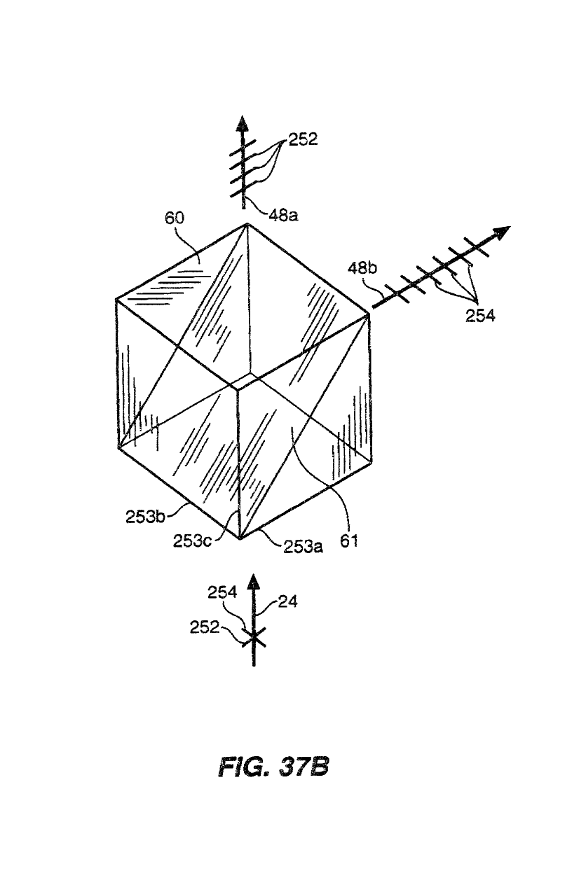

Referring to FIG. 37, a polarization splitter 60 relies on the surface 61 to act as a polarization separation surface 61. Accordingly, an input signal 24 is split between two output signals 48a, 48b. However, the input signal 24 has a horizontal component 252, and a vertical component 254. The horizontal component 252 and vertical component 254 are relative to one another, and not relative to absolute space. Nevertheless, in entering the splitter 60, the horizontal component 252, and vertical component 254 are or do become defined relative to the separation surface 61.

For example, one may think of the axes 253a, 253b, 253c, as defining the geometry of the splitter 60. Thus, the axes 253 form the frame of reference for the geometry of the splitter 60, and its associated splitting surface 61. Therefore, regardless of the orientation of the polarization of the input signal 24, so long as it has at least two orthogonal constituents (components), the plane 61 defines the horizontal component 252 and vertical component 254 in term of itself. The plane 61 controls the separation of the outputs 484a, 484b having a polarization defined by the reference frame of the axis 253. Thus, speaking of the polarization of the signal 24 is a matter of convenience. Meanwhile, speaking of the polarization of the outputs 48a, 48b and their polarization components 252, 254 is real and relative to the reference frame of the axes 253. As a result, the orientations of the horizontal polarization component 252 and the vertical polarization component 254 are anchored in the geometry of the apparatus 10, of which the splitter 60 is a component.

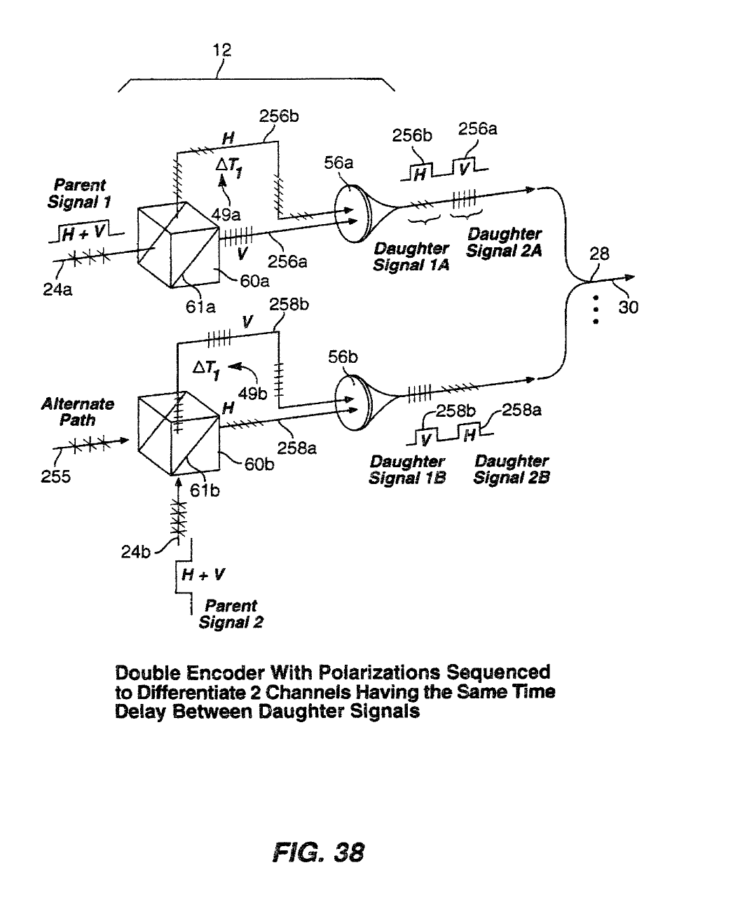

Referring to FIG. 38, an input signal 24a enters a splitter 60a, which separates out the signal 256a, containing the horizontal component 252, and the signal 256b containing the vertical component 254. The orientation of the horizontal component 252, and the vertical component 254 represented in the signals 256a, 256b, respectively, is maintained from the splitter 60a to the photonic element 56a, responsible for directing the signals 256 into the carrier medium 30 as sequential daughter signals 256a, 256b. Thus, introduction of the parent signal 24b into the splitter 60b at an orientation orthogonal to that of the entry of the signal 24a into the splitter 60a, produces splitting at the surface 61b at a different set of orientations.

That is, the horizontal component 252 is embodied in the direct signal 258a while the vertical component 254 is embodied in the delayed signal 258b. As with the signals 256a, 256b, the optical element or photonic element 56b (as appropriate) launches the daughter signals 258a, 258b into the carrier medium 30 via the combiner 28.

Significantly, the signal 256a leads, having a vertical component 254, while the horizontal component 252 in the signal 258a leads. The delay 49a between the signals 256a,256b results from the fact that the signal 256a passes directly from the splitter 60a to the photonic element 56a. Meanwhile, the signal 256b passes indirectly through a time delay 49a to the photonic element 56a.

By contrast, due to the orientation of the incoming signal 24b, and the orientation of the surface 61b, the signal 258a passes directly from the splitter 60b to the photonic element 56b. Meanwhile, the indirect signal 258b passes through the time delay 49b on its path to the photonic element 56b. Accordingly, the signal 258b trails the signal 258a, and embodies the vertical component 254, in contrast to the relative components 252, 254 of the signals 256a, 256b.

The paths 256b, 258b, or signals 256b, 258b may be subjected to the corresponding delays 49a, 49b by any suitable optical elements, including mirrors, optical fibers, changes in refracted indices, and so forth. The significance of the apparatus of FIG. 38 is the creation of two separate channels sending data simultaneously over the carrier medium 30 by virtue of polarization sequencing.

In one embodiment, the functions of the splitter 60a and the splitter 60b may be consolidated into a single splitter 60b. In such an alternative embodiment, one merely need pass a signal 255 directly into the splitter 60b, as illustrated, to provide the same signal and identical functionality as the signal 24a. Since the path 255 or input signal 255 is orthogonal to the path and signal 24b relative to the surface 61b, the functionality of this alternative embodiment is identical to that of the twin splitters 60a, 60b. However, one advantage of the illustrated embodiment is that the splitter 60a and the splitter 60b can be in remote locations with respect to one another. Thus, different locations, even different cities, may be served by the splitters 60a, 60b acting as encoders 12.

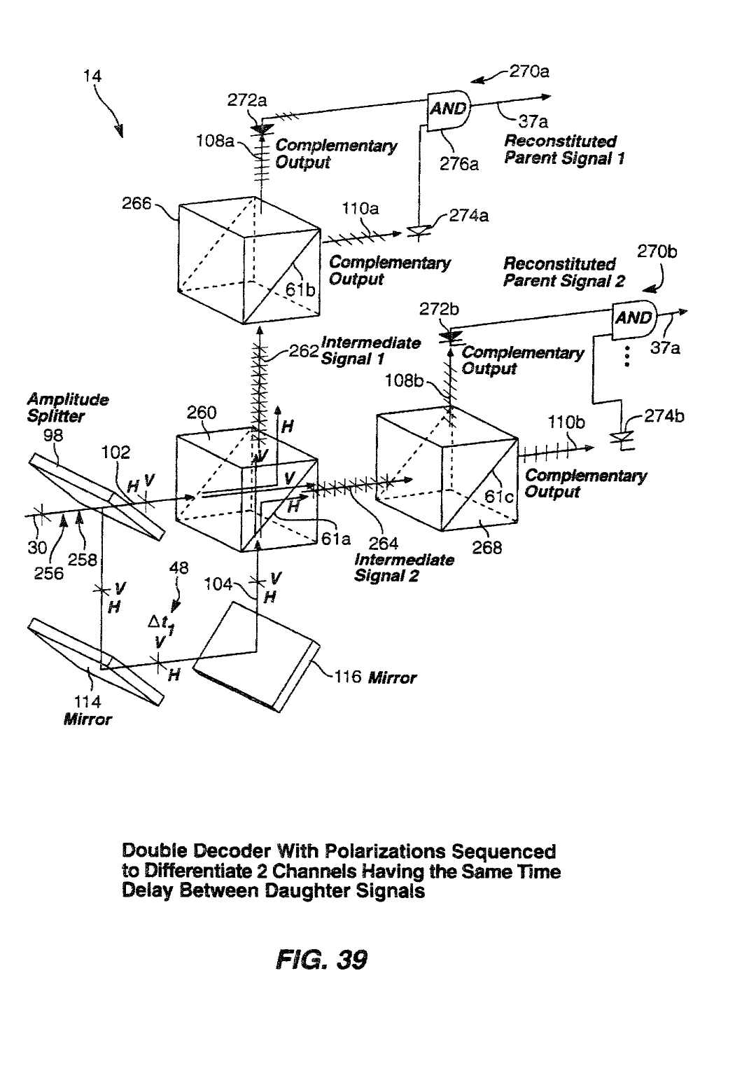

Referring to FIG. 39, a double decoder 14 separates polarization sequenced signals 256, 258 in order to differentiate two channels of information having the same time delay 49. The time delays 49a, 49b in FIG. 38, and the time delay 49 in FIG. 39 are substantially the same.

The signals 256,258 enter the decoder 14 over the carrier medium 30 as multiplexed signals. The decoder 14 is responsible to de-multiplex the two channels. The method for producing the delay 49 may be similar to, or identical to, any of those heretofore discussed, as appropriate. The multiplexed signals 256, 258 arriving over the carrier medium 30 are divided by the amplitude splitter 98 between a direct path 102 and a delay path 104.

The direct path 102 or direct signal 102 passes into the divider 260 serving as a polarization channel divider 260 (a splitter 60) to be split on the basis of polarization between a horizontal component 252 and a vertical component 254. The horizontal component will be reflected upward toward the component separator (polarization component separator) 266, while the vertical component 254 will be transmitted through the divider 260 toward the polarization component separator 268 (separator 268).

Meanwhile, the delayed path 104 or delay signal 104 enters the divider 260 orthogonal to the signal 102 or path 102. Accordingly, the vertical component 254 of the signal 104 is transmitted through the divider 260 toward the separator 266. By the same token, the horizontal component 252 of the signal 104 is reflected from the surface 61 a toward the separator 268 (polarization component separator 268).

In providing the delay 49, the decoder 14 of FIG. 39 relies on mirrors 114, 116. Nevertheless, any suitable method discussed herein, or an equivalent known in the art, may suitably provide the delay 49.

The functions of the polarization component separators 266, 268 are identical. Therefore, the explanation of one, reflects the operation of the other. For example, the intermediate signal 262 represents all signals that may arrive in the illustrated orientation, regardless of channel. Similarly, the intermediate signal 264 represents all signals that may arrive in the illustrated orientation, regardless of channel. The intermediate signal 262 is split by the surface 61b into complementary outputs 108a, 110a, having orthogonal polarizations. Similarly, the complementary outputs 108b, 110b have orthogonal polarizations. The complementary signals 108, 110 enter a coincidence detector 270. Note that the trailing reference letters refer to specific instances of the more generic item identified by the corresponding reference number.

The coincidence detectors 270a, 270b may utilize fully photonic configurations (circuitry, components, etc.) or electronic configurations. However, for simplicity and clarity, electronic circuitry is illustrated. Nevertheless, the photonic circuitry for accomplishing the function has been described in the prior art. In the illustrated embodiment, a pair of diodes 272, 274 feeding into an AND (e.g. a Boolean AND circuit) 276. When both complementary outputs 108, 110 corresponding to a single channel are “coincident,” a reconstituted parent signal 37 is output from the AND gate 276. Any other condition produces a null output as the signal 37.

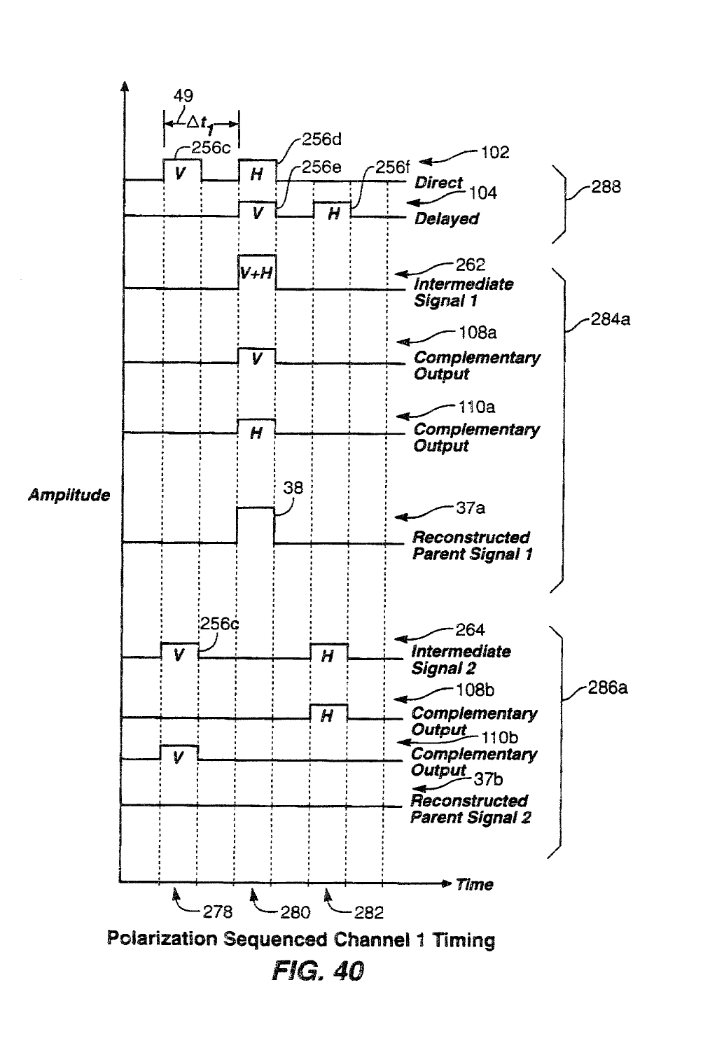

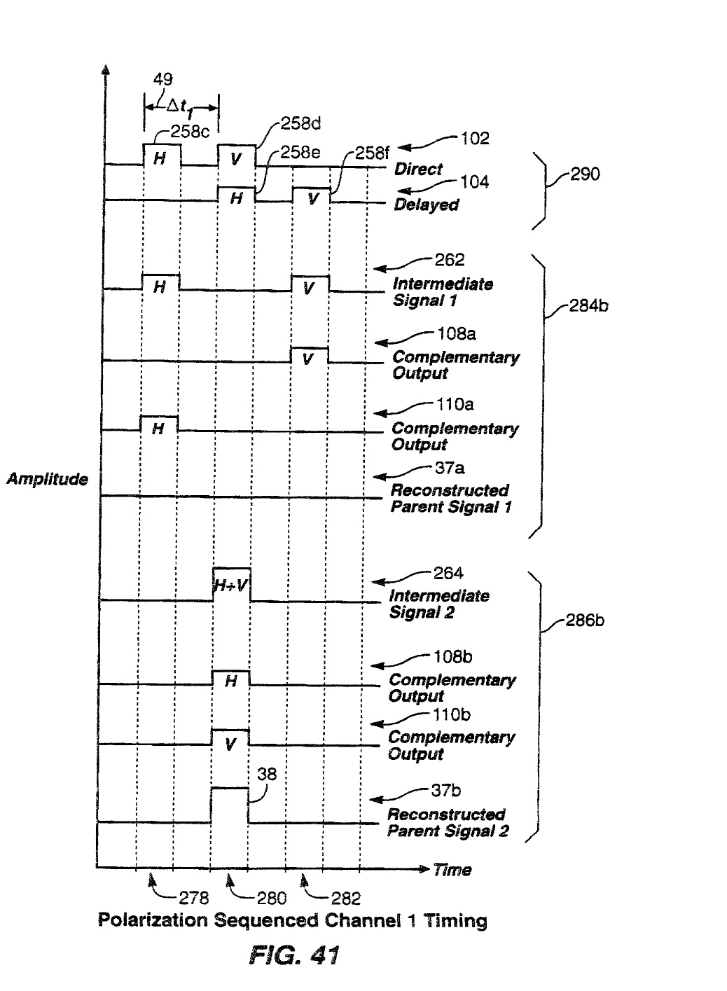

Referring to FIGS. 40-41, a timing diagram illustrates the functioning of the apparatus 14 of FIG. 39. The timing relationships of the timing diagram of FIGS. 40-41 illustrate why the functioning of the decoder 14 of FIG. 39 produces channeling based on polarization sequencing.

Referring to FIG. 40, a timing diagram for a first channel provides a direct signal 102 and a delayed signal 104 representing the signal 256 received at the divider 260. The leading pulse 256c contains the vertical component 254, and the trailing pulse 256d contains the horizontal component 252. Similarly, the leading pulse 256e contains the vertical component 254 while the trailing pulse 256f contains the horizontal component 252 in the delayed signal 104.

In the same fashion, the leading pulse 258c contains the horizontal component 252 and the trailing pulse 258d contains the vertical component 254. In like manner for the delayed signal 104, the leading pulse 258e contains the horizontal component 252 while the trailing pulse 258f contains the vertical component 254.

It is important to remember that each of the signals 102, 104 in the timing diagrams of FIGS. 40-41 represent granddaughter pulses created by the amplitude splitter 98 of the apparatus 14 (decoder 14) of FIG. 39. In any event, the leading and trailing relationship of the vertical and horizontal components of any signal are reversed to differentiate a first channel from a second channel. In certain embodiments, one may refer to this sequencing of polarization as an encoding scheme, and consequently a decoding scheme for a telecommunications network.

The process of decoding is illustrated by observing its performance during adjacent time intervals 278, 280,282. During the time interval 278 the leading pulse 256c of the direct signal 102 contains the vertical component 254. The vertical component 254 is separated by the divider 260 to provide the intermediate signal 264. The signal energy is then transmitted through to the complementary output 110b leaving all the other signals null.

Similarly, during the time interval 282, the delay signal 104 contains a trailing pulse 256f embodying the horizontal component 252. Accordingly, the divider 260 outputs the intermediate signal 264 containing the energy of the horizontal component 252, which is then directed into the separator 268 to be output as the complementary output 108b. All other signals are null.

As a result, during these two time intervals 278, 282, the reconstructed parent signal 37b is null, as is the reconstructed signal 37a. During the time interval 280, coincidence exists between the trailing pulse 256d of the direct signal 102, and the leading pulse 256e of the delayed signal 104. Accordingly, both the horizontal and vertical components 252, 254 are present.

Thus, the energy of both pulses 256d, 256e may be output as the intermediate signal 262 of a first channel. That energy is separated by the separator 266 into the complementary outputs 108a, 110. Therefore, the coincidence detector 270 detects the coincidence and produces the pulse 38 as the reconstructed parent signal 37a. The other signals 264, 108, 110b, 37b of the second channel are null.

The response 284a corresponds to a first channel, and the response 286a represents a second channel, to the signal set 288 received as a multiplexed input. Similarly, the response 284b of the first channel, and the response 286b of the second channel are in correspondence with the signal set 290 received as a multiplexed input of the second channel.

The time delays 49 for both channels are identical. Accordingly, during the time interval 278, the leading pulse 258c contains a horizontal component 252 directed into the intermediate signal 262 and subsequently directed to the complementary output 110a. The remainder of the signals during the time interval 278 are null. Similarly, the trailing pulse 258e of the delayed channel 104 contains a vertical component 254 transmitted through (directed to) the intermediate signal 262. The complementary output 108a contains that same energy of the vertical component 254. The value of all other channels during the time interval 282 is null.

During the time interval 280, the coincidence time, the trailing pulse 258d of the direct signal 102, and the leading pulse 268e of the delayed signal 104 are directed into the intermediate signal 264 of the second channel. Subsequently, the energy thereof is divided by the separator 268 into the complementary outputs 108b, 110b. The result of the operation of the coincidence detector 270b is a reconstituted parent signal 37b embodying the pulse 38.

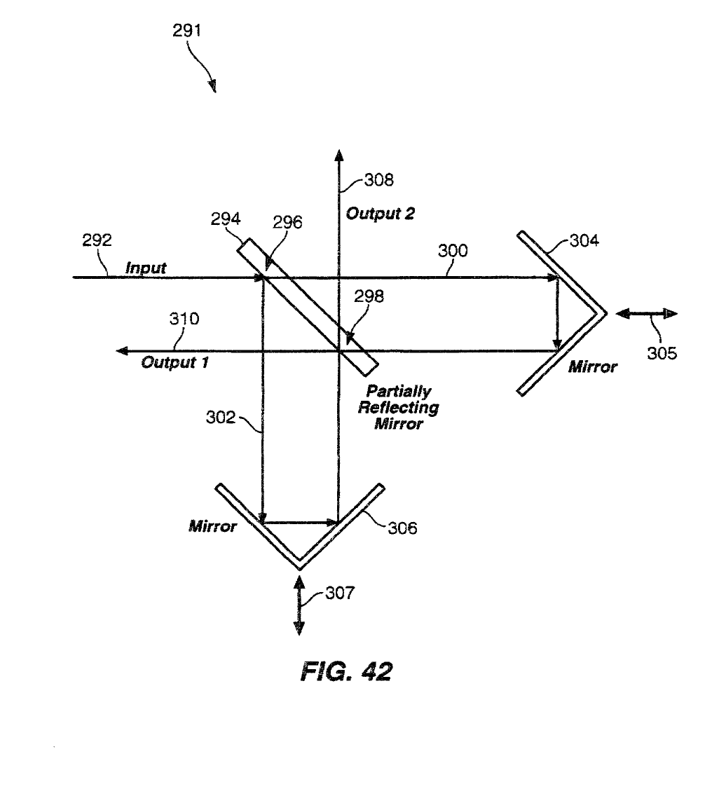

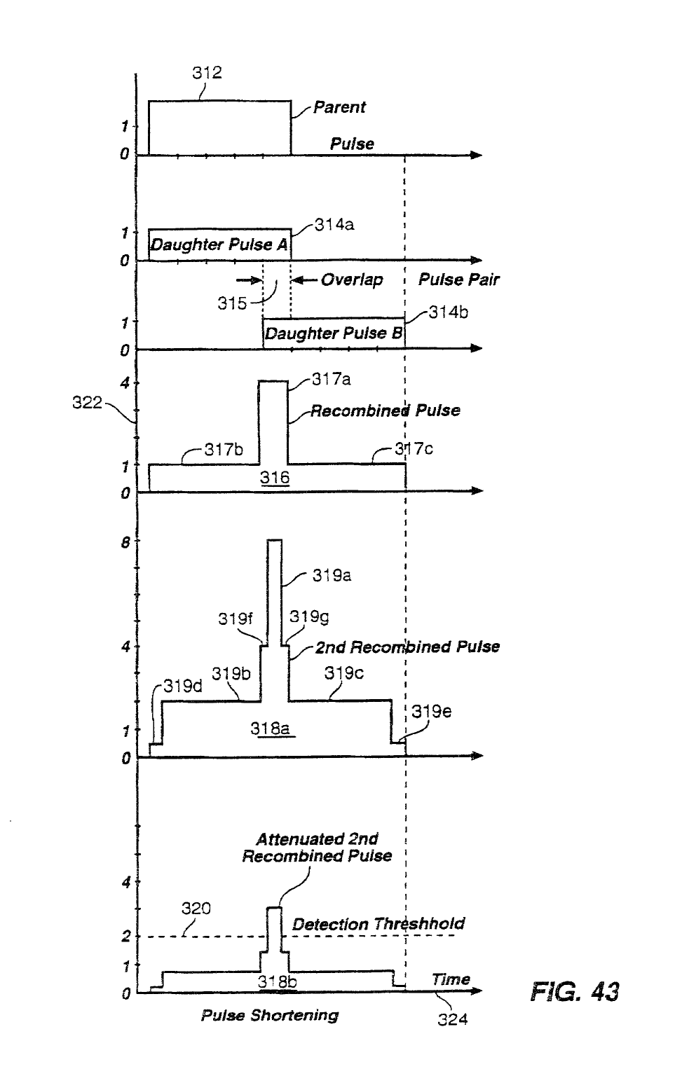

Referring to FIGS. 42-43, a method and apparatus are available for narrowing the width of a pulse containing information, such that more pulses may be launched in a carrier medium per unit time, without saturating the carrier medium. Meanwhile, signal-to-noise ratios are maintained, and information is not lost.

One valuable application of such a method and apparatus is to provide an initial parent pulse 24 suitable for a delay-domain multiplexer in accordance with the invention. An initial photonic input 292 may be thought of as a base or initial parent pulse, which could have been received as a parent pulse 24 into a delay-domain multiplexer 10. However, the function of the apparatus of FIGS. 42-43 is to further reduce such a pulse in width in order to provide an improved parent pulse 24. Thus, one may think of the input pulse or input signal 292 as a raw pulse of arbitrary width, which width is to be reduced further. Thus, one may think of the apparatus and method of FIGS. 42-43 as an improved signal processing device for pre-processing a parent signal 24 prior to entry into a delay-domain multiplexer.

In the embodiment of FIG. 42, a photonic input 292 is directed toward a partially reflecting mirror 294. In this particular embodiment, the mirror 294 operates to provide two separate functions at two distinct locations 296, 298. A splitting portion 296 splits the input signal 292 into a transmitted portion 300, and a reflected portion 302. The transmitted signal 300 is reflected back from the retroreflecting mirror 304 towards the interferometer portion 298. The interferometer portion 298 of the mirror 294 transmits a portion of the incoming signal 300, and reflects a portion 308.

Meanwhile, the reflected signal 302 is reflected back from the mirror 306 (a retroreflecting mirror 306) to create superposition with the reflected portion 308 of the signal 300. Accordingly, the interferometer portion 298 provides two complementary outputs 308, 310.

Referring to FIG. 43, while continuing to refer to FIGS. 1-42, generally, an initial parent pulse 312 may be contained in the input signal 292. The mirror 294 splits the pulse 312 at the splitting portion 296 to produce two daughter pulses 314a, 314b. Since the mirrors 304, 306 are adjustable in their respective adjustability directions 305, 307, the daughter pulses 314a, 314b may be timed in order to produce an overlap 315. The overlap 315 may be thought of as an adjustable overlap 315. One of the outputs 308,310 will produce constructive interference, during the overlap 315, and the other will produce destructive interference during the same time period. The recombined pulse 316 occurs in which ever of the complementary outputs 308, 310 produces constructive interference.

In certain embodiments, the pulse 316 may be input into another pulse concentrator 291 (see FIG. 42), or may be launched directly into a delay-domain multiplexer. In the embodiment of FIG. 43, two passes may occur through the same or different concentrators 291. A concentrator 291 having a shorter time delay is used for clarity of illustration. The recombined pulse 318a is the result (output) of a second concentrator 291. Further passes through the same or a distinct concentrator 291 are possible, feasible, and, in some cases, recommended. Nevertheless, for the purposes of illustration, the example of FIG. 43 is sufficient.

The effect of the concentrator 291 is to redistribute the energy from the initial parent pulse 312 between the daughter pulses 314, and then into the constructive interference portions 317a and associated skirts 317b, 317c of the reconstructive pulse 316. The effect is to concentrate a greater proportion of the energy into the constructive interference portion 317a during the overlap time period 315.

Further concentration through a pulse concentrator 291, having the recombined pulse 316 as an input, produces the second recombined pulse 318a. In this instance, the constructive interference phenomenon concentrates more energy per unit time in the signal portion 319a. Interference contributes to the energy per unit time in the shoulders 319b, 319c, as well as in the secondary shoulders 319f, 319g. However, the most significant signal portion 319a, best improves the overall signal-to-noise ratio. One may note that the skirts 319d, 319e occur during times when no constructive interference occurs in any of the concentrators 291, regardless of how many have been cascaded together.

An additional benefit may be obtained in certain embodiments of an apparatus 291 in accordance with the invention. The second recombined pulse 318a is attenuated to produce the attenuated pulse 318b. Attenuation may be accomplished through a variety of mechanisms. In certain presently preferred embodiments, attenuation may be accomplished by an attenuator proximate the production of the recombined pulse 318a.

In an alternative embodiment, natural attenuation occurring in a transmission line may be relied upon to produce the attenuated pulse 318b from the pulse 318a. Thus, attenuation may be accomplished, respectively, either before or after entry of a pulse 24 into a delay-domain multiplexing encoder 12. Moreover, attenuation may occur by either natural attenuation of certain transmission media or by inclusion of a specific attenuating device intentionally positioned either before or after an encoder 12.

In certain embodiments, such as the configuration of FIG. 26, junctions 28 or combiners 28 may present a certain degree of attenuation or loss of signal. Accordingly, the network of FIG. 26 may take advantage of the loss occurring in the individual combiners 28 in order to produce the attenuated signal 318b for launch onto the carrier medium 30. As a direct, reliable, and even calculable and deterministic result, more encoders 12 may be multiplexed together to feed (launch) information into the carrier medium 30 without saturation. This effect is directly traceable to the overall reduction of energy in each pulse 318b transmitted. Due to the accentuated SNR, a detection threshold 320 may easily be met. The remainder of the pulse 318b may be discriminated as noise or otherwise ignored as noise would be. Thus, in the time domain 324, the concentration of signals provides adequate amplitude, with minimum energy in each bit.

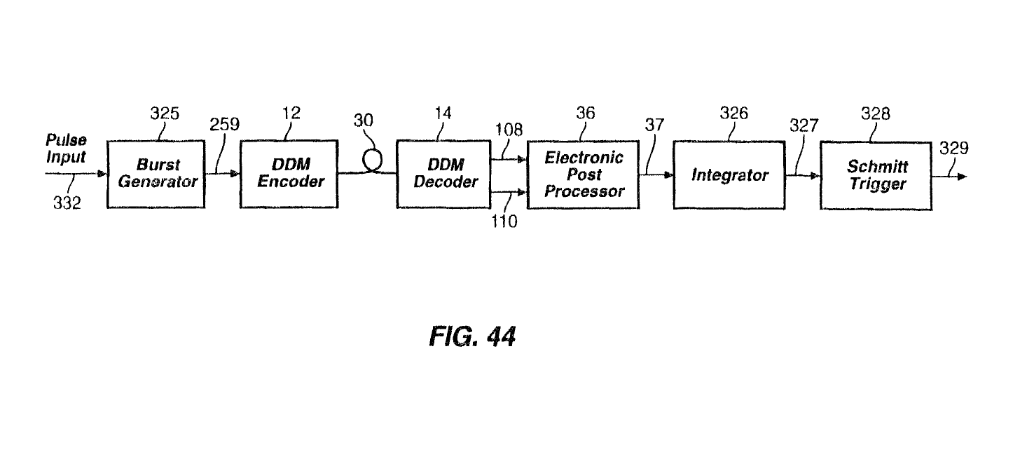

Referring to FIGS. 44-47, a burst generator 325 provides an alternative method and apparatus for reducing the transmitted energy per bit, while maintaining adequate SNR. In the embodiment illustrated in FIGS. 44-47, energy transmitted is substantially decreased, the pulse width of a parent pulse may be maintained, and the SNR is substantially maintained.

The signal conditioning provided by the burst generator 325 is “undone” by a combination of an integrator 326 and a subsequent Schmitt trigger 328. The reconstructed output pulse signal 329 looks substantially identical to the input signal 332. The effect of the burst generator 325 is to replace an electronic input 332 with a series of much shorter photonic “spikes” occurring pseudo-randomly within the time period of the original pulse of the signal 332.

The original pulse is converted into a signal best described as a series of pedestals or a series of bristles, each having a large void fraction in the time domain. A delay-domain multiplexer, in accordance with the invention, thereafter transmits the bristle-like signals, requiring substantially reduced energy per channel of information. The bristles may be converted back to electronic form by an electronic post processor 36. The electronic version of the “bristle signals” is integrated by the integrator 326, provided as a signal 327 (integrated output 327) to drive the Schmitt trigger 328, which, in turn, produces the reconstituted output 329.

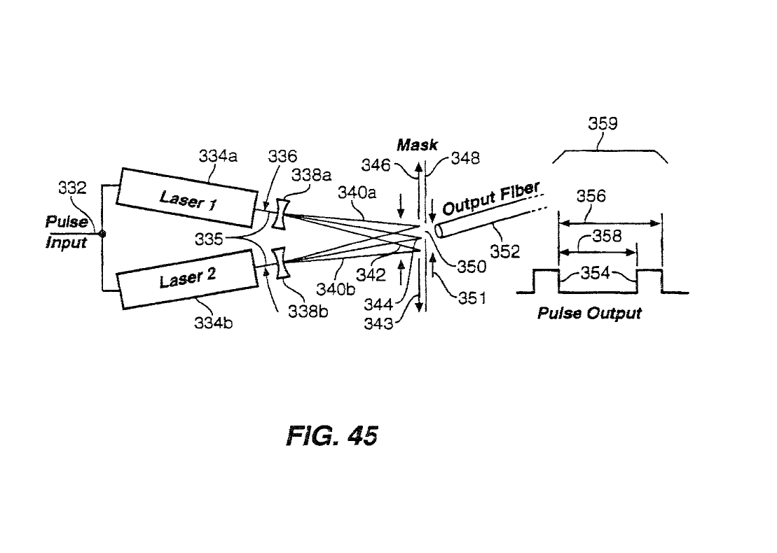

Referring to FIGS. 45-47, while continuing to refer generally to FIGS. 1-44, a pulse input 332, characterized by a pulse 362 extending over a time interval 364 is provided as an input 332 into a pair of lasers 334a, 334b operate at frequencies that are close, but not identical. A tremendous advantage in this configuration for the laser 334 is that exact frequency matching is not required. Provision of two lasers 334 that are substantially close in frequency, but not identical is a relatively inexpensive proposition. Thus, a comparatively inexpensive burst generator 325 is possible.

By contrast, in the art of laser design, a distinct tendency exists to seek longer coherence lengths, and higher precision and predictability in the output of lasers. Meanwhile, an apparatus in accordance with the present invention takes advantage of comparatively inexpensive lasers, to provide a distinct advantage in generating signals, a distinct improvement in the art.

The lasers 334a, 334b produce beams 335a, 335b, respectively, that are directed toward one another at a selected angle 336. The angle 336 is exaggerated in the illustration, and may be selected to produce the desired effect of interference therebetween. Optional optical elements 338 may further condition the beams 335. Nevertheless, with or without the optical elements 338, the beams 335 are superpositioned to produce a Young's-type interference fringe. If the optional lenses 338 or other equivalent optical elements 338 are used, then an expanded beam 340 may result from each of the respective beams 335.

Nevertheless, by either mode, Young's-type interference occurs within an image region 342. Within the image region 342, a constructive interference point 344 moves continually in a lateral direction 346 across the interference region 342 in accordance with the “beat frequency” corresponding to the two frequencies associated with the respective lasers 334a, 334b.

The constructive interference point 344, or constructive interference 344, continues to sweep back across the region 342 defined by a width 343. An aperture 350 is smaller than the width 343 of the interference region 342. The aperture width 351 may correspond to an optional mask 348, or a significant plane (e.g. diameter of cross-section) of an output fiber 352. In either event, the ratio between the aperture width 351 and the width 343 of the interference region 342 defines a duty cycle of the individual spikes 354. The result is a continual stream of spike pulses (bristle pulses) 354 as long as the pulse 362 remains on during the interval 364.

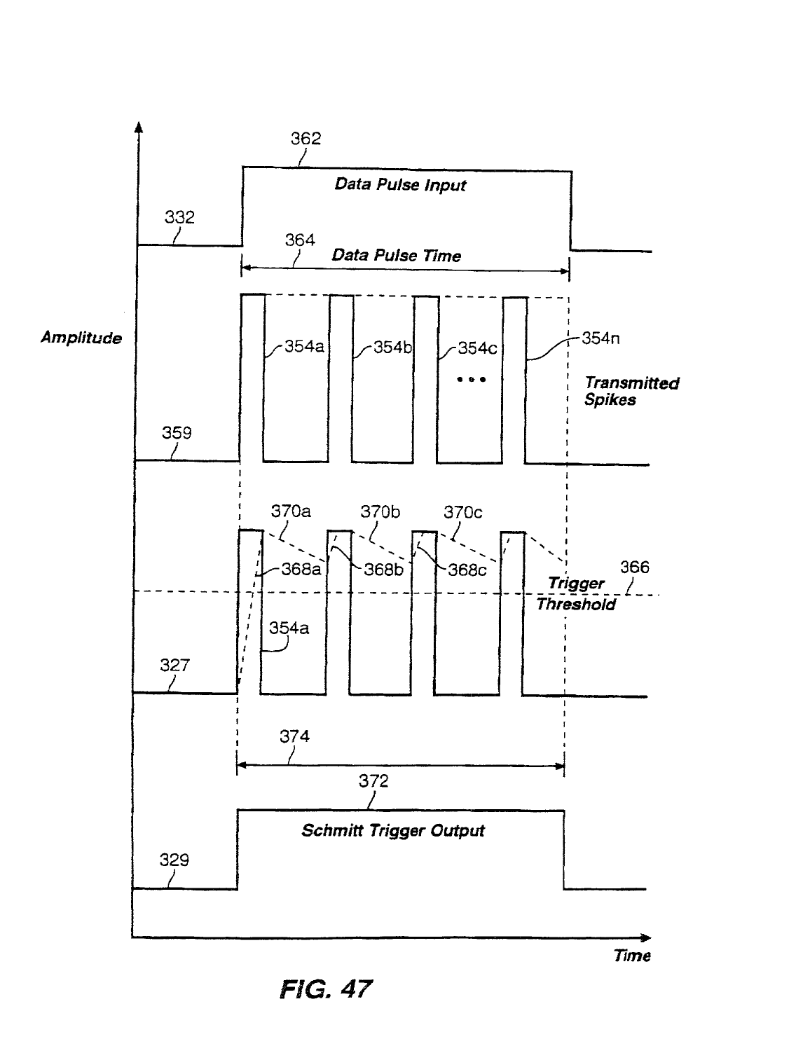

Each of the pulses 354 (see FIG. 47) maintains the desired SNR, yet contains substantially less energy than that contained in the original pulse 362 during the same corresponding time interval time period. Thus, all of the bristle pulses 354 together have less net energy during the time interval 364 than does the pulse 362, while maintaining a high SNR.

One may think of the bristle pulses 354 as having a period 356 determined by the beat frequency, resulting in an off time 358 therebetween. Just as the signal 332 contains a pulse 362, the output signal 359 of the burst generator 325 contains a series of pulses 354 that are effectively “bursts” for bristle pulses 354.

The burst pulses 354 or bristle pulses 354 pass into the encoder 12, and eventually through the decoder 14, as the complementary outputs 108, 110. The pulses 354 are then processed by the electronic post processor 36 to become the output signal 37. The integrator 326 receives the signal 37 and produces the output signal 327 containing a wave form 365. The wave form 365 remains above a trigger threshold 366 at all times during the time interval 364.

For example, each burst pulse 354 (e.g. pulse 354a) includes a rise portion 368 followed by a decay portion 370. Immediately thereafter, the next burst pulse 354 (e.g. burst pulse 354b in the example) has a subsequent rise portion 368B followed by a decayed portion 370b. Accordingly, during the entire time period 364, the value of the wave form 365 remains above of the trigger threshold 356. This wave form 365 of the signal 327 drives a Schmitt trigger 328.

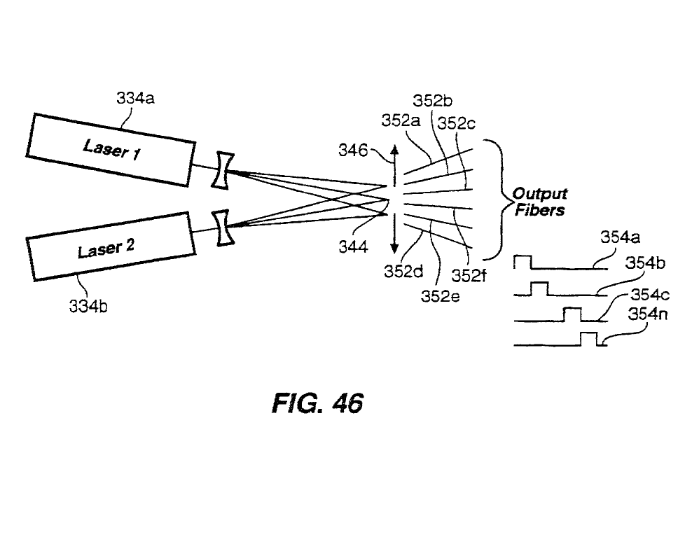

Referring to FIG. 47, the Schmitt trigger 328 of FIG. 46 triggers at the threshold value 366 producing an output signal 329. The output signal 329 is characterized by a reconstructed pulse 372 extending over substantially the same time interval 364. In reality, due to the shape of the wave form 365, and the operation of the Schmitt trigger 328, the actual time interval 374 may differ slightly from the original time interval 364. Nevertheless, all the digital information contained in the original pulse 362 is reconstituted in the output pulse 374 from the Schmitt trigger 328. Thus, all the information included in the signal 332 is contained in the output signal 329.

The apparatus of FIG. 46 illustrates an alternative embodiment of a burst generator 325. In the embodiment of FIG. 46, the lasers 334 may operate identically to those of FIG. 45. Nevertheless, rather than relying on masking or separation by virtue of an aperture in a mask or an aperture of a single output fiber, the constructive interference point 344 is permitted to sweep across a plurality of output fibers 352, thus creating a plurality of sequenced burst pulses 354 sequentially in those fibers 352. Each fiber 352 may be thought of as a single aperture accessed in sequence. The signals in each of the output fibers 354a, 354b, 354c, 354d may be subsequently modulated with their own unique information as multiple, sequenced channels. A photonic, time-division multiplexing operation may be thus conducted. This embodiment also exhibits the dispersive advantages of pulse 238 of FIG. 29.

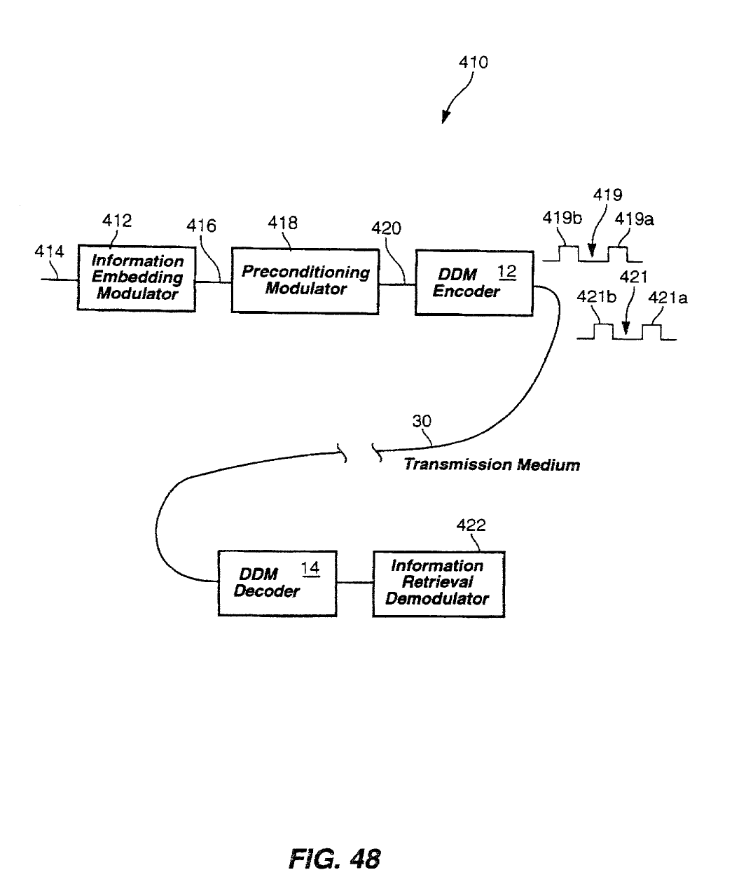

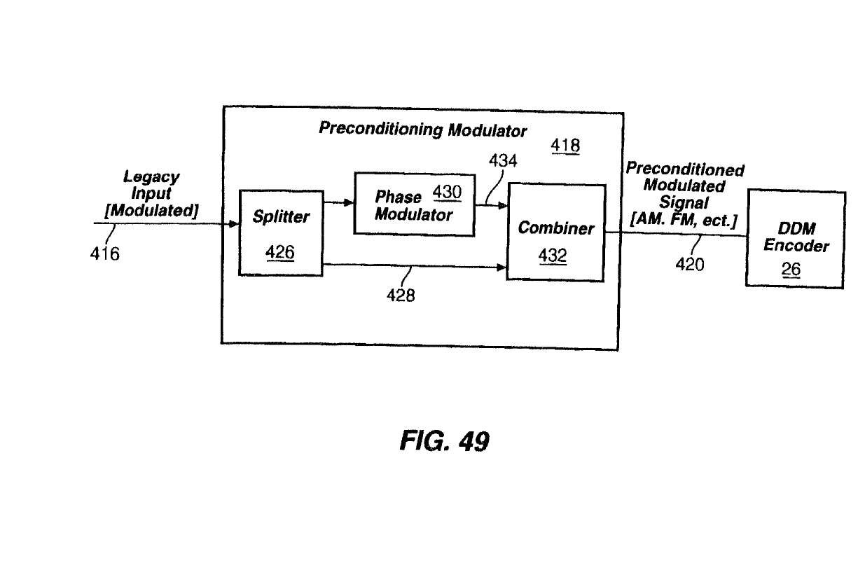

Referring to FIGS. 48-50, an apparatus 410 may receive an input signal 414 into a modulator 412. The modulator may pass a modulated signal 416 into a preconditioning modulator 418. The function of the preconditioning modulator is to continually vary the value of a parameter used for modulation, in order to provide a preconditioned signal 420 into a delay-domain encoder 12. The preconditioning of the signal 416 assures that a leading daughter signal 419a associated with one daughter pair 419 (e.g. 419a, 419b), will not provide coherence coincidence with a trailing daughter signal 421b from a preceding daughter pair 421 (e.g. signals 421a, 421b).

The transmission medium 30 carries the signals 419, 421 to a delay-domain decoder 14 for de-multiplexing. Thereafter the information can be retrieved by demodulation in the demodulator 422. The purpose of the modulation in the preconditioning modulator 418 is accomplished by the mere avoidance of accidental coherence coincidence, and thus no corresponding demodulation is required. Also, the multiplexing and demultiplexing are independent from the modulation of the original modulator 412 embodying the information in the signal 416.

The input signal 414 may be any suitable analog or digital signal, including a legacy signal from a fiberoptic system, or a conversion of an electronic signal to a photonic signal. In one presently preferred embodiment, the input signal 414 is modulated in any suitable domain, including modulation in multiple domains. Modulation for embedding information may be compounded by modulation for preconditioning.

Domains for pre-conditioning modulation, may include, for example, amplitude, frequency, phase, and polarization. The pre-conditioning modulator 418 may include a splitter 426 that passes one signal along a path 428 directly, and another signal into a modulator 430. In certain embodiments, modulation may be accomplished by a Mach-Zehnder phase modulator 430 driven beyond the typical 180 degrees of phase shift, in order to produce frequency modulation. Experiments have shown that this phase modulation technique to produce frequency modulation produces the desired result.

In certain embodiments, the modulator 418 may include a splitter 426 selected to split based on amplitude or another suitable domain. A phase modulator 430 may be configured to continually alter the input signal 416 to produce frequency modulation at varying values of frequency. The preconditioned signal passes through the path 434 to the combiner 432. Meanwhile, the direct signal passes through the bypass path 428 to the combiner 424. The splitter 426 and combiner 432 may be solid, fiber, or free-space devices.

Thus, in certain embodiments, an original input signal 414 may be modulated in a first domain, and then modulated in a second domain to provide compound modulation. The domains may preferably be different. Domains may include amplitude, frequency, and polarization. The compound-modulated input signal 420 may, after this preconditioning, be launched into a delay-domain encoder 12 for multiplexing.

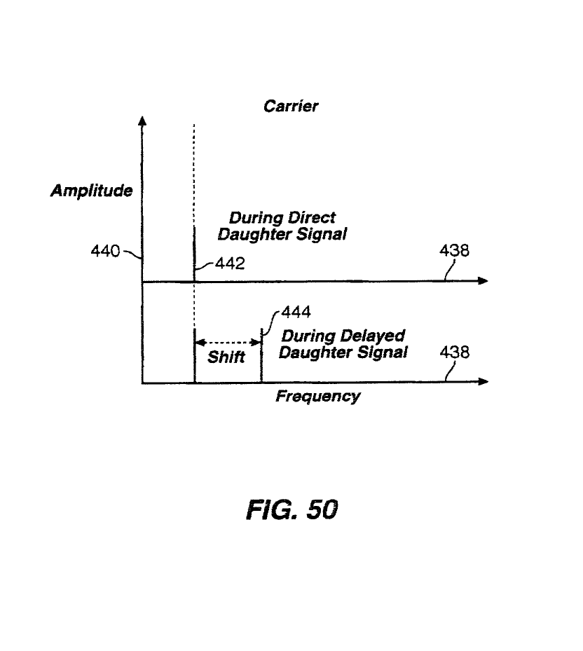

At any given instant of time, a signal 426 may be propagated at a frequency 438 as illustrated in FIG. 50. A conventional or legacy signal 414, 416, modulated (e.g. FM) to a signal 420 with its new protection against accidental coherence coincidence between disparate information, may be launched into a delay-domain encoder 12 for splitting into daughter signals 48,419,421 as discussed earlier. An amplitude 440, plotted against a frequency 438 illustrates an embodiment of a direct daughter signal 442, and a delayed daughter signal 444.

By the time a delayed daughter signal 428 is ready to be re-combined, a parametric value (e.g. a frequency) of a direct signal from a subsequent wave form 412 has moved slightly off the nominal value of the preconditioning-modulation-domain parameter (e.g. frequency) in the compound modulation, preconditioning domain. Due to the shift, No interference can occur between the trailing (delayed) daughter 444 of a first set of daughter signals and the leading (direct) daughter 442 of the subsequent set of daughter signals. Thus cross-talk due to accidental interference (coherence coincidence) may be greatly reduced.

Time delays used for multiplexing in a delay domain may be selected for optimum performance. The domain and the drift or continual shifting in the value of a modulated parameter in a preconditioning domain can be selected to operate in tandem (compounding) with another modulation domain relied upon to encode information. By coordinating, for example, a frequency in a frequency modulation of a signal, with the delay used in a delay-domain encoder of a delay-domain multiplexing system, accidental coherent coincidence may be avoided.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for generating short-duration pulses, the apparatus comprising:
an input line configured to receive an input signal having a first arbitrary frequency;
an output line configured to send a photonic signal to aphotonic destination device operating at a second arbitrary frequency different from the first arbitrary frequency; and
a self-synchronizing interface operable to synchronize transfer of information received from the input line, at the first arbitrary frequency, to the output line, at the second arbitrary frequency.

2. The apparatus of claim 1, wherein the self-synchronizing interface is operable at an operation frequency limited by the order of magnitude of a wavelength corresponding to the photonic signal.

3. The apparatus of claim 2, wherein the input signal is selected from a photonic input signal and an electronic input signal.

4. The apparatus of claim 3, wherein the input signal is an input pulse.

5. The apparatus of claim 4, wherein the self-synchronizing interface further comprises a pulse generator operating fully photonically.

6. The apparatus of claim 5, wherein the pulse generator is configured to generate, repetitively, sequences of photonic pulses derived from a beat frequency corresponding to an interaction of two, photonic, source frequencies.

7. The apparatus of claim 6, wherein the fully-photonic, pulse generator provides timing pulses as a time base of the self-synchronizing interface.

8. The apparatus of claim 7, wherein the self-synchronizing interface further comprises a sampling module for sampling the input signal in order to transfer information therefrom into the output signal.

9. The apparatus of claim 1, wherein the input signal is selected from a photonic input signal and an electronic input signal.

10. The apparatus of claim 1, wherein the input signal is an input pulse.

11. The apparatus of claim 1, wherein the self-synchronizing interface further comprises a pulse generator operating fully photonically.

12. The apparatus of claim 1, wherein the self-synchronizing interface is further configured to generate, repetitively, sequences of photonic signals derived from a beat frequency corresponding to an interaction of two, photonic, source frequencies.

13. The apparatus of claim 1, further comprising a fully-photonic, pulse generator configured to provide timing pulses as a time base of the self-synchronizing interface.

14. The apparatus of claim 1, wherein the self-synchronizing interface further comprises a sampling module for sampling the input signal in order to transfer information therefrom into the output signal.

15. The apparatus of claim 1, wherein at least one of the first and second arbitrary frequencies corresponds to a bit rate.

16. The apparatus of claim 1, wherein at least one of the first and second arbitrary frequencies corresponds to a carrier frequency.

17. The apparatus of claim 1, wherein at least one of the first and second arbitrary frequencies corresponds to an analog carrier frequency.

18. An apparatus for generating short-duration pulses, the apparatus comprising:
a first laser configured to generate a first beam, characterized by a first frequency;
a second laser configured to generate a second beam, characterized by a second frequency having a value proximate the value of the first frequency but distinguishably different therefrom;
a first lens region positioned to spatially spread the first beam;
a second lens region positioned to spatially spread the second beam to superimpose on the first beam at a location in space, forming an interference pattern thereat; and
an output target positioned proximate the location in space for receiving a selected portion of the interference pattern.

19. The apparatus of claim 18, further comprising a mask positioned to select the selected portion of the interference pattern.

20. The apparatus of claim 19, wherein the output target is sized to select the selected portion of the interference pattern.

21. The apparatus of claim 20, wherein the output target comprises an optical fiber.

22. The apparatus of claim 21, wherein the optical fiber has a diameter selected to limit the portion of the interference pattern receivable therethrough.

23. The apparatus of claim 18, further comprising a plurality of output targets.

24. The apparatus of claim 23, wherein each output target corresponds permanently to a position in the interference pattern.

25. The apparatus of claim 24, wherein each output target represents a channel for receiving a fully-photonic signal.

26. The apparatus of claim 25, wherein each output target receives, sequentially, a fully-photonic pulse.

27. The apparatus of claim 26, wherein the pulse corresponds to a portion of the interference pattern selected from destructive interference and constructive interference.

28. The apparatus of claim 18, wherein the output target comprises an optical fiber.

29. A method for generating short-duration pulses, the method comprising:
providing an input signal having a first arbitrary frequency;
self-synchronizing the input signal with a photonic output signal having a second arbitrary frequency; and
providing the photonic output signal to a photonic destination device operating at the second arbitrary frequency different from the first arbitrary frequency.

30. The method of claim 29, wherein self-synchronizing is executed at an operation frequency limited by the order of magnitude of a wavelength corresponding to the photonic output signal.

31. The method of claim 30, wherein the input signal is selected from a photonic input signal and an electronic input signal.

32. The method of claim 31, wherein the input signal is an input pulse.

33. The method of claim 32, wherein self-synchronizing further comprises generating a photonic pulse.

34. The method of claim 33, wherein generating further comprises repetitively forming sequences of photonic pulses derived from a beat frequency corresponding to an interaction of two, photonic, source frequencies.

35. The method of claim 34, wherein generating further comprises generating timing pulses as a time base for self-synchronization.

36. The method of claim 35, wherein self-synchronizing further comprises sampling the input signal in order to transfer information therefrom into the output signal.

37. The method of claim 29, wherein the input signal is selected from a photonic input signal and an electronic input signal.

38. The method of claim 29, wherein the input signal is an input pulse.

39. The method of claim 29, wherein self-synchronizing further comprises generating a photonic pulse.

40. The method of claim 29, wherein self-synchronizing further comprises generating repetitively forming sequences of photonic pulses derived from a beat frequency corresponding to an interaction of two, photonic, source frequencies.

41. The method of claim 29, wherein self-synchronizing further comprises generating timing pulses as a time base therefor.

42. The method of claim 29, wherein self-synchronizing further comprises sampling the input signal in order to transfer information therefrom into the output signal.

43. The method of claim 29, wherein at least one of the first and second arbitrary frequencies corresponds to a bit rate.

44. The method of claim 29, wherein at least one of the first and second arbitrary frequencies corresponds to a carrier frequency.

45. The method of claim 29, wherein at least one of the first and second arbitrary frequencies corresponds to an analog carrier frequency.

46. A method for generating short-duration pulses, the method comprising:
generating a first beam, characterized by a first frequency;
generating a second beam, characterized by a second frequency having a value proximate the value of the first frequency but distinguishably different therefrom;
spatially spreading the first beam;
spatially spreading the second beam to superimpose on the first beam at a location in space, forming an interference pattern thereat; and
directing, to a target position, a selected portion of the interference pattern.

47. The method of claim 46, further comprising masking the interference pattern to select the selected portion.

48. The method of claim 46, further comprising selecting the selected portion by defining a target size.

49. The method of claim 46, where in selecting further her comprises selecting an optical fiber to receive the selected portion of the interference pattern.

50. The method of claim 49, wherein the optical fiber has a diameter selected to limit the portion of the interference pattern receivable therethrough.

51. The method of claim 46, further comprising sending the output signal to a plurality of output targets.

52. The method of claim 51, wherein each output target corresponds permanently to a position in the interference pattern.

53. The method of claim 52, wherein each output target represents a channel for receiving a fully-photonic signal.

54. The method of claim 51, wherein each output target receives, sequentially, a fully-photonic pulse.

55. The method of claim 54, wherein the pulse corresponds to a portion of the interference pattern selected from destructive interference and constructive interference.

56. The method of claim 46, wherein the output target comprises an optical fiber.
